(19) United States
(12) Patent Application Publication
(10) Pub. No.: US 2013/0309604 A1
(43) Pub. Date: Nov. 21, 2013

(54) IMAGE-FORMING APPARATUS AND CARTRIDGE

(71) Applicants: Mitsuo WADA, Kanagawa (JP); Teruyuki Mitsumori, Tokyo (JP); Hiroaki Takamura, Kanagawa (JP); Masaya Oota, Mie (JP); Teruki Senokuchi, Mie (JP); Shiho Sano, Niigata (JP); Masakazu Sugihara, Niigata (JP); Shiro Yasutomi, Niigata (JP); Yumi Hirabaru, Niigata (JP); Takeshi Oowada, Chesapeake, VA (US)

(72) Inventors: Mitsuo WADA, Kanagawa (JP); Teruyuki Mitsumori, Tokyo (JP); Hiroaki Takamura, Kanagawa (JP); Masaya Oota, Mie (JP); Teruki Senokuchi, Mie (JP); Shiho Sano, Niigata (JP); Masakazu Sugihara, Niigata (JP); Shiro Yasutomi, Niigata (JP); Yumi Hirabaru, Niigata (JP); Takeshi Oowada, Chesapeake, VA (US)

(73) Assignee: Mitsubishi Chemical Corporation, Chiyoda-ku (JP)

(21) Appl. No.: 13/933,918

(22) Filed: Jul. 2, 2013

Related U.S. Application Data
(62) Division of application No. 12/664,405, filed on Mar. 26, 2010.

(30) Foreign Application Priority Data
Jun. 12, 2007 (JP) 2007-155670
Oct. 3, 2007 (JP) 2007-259703

(51) Int. Cl. G03G 13/08

(52) U.S. Cl. CPC G03G 13/08
USPC 430/123.41

(57) ABSTRACT

An image-forming apparatus including an electrophotographic photoreceptor of which photosensitive layer contains oxytitanium phthalocyanine showing main diffraction peaks at Bragg angles (2θ) of 9.0° and 27.2° and at least one main diffraction peak in the range of 9.3° to 9.8° to CuKα rays, and the toner satisfies all the following requirements (1) to (3):
(1) the volume median diameter (Dv50) is 4.0 μm or more and 7.0 μm or less,
(2) the average sphericity is 0.93 or more, and
(3) the relation between the volume median diameter (Dv50) and the content (% by number: Dns) of toner particles of 2.00 μm or more and 3.56 μm or less satisfies Dns≦0.233EXP(17.3/Dv50).

This application is a divisional of U.S. application Ser. No. 12/664,405 filed Mar. 26, 2010, which is a National Stage of PCT/JP2008/060791 filed Jun. 12, 2008, both of which are incorporated herein by reference. This application also claims the benefit of JP 2007-155670 filed Jun. 12, 2007 and JP 2007-259703 filed Oct. 3, 2007.

### TECHNICAL FIELD

The present invention relates to an image-forming apparatus and a cartridge, which are employed in, for example, copiers and printers.

### BACKGROUND ART

Recently, uses of image-forming apparatuses seen as electrophotographic copiers have been expanded, and demands on the market for forming a higher-quality image have remarkably become high. Particularly, photographic technology and latent image-forming technology for inputting office documents have been developed. In addition, the kind of characters to be output in the office documents increases, and the shapes of such characters are highly refined. Furthermore, the spread and development in presentation software require reproducibility of significantly high-quality latent images that can produce printed images with reduced defects and fogs. A toner having a conventional large particle diameter generally exhibits low reproducibility of thin lines. In particular, when the conventional toner is used as a developer for forming a thin-line electrostatic latent image of 100 μm or lees (about 300 dpi or more), on a latent image carrier being an image-forming apparatus, the reproducibility of the thin lines is generally low. Thus, the clearness of line images is not sufficient yet.

In particulars image-forming apparatuses using digital image signals, such as electrophotographic printers, form a latent image that consists of solid portions, halftone portions, and light portions, which are expressed by variable densities of dot units. Accordingly, if the toner is not fixed on correct positions of the dot units, disagreement occurs between the positions of the dot units and the actual positions of the toner. This causes a disadvantage in that the gradient of a toner image does not correspond to the ratio of dot densities of a black portion to a white portion of the digital latent image. Furthermore, this toner cannot follow a smaller dot size for high resolution and high image quality, and, thereby, latent images cannot be precisely developed from these dots. The resulting images have poor gradation and poor sharpness, despite high resolution.

An attempt to improve image quality by high reproducibility of microdots is control of the particle size distribution of the developer. Patent Document 1 discloses a toner having an average particle diameter of 6 to 8 μm. this small particle diameter ensures formation of a latent image of microdots with high reproducibility. Patent Document 2 discloses a toner having a weight-average particle diameter or 4 to 8 μm. This toner contains 17 to 60% by number of toner mother particles having a particle diameter of 5 μm or less. Patent Document 3 discloses a magnetic toner containing 17 to 60% by number of magnetic toner mother particles having a particle diameter of 5 μm or less. Patent Document 4 discloses toner mother particles of which the particle size distribution shows a content of toner mother particles with a particle diameter of 2.0 to 4.0 μm being 15 to 40% by number. Patent Document 5 discloses a toner containing about 15 to 65% by number of particles of 5 μm or less. In addition, Patent Documents 6 and 7 disclose similar toners. Patent Document 8 discloses a toner containing 17 to 60% by number of toner mother particles having a particle diameter of 5 μm or less, 1 to 30% by number of toner mother particles having a particle diameter of 8 to 12.7 μm, and 2.0% by volume or less of toner mother particles having a particle diameter of 16 μm or more, and having a volume-average particle diameter of 4 to 10 μm, and showing a specific particles size distribution of the toner particles of 5 μm or less. Furthermore, Patent Document 9 discloses toner particles having a 50% volume particle diameter of 2 to 8 μm wherein the number of toner particles having a particle diameter of “0.7×the 50% number particle diameter” or less is 10% by number or less.

All these toners contain particles of 3.56 μm or less in a large amount seen that the content (% by number) of the particles is higher than the upper limit, that is, the right side in Expression (3) below, of the requirement in the present invention. This means that a relatively large amount of fine powder remains in the above-mentioned toners with respect to the amount of the toner having a predetermined particle diameter, in the relative relationship between the particle diameter and the fine powder. In these toners, since the ratio of the fine powder is still high, insufficiently charged particles occur in a development process, such as a nonmagnetic single-component development process, that requires toner to be quickly charged by momentary friction. As a result, the following problems still remain, i.e., detachment or blow-out of toners from development rollers, residual images (ghost images) wherein image concentrations selectively vary in second or later turns of the development rollers due to hysteresis of the printing information, of the first turn, and contamination of printed images due to poor drum cleaning and insufficient formation of toner layers on the development rollers.

Furthermore, another challenge is preparation of an electrophotographic photoreceptor that is suitable for a toner having a controlled particle diameter.

[Patent Document 1] Japanese Unexamined Patent Application Publication No. 2-284158

[Patent Document 2] Japanese Unexamined Patent Application Publication No. 5-119530

[Patent Document 3] Japanese Unexamined Patent Application Publication No. 1-221755

[Patent Document 4] Japanese Unexamined Patent Application Publication No. 6-289648

[Patent Document 5] Japanese Unexamined Patent Application Publication No. 2001-134005

[Patent Document 6] Japanese Unexamined Patent Application Publication No. 11-174731

[Patent Document 7] Japanese Unexamined Patent Application Publication (sic) No. 11-362389

[Patent Document 8] Japanese Unexamined Patent Application Publication No. 2-000877

[Patent Document 9] Japanese Unexamined Patent Application Publication No. 2004-045948

In addition, recently, the demands at the moment on the market for formation of a higher-quality image require a long service life and high speed printing. However, these conventional toners cannot sufficiently satisfy these characteristics. In toners containing a large amount of fine powder, such as conventional toners, the fine powder contaminates device components during continuous printing and thereby impairs the charge imparting ability, resulting in formation of blur image. In addition, the toner scatters prominently when used in a high-speed or printing apparatus.

In order to achieve high-quality printing, a toner necessarily has a sharp particle size distribution. If the toner contains coarse particles, it has a broad charge density distribution, which causes a phenomenon called “selective development”. The “selective development” represents that only toner particles that have a charge density sufficient to development are developed and are consumed during copying, when toner having a broad charge density distribution is used. Consequently, clear images can be formed in the initial period of copying, but the density is gradually decreased or toner particles become coarse during continuous copying operation, resulting in formation of blur images. Such a phenomenon is defined as poor selective development. Coarse grains with a low charge density tend to significantly decrease the guaranteed service life indicated by the number of copied sheets. Patent Document 10 discloses a toner containing a large amount of coarse grains exhibiting a number variation coefficient of 24.2. Such toners are inadequate for stably providing high-resolution images. Patent Document 11 does not show that the toner has a sharp particle sore distribution.

[Patent Document 10] Japanese Unexamined Patent Application Publication No. 2003-255567

[Patent Document 11] International Patent Publication No. WO 2004/088431

In addition, toner transfer properties are important in order to achieve high-quality image printing. A toner with excellent transfer properties is defined as that the toner particles developed on a photoreceptor are highly efficiently transferred to an intermediate transfer drum or paper or the toner particles on the intermediate transfer drum are highly efficiently transferred to paper. Patent Documents 12 to 14 disclose ground toners having not high average sphericities, as is presumed from the manufacturing processes. Accordingly, they are insufficient for achieving high-quality image printing with excellent transfer properties.

[Patent Document 12] Japanese Unexamined Patent Application Publication No. 7-098521

[Patent Document 13] Japanese Unexamined Patent Application Publication No. 2006-091175

[Patent Document 14] Japanese Unexamined Patent Application Publication No. 2006-119616

Furthermore, for example, investigations for increasing sensitivity of electrophotographic photoreceptors are extensively conducted for high-speed copiers and printers, and developments of toners with small particle diameters are also extensively conducted for high resolution and high image quality. Thus, various investigations have been conducted for individual components of image-forming apparatuses for achieving the objects such as high speed, high resolution, and high image quality (Patent Documents 15 and 16 and Non-Patent Document 1).

[Patent Document 15] Japanese Unexamined Patent Application Publication No. 5-88409

[Patent Document 16] Japanese Unexamined Patent Application Publication No. 11-143125

[Non-Patent Document 1] Denshi Shashin Gakkaishi (Electrophotography), 29(3), 250-258.

However, an image-forming apparatus having a combination of an electrophotographic photoreceptor that can provide high sensitivity and a toner that can provide high resolution and high image quality cannot readily form an image that satisfies high resolution and high quality at a desirable high speed, contrary to expectation. Specifically, when a conventional image-forming apparatus provided with such a combination of the electrophotographic photoreceptor and the toner prints a halftone image after printing an image, a phenomenon that the image previously printed appears at the halftone image portion, that is, a so-called memory (ghost) phenomenon occurs.

The memory phenomenon includes a positive memory of a higher concentration and a negative memory of a lower concentration. The detail mechanism of this memory phenomenon of images is still unclear in many points, and an image-forming apparatus that does not cause the memory phenomenon and can simultaneously satisfy high speed printing and formation of an image with high resolution and high quality has not been developed yet.

Accordingly, for example, in copiers, printers, and plain paper facsimile machines, widely demanded is an image-forming apparatus that can form a high-quality image at a high speed, but does not cause a memory (ghost) phenomenon in the image, smears in the white area of the image, toner scattering in the apparatus, occurrence of lines, and thin spots (imperfect solid images), and other defects.

### DISCLOSURE OF INVENTION

### Problems to be Solved by the Invention

The present invention has been made in view of such background of technology. It is an object to provide an image-forming apparatus and a cartridge that can form a nigh-quality image, are good in cleaning, do not cause dead dots even in a low concentration, have satisfactory reproducibility of thin lines, can reduce occurrence of the problems such as smears even in operation of high-speed printers for a long time, and exhibit excellent image stability, while suppressing unevenness in toner particle sure distribution and occurrence of defects caused by mismatching of a toner and a photoreceptor, such as smears in the white area of the image, residual images (memory, ghost), toner scattering in the apparatus, lines, and thin spots (imperfect solid images). In addition, it is an object to provide an image-forming apparatus and a cartridge that can stably form an image with high resolution by preventing “selective development”.

### Means for Solving the Problems

The present inventors have conducted intensive studies for solving the above-mentioned problems and, as a result, have found than the problems can be solved by a combination of a specific electrophotographic photoreceptor and a toner. The present invention has been thus accomplished.

That is, the present invention provides an image-forming apparatus and a cartridge each including an electrophotographic photoreceptor having a photosensitive layer on an electroconductive support, and an electrostatic charge image-developing toner, wherein the photosensitive layer of the electrophotographic photoreceptor contains oxytitanium phthalocyanine at least showing main diffraction peaks at Bragg angles (2θ±0.2°) of 9.0° and 27.2° and at least one main diffraction peek in the range of 9.3° to 9.8° to CuKα characteristic X-rays (wavelength: 1.541 angstroms), and the electrostatic charge image-developing toner has an average sphericity of 0.940 or more and 0.963 or less.

The present invention provides an image-forming apparatus and a cartridge each including an electrophotographic photoreceptor having a photosensitive layer on an electroconductive support, and an electrostatic charge image-developing toners, wherein the photosensitive layer of the electrophotographic photoreceptor contains oxytitanium phthalocyanine at least showing main diffraction peaks at Bragg angles (2θ±0.2°) of 9.0° and 27.2° and at least one main diffraction peak in the range of 9.3° to 9.8° to CuKα characteristic X-rays (wavelength: 1.541 angstroms), and the electrostatic charge image-developing toner satisfies all the following requirements (1) to (3):

(1) the volume median diameter (Dv50) is 4.0 μm or more and 7.0 μm or less,

(2) the average sphericity is 0.93 or more, and

(3) the relation between the volume median diameter (Dv50) of the toner and the content (% by number: Dns) of toner particles having a particle diameter of 2.00 μm or more and 3.56 μm or less satisfies Dns≦0.233EXP(17.3/Dv50).

The present invention provides the image-forming apparatus or the cartridge, wherein the photosensitive layer of the electrophotographic photoreceptor contains a charge-transporting organic material having a dipole moment Pcal satisfying 0.2(D)<P<2.1D) (sic), where the dipole moment is calculated by geometry optimization based on a semiempirical molecular orbital calculation using an AM1 parameter.

### Advantages

Since the present invention can provide satisfactory matching of a toner and a photorecepter, the image-forming apparatus and the cartridge of the present invention can suppress occurrence of, for example, smears in the white area of an image, toner scattering in the apparatus, residual images (memory, ghost), lines, and thin spots (imperfect solid images) and can reduce occurrence of such problems even after long-term operation and exhibit excellent image stability. Furthermore, the image-forming apparatus and the cartridge of the present invention do not cause dead dots even in a low concentration and can satisfactorily reproduce thin lines.

Since the toner has a narrow particle size distribution and the amount of fine powder is small even if the toner particle diameter is reduced, the filling rate, i.e., bulk density, of the toner powder is increased even if the image is formed by a high-speed printing process that has been recently developed. Therefore, the amount of air present in the gaps among toner mother particles is decreased, which reduces the heat-insulating effect by the air. As a result, the thermal conductivity is increased, resulting in an improvement in thermal fixation. Furthermore, the present invention can provide an image-forming apparatus and a cartridge exhibiting excellent image stability, without occurrence of smears even after long-time operation.

Furthermore, the present invention provides an image-forming apparatus and a cartridge that can form images with reduced defects, such as fogs, color spots, and leakage, by a synergistic effect of the toner and the electrophotographic photoreceptor including the photosensitive layer containing a specific material.

The image-forming apparatus and the cartridge can prevent the “selective development” and thereby can stably form high-resolution images even after long-term printing, and have excellent transfer properties and thereby can prevent the interior of the apparatus from contamination.

### BRIEF DESCRIPTION OF DRAWINGS

FIG. 1 is a schematic view illustrating a nonmagnetic single-component toner developer applied in an image-forming apparatus according to the present invention;

FIG. 2 is a schematic view illustrating the main structure of an image-forming apparatus according to an embodiment of the present invention;

FIG. 3 is an SEM photograph at a magnification of 1000 times shoving the toner (toner K) prepared in Toner Production Comparative Example 2;

FIG. 4 is an SEM photograph at a magnification of 1000 times showing the toner (toner H) prepared in Toner Production Example 7;

FIG. 5 is an SEM photograph at a magnification of 1000 times showing the toner (toner K) prepared in Toner Production Comparative Example 2 remaining on a cleaning blade after actual printing evaluation;

FIG. 6 is an X-ray diffraction spectrum of a coating liquid for a charge-generating layer concerning oxytitanium phthalocyanine used in photoreceptor-producing example 1, measured according to a “method for measuring CKα characteristic X-rays (wavelength: 1.541 angstroms) of a charge-generating layer (sample preparation (1))”;

FIG. 7 is an X-ray diffraction spectrum of a coating liquid for a charge-generating layer containing oxytitanium phthalocyanine used in photoreceptor-producing example 4, measured according to a “method for measuring CuKα characteristic X-rays (wavelength: 1.541 angstroms) of a charge-generating layer (sample preparation (1))”;

FIG. 8 is an X-ray diffraction spectrum of oxytitanium phthalocyanine used in comparative photoreceptor-producing example 1, measured by ordinary powder X-ray diffractometry

FIG. 9 is an X-ray diffraction spectrum of oxytitanium phthalocyanine used in comparative photoreceptor-producing example 2, measured by ordinary powder X-ray diffractometry; and

FIG. 10 is an X-ray diffraction spectrum of a coating liquid for a charge-generating layer containing oxytitanium phthalocyanine used in comparative photoreceptor-producing example 2, measured according to a “method for measuring CuKα characteristic X-rays (wavelength: 1.541 angstroms) of a charge-generating layer (sample preparation (1)”.

### REFERENCE NUMERALS

11 electrostatic latent image carrier

12 toner-transferring member

13 elastic blade (toner layer thickness regulator)

14 sponge roller (auxiliary toner feeder)

15 agitating blade

16 toner

17 toner hopper

1 photoreceptor (electrophotographic photoreceptor)

2 charging device (charging roller: charging portion)

3 exposure device (exposing portion)

4 development device (developing portion)

5 transfer device

6 cleaning device (cleaning portion)

7 fixing device

41 developer tank

42 agitator

43 supply roller

44 development roller

43 regulator

71 upper fixing member (pressurizing roller)

72 lower fixing member (fixing roller)

73 heater

T toner

P recording sheet (paper, medium)

### BEST MODE FOR CARRYING OUT THE INVENTION

The present invention will now be described, but should not be limited to the following specific embodiments. Various modifications can be made within the scope of the present invention.

The electrostatic charge image-developing toner (hereinafter, optionally, abbreviated to “toner”) has an average sphericity of 0.940 or more and 0.965 or less or satisfies all the following requirements (1) to (3):

(1) the volume medium diameter (Dv50) is 4.0 μm or more and 7.0 μm or less,

(2) the average sphericity is 0.93 or more, and

(3) the relation between the volume median diameter (Dv50) of the toner and the content (% by number: Dns) of toner particles having a particle diameter of 2.00 μm or more and 3.55 μm or less satisfies Dns≦0.233EXP(17.3/Dv50).

### [The Case of an Average Sphericity of 0.940 or More and 0.965 or Less]

In the toner according to the present invention, as the toner particles have shapes similar to one another and have higher sphericity, the charge density is barely localized in the toner particles and development properties become uniform. Such a toner is preferred for improved image quality. Accordingly, the average sphericity of the toner according to the present invention is usually 0.940 or more, preferably 0.942 or more, and more preferably 0.945 or more, when measured with a flow-type particle image analyzer. The upper limit of the average sphericity as 0.965 or less without other limitation. However, when the shape of the toner is enormously close to a complete sphere, the formed image may have defects caused by contamination with the residual toner on the surface of the electrophotographic photoreceptor due to insufficient cleaning of the toner after the image formation. In such a case, intensive cleaning is necessary to complement insufficient cleaning. Such intensive cleaning furthermore causes wear or scratch on the electrophotographic photoreceptor, which tends to decrease the service life of the electrophotographic photoreceptor. Furthermore, since the completely spherical toner cannot be produced at low cost, it may not have industrial availability.

In addition, it is preferable that the toner having an average sphericity of 0.940 or more and 0.965 or less also satisfy requirements (1) and (3) in “the case that requirements (1) to (3) are satisfied” described below and that the toner also satisfy standard deviation of the charge density described below. Furthermore, the toner is preferably that used in an image-forming apparatus satisfying a development speed and Expression (G) described below. The toner preferably satisfies the resolution level to a latent image carrier, which is described below.

### [Measurement of Sphericity]

The average sphericity is used as a simple method for quantitatively expressing the shapes of toner particles. In the present invention, the sphericity [a] of toner particles is determined by assigning the value obtained by measurement with a flow-type particle image analyzer FPIA-2000 manufactured by Sysmex Co. to the following Equation (A):

Sphericity [a]=L₀/L (A)

(in Equation (A), L₀ represents a perimeter of a circle having the same projected area as that of a particle image, and L represents a perimeter of the particle image obtained by image processing).

The sphericity is an index of irregularity of the toner particles and is 1.00 for completely spherical toner. The sphericity decreases with an increase in complexity of the surface shape.

An actual method of measuring the average sphericity is as follows: A surfactant (preferably alkylbenzenesulfonate) as a dispersing agent is added to 20 mL of impurity-free water in a container, and about 0.05 g of a sample (toner) to be measured is added thereto. The resulting suspension containing the sample is irradiated with ultrasound for 30 seconds. The particle concentration is adjusted to 3000 to 8000 particles/μL (microliter), and the sphericity distribution of particles having diameters corresponding to circles of 0.06 μ, or more and less than 160 μm is measured with the flow-type particle image analyzer.

### [The Case Satisfying Requirements (1) to (3)]

### Regarding Requirement (1)

The volume median diameter (Dv50) of a toner is defined by a value that is measured by a method described in the section Examples. In the present invention, when a toner is composed of toner mother particles having surfaces on which an external additive is fixed or adhered, the toner is used as a sample to be measured. Similarly, also in the measurements of the average sphericity and the content (% by number: Dns) of toner particles having a particle diameter in the range of 2.00 to 3.56 μm, which are described below, when a toner is composed of toner mother particles having surfaces on which an external additive is fixed or adheres, the toner is used as a sample to be measured.

The Dv50 of the toner according to the present invention is in the range at 4.0 to 7.0 μm. This range can provide an image having significantly high quality. A high-quality image can be more readily produced at a Dv50 of 6.8 μm or less and more preferably 6.5 μm or less. From the viewpoint of reducing the generation of fine powder, the Dv50 is preferably 4.5 μm or more, more preferably 5.0 μm or more, and most preferably 5.3 μm or more.

### Regarding Requirement (2)

The average sphericity of a toner defined by a value that is measured by the following method.

The average sphericity measured by dispersing toner mother particles in a dispersion medium (Isotone II, manufactured by Beckman Coulter, Inc.) in the range of 5720 to 7140 particles/μL and measuring sphericity with a flow-type particle image analyzer (FPIA2100, manufactured by Sysmex Co., (previous Toa Medical Electronics Co., Ltd.)) under the following conditions, and the observed value is defined as the “average sphericity”. In the present invention, the measurement is repeated three times, and the arithmetic average of the three observed values is used as the “average sphericity”.

Mode: HPF

Amount analyzed by HPF: 0.35 μL

HPF detection number: 2000 to 2500

The “sphericity”, which is defined by the following equation, is automatically calculated and is displayed on the above-mentioned analyzer.

(Sphericity)=(perimeter of a circle having the same protected area as that of a particle image)/(perimeter of the particle image)

Particles corresponding to the HPF detection number, i.e., 2000 to 2500 particles, are subjected to the measurement, and the arithmetic mean or arithmetic average of the sphericities of these particles is displayed on the analyzer as an “average sphericity”.

The average sphericity of the toner in the present invention is 0.930 or more and preferably 0.940 or more. In general, a toner having a higher sphericity exhibits a higher transfer efficiency. Since a toner particle having a high sphericity is in contact with other particles or various other members in a narrower area, the mechanical share on a charging roller is small, and the surface deformation is low. In addition, since the mother toner itself has high fluidity, a change in the amount of external inorganic powder additive does not significantly vary the fluidity. Thus, the spherical toner hardly deteriorates. In addition, such a toner is readily released from a photosensitive drum and whereby exhibits high transfer efficiency. Therefore, a sufficient image density is ensured, and, at the same time, the amount of the residual toner after transferring can be reduced.

However, in a toner having a high average sphericity, the proportion of weakly charged toner particles, WST (%), which is measured with an E-SPART analyzer, tends to increase, resulting in poor toner scattering. Furthermore, when the residual toner after transferring by a cleaning blade is scraped, the residual toner is easy to slip through the cleaning blade, which causes smears in an image. This phenomenon occurs significantly in high-speed printing. Therefore, in the present invention, the average sphericity of the toner is preferably 0.970 or less and more preferably 0.965 or less Furthermore, since a toner having a small particle diameter and a high sphericity is hardly scraped with a cleaning blade and easy to slip through the cleaning blade, it is particularly necessary to control the particle size distribution according to the sphericity.

### Regarding Requirement (3)

The content (% by number: Dns) of toner particles having a particle diameter in the range of 2.00 μm to 3.56 μm is defined by a value that is measured by the method described in the section Examples. In the toner of the present invention, the relation between the volume median diameter (Dv50) of the toner and the content (% by number: Dns) of toner particles having a particle diameter in the range of 2.00 to 3.56 μm satisfies the inequality:

Dns≦0.233EXP(17.3/Dv50).

In the present invention, “EXP” means “Exponential”, namely, a base of natural logarithm, and the right side is represented by the exponent. This expression is optionally referred to as “expression of requirement (3)”.

This relational expression (expression of requirement (3)) shows that the amount of fine powder increases with a decrease in the volume median diameter (Dv) of the toner. When a Dv is 4.5 μm or less, i.e., when a Dv value is near the region of a particle diameter in the range of 2.00 to 3.56 μm, the Dns value is exponentially increased. Such a Dv in the range of 2.00 to 3.56 μm is expressed by a prescribed channel of Multicizer III (manufactured by Coulter Counter Inc.).

In the present invention, toner particles having particle diameters in the range of 2.00 μm to 3.56 μm should be selectively removed from the toner particles having a volume median diameter in the range of 4.0 to 7.0 μm. The reason for this is based on the experimental results.

The toner in the present invention showing a particle size distribution that satisfies requirement (3) can produce high-quality images, with reduced smears, residual images (ghosts), and thin spots (imperfect solid images) and excellent cleaning properties, even when the toner is applied to high-speed printers. The narrow particle size distribution highly sharpens the charge density distribution. As a result, there are no particles with a low charge density that causes smears in the white area of an image or contamination of the interior of an apparatus by scattering. In addition, the following phenomenon causing image defects such as lines and thin spots does not occur; particles with a high charge density that are not used for development adheres to device components such as a layer-regulating blade and a roller. Accordingly, the “selective development” hardly occurs.

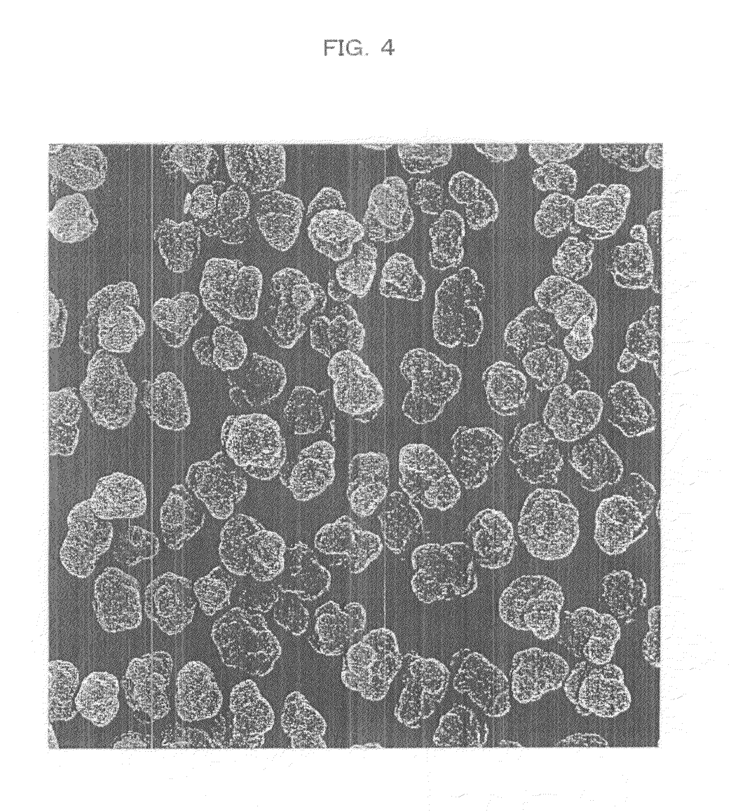

That is, the image is affected by the amount of the fine powder when the amount is outside the expression of requirement (3). When the Dns value exceeds the value of the right side, the fine powder causes defects in an image. For example, as shown in FIG. 4, the fine powder accumulates on a cleaning blade to cause image defeats such as residual images, thin spots, and smears.

Since the image-forming apparatus is designed to transfer particles having a specific charge density, the particles having such a specific charge density are preferentially transferred to an OPC during electrostatic development. Particles having a charge density higher than the specific charge density may adhere to, for example, device components to cause contamination or deterioration of the fluidity. On the other hand, particles having a charge density lower than the characteristic charge density may accumulate in the cartridge to contaminate, for example, device components.

The charge density of toners has a correlation with the particle diameter of the toners, when the toners have the same compositions. In general, a toner having a smaller particle diameter has a higher charge density per unit weighs, whereas a toner having a larger particle diameter has a lower charge density per unit weight. That is, a large number of toner particles having a small particle diameter increases the charge density, resulting in adhesion of the toner to device components and a decrease in the fluidity of the toner. However, the use of the toner of the present invention decreases the “selective development”. In the present invention, the particle diameter of the toner is limited to 3.55 μm or less. This value of 3.56 μm is regulated by the channel of a measuring apparatus. The lower limit is 2.00 μm, which is the measuring limit of the measuring apparatus.

In the content (% by number: Dns) of toner particles, the particle diameter is limited to 2.00 μm or more and 3.56 μm or less. The lower limit is the measuring limit of the apparatus used for measuring particle diameters of toners in the present invention. The upper limit is a critical value obtained from the results described in the section Examples. That is, if the content (% by number) of toner particles includes a particle diameter higher than 3.56 μm, it is difficult to distinguish toners exhibiting the effects of the present invention from toners not exhibiting the effects by the expression described above.

From the viewpoint of the effect, preferred is a toner satisfying the following relation between Dv50 and Dns:

Dns≦0.110EXP(19.9/Dv50). 3-1)

On the other hand, from the viewpoint of high-yield production, the toner preferably satisfies the following relation between Dv50 and Dns:

0.0517EXP(22.4/Dv50)≦Dns. (3-2)

In addition, a toner having a Dns of 6% by number or less is preferred because it can yield a higher-quality image and hardly contaminates the image-forming apparatus. More preferably, a toner simultaneously satisfies the condition of “a Dns of 6% by number or less” and a preferable particle diameter range of Dv50, for example, “a Dv50 of 4.5 μm or more”. In this range, the resulting toner can yield a high-quality image without a reduction in productivity, hardly contaminates the image-forming apparatus, and hardly causes “selective development”.

The toner applied to the image-forming apparatus of the present invention must satisfy requirements (1) to (3). Conventional toners do not satisfy any of requirements (1) to (3). This is because that if the amount of the fine powder is significantly reduced (satisfying requirement (3)), coarse grains increasing the number variation coefficient are generated, which is unfavorable to a toner. If a toner is tried to be ensphered by a physical impact (satisfying requirement (2)), the generation of fine powder is accelerated (requirement (3) is not satisfied). If a toner is ensphered by thermal fusion (satisfying requirement (2)), the toner particles fuse to one another to generate coarse grains or to increase the number variation coefficient.

The toner satisfying all requirements (1) to (3) in the present invention can produce high-quality images, with reduced smears, residual images (ghosts), and thin spots (imperfect solid images) and excellent cleaning properties, even when the toner is applied to high-speed printers. The narrow particle size distribution highly sharpens the charge density distribution. As a result, there are no particles with a low charge density that causes smears in the white area of an image or contamination of the interior of an apparatus by scattering. In addition, the following phenomenon causing image defects such as lines end thin spots does not occur; particles with a high charge density that are not need for development adheres to device components such as a layer-regulating blade and a roller. Accordingly, the “selective development” hardly occurs.

The toner applied to the image-forming apparatus of the present invention must satisfy all requirements (1) to (3) and preferably has a number variation coefficient of 24.0% or less, more preferably 22.0% or less, more preferably 20.0% or less, and most preferably 19.0% or less. In general, if a value of the number variation coefficient is high, the charge density distribution is broad, and image defects are caused by defective charging. In addition, the broad distribution may induce contamination by adhesion of toner to, for example, toner components and contamination by scattering of the toner. Accordingly, a lower number variation coefficient is preferable. However, the number variation coefficient is preferably higher than 0% and more preferably 5% or more, from the industrial viewpoint. The number variation coefficient (%) is defined by a value that is measured by the method described in the section Examples.

The toner in the present invention has a sharp charge density distribution compared to those of conventional toners. The charge density distribution has a correlation with the particle size distribution of the toner. When the particle size distribution of a toner is broad like the conventional toners, the charge density distribution is also broad. In a toner showing a broad charge density distribution, the amounts of low-charged particles and highly-charged particles are increased to cause various image defects that cannot be reduced by controlling the development conditions of the apparatus using the toner. For example, the particles with a low charge density cause smears in a white portion of an image or contamination of the interior of the apparatus by scattering of the toner. The particles with a high charge density does not contribute to development and accumulate on device components, such as a layer-regulating blade and a roller, in a developer tank, resulting in image defects such as lines and thin spots due to fusion.

Even in the conditions for development of an image-forming apparatus designed so as to be adapted to the average value of a toner charge density, a toner having a charge density that is highly deviated from such an average value causes scattering and image defects such as lines and thin spots in the image-forming apparatus. Thus, the toner exhibits poor adaptability to the apparatus. On the other hand, a sharp charge density distribution in the present invention can control the development parameter, for example, bias. Therefore, the components of the image-forming apparatus are not contaminated and a clear image can be formed.

In the toner in the present invention, the “standard deviation of charge density”, which is one measure showing “charge density distribution”, is preferably in the range of 1.0 to 2.0, more preferably 1.0 to 1.8, and most preferably 1.0 to 1.5. When the standard deviation is higher than the upper limit, the toner adheres to the layer-regulating blade and thus cannot be readily transferred. The adhering toner blocks toners to be transferred afterward, and thereby components inside the image-forming apparatus are contaminated. A toner showing a standard deviation lower than the lower limit is not preferred, from the industrial viewpoint. The lower limit is preferably 1.3 or more.

Since the toner in the present invention exhibits a sharp charge density distribution, contamination (toner scattering) of the interior of the image-forming apparatus caused by the defectively charged toner is significantly low. This effect is significant, in particular, in high-speed image-forming apparatuses that conduct the development on an electrostatic latent image carrier at a rate of 100 mm/sec or more.

Since the toner in the present invention exhibits a sharp charge density distribution, the development properties are excellent, so that the amount of toner particles that do rest contribute to development and accumulate is very small. This effect is significant, in particular, in image-forming apparatuses that rapidly consume toners. In particular, the advantages of the present invention are noticeable when the toner is applied to an image-forming apparatus satisfying the following expression (G):

(the number of sheets of guaranteed service life of a developing machine filled with a developer)×(printing ratio) ≧400 (sheets). (G)

In expression (G), the “printing rate” represents a value obtained by dividing the sum of printed areas by the total area of a printed medium, in a printed material for determining a guaranteed service life indicated by the number of the sheets showing the performance of an image-forming apparatus. For example, the “printing rate” is “0.05” for a printing % of “5%”.

Since the toner in the present invention exhibits a sharp charge density distribution, reproducing properties of a latent image are excellent. Therefore, this effect is significant when the toner is applied to, in particular, an image-forming apparatus of which resolution to an electrostatic latent image carrier is 600 dpi or more. In addition, the image-forming apparatus and the cartridge of the present invention are characterized by the use of a toner satisfying all requirements (1) to (3), and a high-resolution image, that is, a resolution of an electrostatic latent image carrier of 600 dpi or more can be achieved by the use of such a toner. The term “resolution of an electrostatic latent image carrier” has the same meaning as the term “resolution of an apparatus”.

### [Composition of Toner]

The toner used in the image-forming apparatus or the cartridge of the present invention is composed of a binder resin, a colorant, a wax, an external assistive, and other components. The binder resin may be any known one that can be used in toners. Examples of such a binder resin include styrene-based resins, (vinyl chloride)-based resins, rosin-modified maleic acid resins, phenol resins, epoxy resins, saturated or unsaturated polyester resins, polyethylene resins, polypropylene resins, ionomer resins, polyurethane resins, silicone resins, ketone resins, ethylene-acrylate copolymers, xylene resins, polyvinyl butyral resins, styrene-(alkyl acrylate) copolymers, styrene-(alkyl methacrylate) copolymers, styrene-acrylonitrile copolymers, styrene-butadiene copolymers, and styrene-maleic anhydride copolymers. These resins may be used alone or in any combination.

The colorant constituting the toner in the present invention may be any known one that can be used in toners. Examples of such a colorant include yellow pigments, magenta pigments, and cyan pigments shown below. The black pigment may be carbon black or mixed pigments toned into black prepared by blending a yellow pigment, a magenta pigment, and a cyan pigment shown below.

Among them, carbon black used as the black pigment is present in the form of aggregate of highly fine primary particles and easily causes coarsening of carbon black particles due to agglomeration when it is dispersed as a pigment particle dispersion. The degree of agglomeration of the carbon black particles has a correlation with the size of impurities (the amount of the remaining undecomposed organic materials) contained in the carbon black, that is, a larger amount of impurities results in prominent coarsening due to agglomeration after dispersion. For determination of the amount of impurities, the ultraviolet absorbance of toluene extract from carbon black measured by the following procedure is preferably 0.05 or less and more preferably 0.03 or less. In general, carbon black produced by a channel process includes larger amounts of impurities. Accordingly, the carbon black used in the present invention is preferably produced by a furnace process.

The ultraviolet absorbance (λc) of carbon black is determined by the following process: 3 g of carbon black is sufficiently dispersed in 30 mL of toluene, and then this mixture is filtered through No. 5C filter paper. Then, the filtrate is transferred to a square quartz cell with a 1 cm light path and is subjected to measurement of absorbance (λs) at a wavelength of 336 nm using a commercially available ultraviolet spectrophotometer. As a reference, toluene is subjected to measurement of absorbance (λo) by the same method, and the ultraviolet absorbance is determined by λc=λs−λo. An example of the commercially available spectrophotometer is an ultraviolet and visible spectrophotometer (UV-3100PC) manufactured by Shimadzu Corp.

Typical examples of the yellow pigment include condensed azo compounds and isoindolinone compounds. Specifically, preferred are C.I. Pigment Yellows 12, 13, 14, 15, 17, 62, 74, 83, 93, 94, 95, 109, 110, 111, 128, 129, 147, 150, 155, 168, 180, and 194.

Examples of the magenta pigment include condensed azo compounds, diketopyrrolopyrrole compounds, anthraquinones, quinacridone compounds, basic dye lake compounds, naphthol compounds, benzimidazolone compounds, thioindigo compounds, and perylene compounds. Specifically, preferred are C.I. Pigment Reds 2, 3, 5, 6, 7, 23, 48:2, 48:3, 48:4, 57:1, 81:1, 122, 144, 146, 166, 169, 17.3 (sic), 184, 185, 202, 206, 207, 209, 220, 221, 238, and 254, and C.I. Pigment Violet 19. Among them, the quinacridone pigments denoted as C.I. Pigment Reds 122, 202, 207, and 209, and C.I. Pigment Violet 19 are particularly preferred. Among the quinacridone pigments, a compound denoted as C.I. Pigment Red 122 is particularly preferred.

Examples of the cyan pigment include copper phthalocyanine compounds and their derivatives, anthraquinone compounds, and basic dye lake compounds. Specifically, preferred are C.I. Pigment Blues 1, 15, 15:1, 15:2, 15:3, 15:4, 60, 62, and 66, and C.I. Pigment Greens 7, 36 and the like.

The toner in the present invention preferably contains a wax that improves mold releasability. Any wax that has mold releasability can be used without limitation. Examples of usable wax include olefin waxes seen as low molecular weight polyethylene, low molecular weight polypropylene, and copolymerized polyethylene; paraffin waxes; ester waxes having a long-chain aliphatic group, such as behenyl behenate, montanic acid esters, and stearyl stearate; plant waxes such as hydrogenated castor oil and carnauba wax; ketones having a long-chain alkyl group, such as distearyl ketone; silicone waxes having an alkyl group; higher fatty acids such as stearic acid; long-chain aliphatic alcohols such as eicosanol; carboxylic acid esters or partial esters of polyols prepared from polyols and long-chain fatty acids, such as glycerin and pentaerythritol; higher fatty acid amide each as oleic acid amide and stearic acid amide; and low molecular weight polyester.

In these waxes, in order to enhance fixability, the melting point of the wax is preferably 30° C. or more, more preferably 40° C. or more, and most preferably 50° C. or more and preferably 100° C. or less, more preferably 0° C. or less, and most preferably 80° C. or less. A wax having a lower melting point bleeds on the surface of the toner after fixing to cause stickiness, and a wax having a higher melting point exhibits poor fixability at low temperature. The wax compound is preferably ester waxes prepared from an aliphatic carboxylic acid and a monovalent or polyvalent alcohol. Among ester waxes, those having 20 to 100 carbon atoms are preferred.

The waxes may be used alone or as a mixture. The wax compound is selected such that its melting point is suitable for the temperature for fixing the toner. The amount of the wax used is preferably 4 parts by weight or more, more preferably 6 parts by weight or more, and most preferably 8 parts by weight or more and 20 parts by weight or less, more preferably 18 parts by weight or less, and most preferably 15 parts by weight or less on the basis of 100 parts by weight of the toner. When the volume median diameter (Dv50) of the toner is 7 μm or less, that is, when the toner is composed of small particles, the bleeding of the wax on the surface of the toner particles is significantly noticeable as the amount of the wax used increases, resulting in a decrease in storage stability of the toner. The toner in the present invention is composed of toner particles having a small particle diameter exhibiting a sharp particle size distribution, which can keep excellent toner properties, compared to those in conventional toners, regardless of use of such a large amount of wax.

The toner in the present invention may include any known external additive on the surfaces of the toner mother particles for controlling the fluidity and development properties. Examples of the external additive include metal oxides and hydroxides stash as alumina, silica, titania, zinc oxide, zirconium oxide, cerium oxide, talc, and hydrotalcite; metal titanates such as calcium titanate, strontium titanate, and barium titanate; nitrides such as titanium nitride and silicon nitride; carbides such as titanium carbide and silicon carbide; and organic particles such as acrylic resins and melamine resins. These external additives may be used in a combination. Among them, preferred are silica, titania, and alumina. More preferred are those of which surfaces are treated with, for example, a silane coupling agent or a silicone oil. The average primary particle diameter is preferably 1 nm or more and more preferably 5 nm or more and preferably 500 nm or less and more preferably 100 nm or less. The external additive is preferably composed of small particles and large particles within such a particle diameter range. The total amount of the external additive added is preferably 0.05 part by weight or more and more preferably 0.1 part by weight or more and preferably 10 parts by weight or less and more preferably 5 parts by weight or less on the basis of 100 parts by weight of the toner mother particles.

### [Production of Toner]

The toner in the present invention may be produced by any method without limitation. That is, the toner can be produced by, for example, a grinding process or a process of forming particles in an aqueous solvent (hereinafter, optionally, abbreviated to “wet process”). Preferred wet processes are, for example, radical polymerization in an aqueous solvent (hereinafter, abbreviated to “polymerization”, and the resulting toner is abbreviated to “polymerized toner”), such as suspension polymerization and emulsion polymerization/agglomeration, and chemical grinding, such as molten suspension. The toner particles may be sized to a specific range of the present invention by any means without limitation. For example, in the process of producing a polymerized toner by suspension polymerization, a high shear force is applied to the toner in the step of forming polymerizable monomer drops or a large amount of dispersion stabilizer is added.

Since toner production by grinding, in general, tends to generate fine powder, it needs a classification step. In particular, in order to satisfy the requirements for the toner particle diameters in the present invention, it may require an extensive classification operation. This causes a significant decrease in the product yield, which is undesirable from the industrial viewpoint, nevertheless, such toners should not be excluded from the scope of the toner that is used in the image-forming apparatus of the present invention. In contrast, the wet process of forming particles in an aqueous solvent is preferred for formation of the toner of the present invention, because it hardly generates fine powder and does not require classification.

The toner exhibiting a specific particle size distribution according to the present invention may be prepared by any method, for example, grinding, polymerization such as suspension polymerization or emulsion polymerization/agglomeration, or a chemical grinding such as molten suspension. In these “grinding”, “suspension polymerization”, and “chemical grinding such as molten suspension”, the particle size is adjusted from a larger size than the target particle diameter of the toner to a smaller size. Consequently, the amount of particles having a smaller diameter tends to increase as the average particle diameter decreases. Therefore, excess burden is forced in the classification step. In the emulsion polymerization/agglomeration, the particle size distribution is relatively sharp, and the particle size is adjusted from a smaller size than the target toner mother particle diameter to a larger size. Consequently, the toner can exhibit a satisfactory particle size distribution without the classification step. Therefore, the toner in the present invention is preferably produced by emulsion polymerization/agglomeration.

Among the methods of forming particles in aqueous solvents, polymerization in an aqueous solvent and emulsion polymerization/agglomeration will be described, from the viewpoint that fine powder is hardly generated. The production process of a toner by emulsion polymerization/agglomeration usually includes steps of polymerization, mixing, agglomeration, aging, and washing/drying. That is, in general, toner mother particles are prepared by preparing a dispersion containing polymer primary particles that are formed by emulsion polymerization; mixing the dispersion with a dispersion of agents such as a colorant, a charge controlling agent, and a wax; agglomerating the primary particles in this dispersion into seed particles; fusing the resulting particles after optional fixation or adhesion with, for example, resin microparticles; and washing and drying the particles.

The binder resin constituting the polymer primary particles used in the emulsion polymerization/agglomeration may be prepared by one or more monomers that can be emulsion polymerized. Examples of preferred polymerizable monomers include “polymerizable monomers having polar groups” (hereinafter, optionally abbreviated to “polar monomers”), such as “polymerizable monomers having acid groups” (hereinafter, optionally, abbreviated to “acidic monomers”) and “polymerizable monomers having basic groups” (hereinafter, optionally, abbreviated to “basic monomers”); and “polymerizable monomers not having either acid groups or basic groups” (hereinafter, optionally, abbreviated to “other monomers”). In this case, these polymerizable monomers may be separately added to the emulsion polymerization/agglomeration, or a premix of different polymerizable monomers may be added to the emulsion polymerization/agglomeration. Furthermore, the polymerizable monomers may be added to a varying polymerizable monomer composition. The polymerizable monomer may be directly added or may be added as an emulsion prepared by previously mixing with, for example, water or an emulsifier.

Examples of the “acidic monomer” include polymerizable monomers having a carboxyl group, such as acrylic acid, methacrylic acid, itaconic acid, maleic acid, fumeric acid, and cinnamic acid; polymerizable monomers having a sulfonate group, such as sulfonated styrene; and polymerizable monomers having a sulfonamide group, such as vinylbenzenesulfonamide. Examples of the “basic monomer” include aromatic vinyl compounds having an amino group, such as aminostyrene; and polymerizable monomers having a nitrogen-containing heterocycle, such as vinylpyridine and vinylpyrrolidone.

These polar monomers may be used alone or as a mixture, and may be present in the form of salts with counter ions. In particular, preferred are the acidic monomers, and more preferred is (meth) acrylic acid. The total amount of the polar monomers on the basis of 100 mass % of total polymerizable monomers constituting the binder resin as polymer primary particles is preferably 0.05 mass % or more, more preferably 0.3 mass % or more, more preferably 0.5 mass % or more, and most preferably 1 mass % or more. The upper limit is preferably 10 mass % or less, more preferably 5 mass % or less, and most preferably 2 mass % or less. When the amount of the polar monomers is adjusted to such a range, the dispersion stability of the polymer primary particles is increased, and the shape and diameter of the particles can be readily controlled in the agglomeration step.

Examples of the “other monomer” include styrene derivatives such as styrene, methylstyrene, chlorostyrene, dichlorostyrene, p-tert-butylstyrene, p-n-butylstyrene, and p-n-nonylstyrene; acrylates such as methyl acrylate, ethyl acrylate, propyl acrylate, n-butyl acrylate, isobutyl acrylate, hydroxyethyl acrylate, and ethylhexyl acrylate; methacrylates such as methyl methacrylate, ethyl methacrylate, propyl methacrylate, n-butyl methacrylate, isobutyl methacrylate, hydroxyethyl methacrylate, and ethylhexyl methacrylate; and acrylamide, N-propylacrylamide, N,N-dimethylacrylamide, N,N-dipropylacrylamide, N,N-dibutylacrylamide, and amide acrylate. The polymerizable monomers may be used alone or in a combination thereof.

In the present invention, the combination of the polymerizable monomers is preferably a combination of an acidic monomer and another monomer, more preferably a combination of (meth)acrylic acid as the acidic monomer and a polymerizable monomer selected from styrene derivatives and (meth)acrylates as the another monomer, more preferably a combination of (meth)acrylic acid as the acidic monomer and a combination of a styrene derivative and a (meth)acrylate as the another monomer, and most preferably a combination of (meth)acrylic acid as the acidic monomer and a combination of a styrene derivative and h-butyl acrylate at the another monomer.

Furthermore, the binder resin constituting the polymer primary particles may be a crosslinkable resin. In such a case, a multifunctional monomer having radical polymerizability is used as a cross-linking agent that is used together with the polymerizable monomers. Examples of the multifunctional monomer include divinylbenzene, hexanediol diacrylate, ethylene glycol dimethacrylate, diethylene glycol dimethacrylate, diethylene glycol diacrylate, triethylene glycol diacrylate, neopentyl glycol dimethacrylate, neopentyl glycol acrylate, and diarylphthalate. In addition, the cross-linking agent may be a polymerizable monomer having a reactive group in a pendant group, for example, glycidyl methacrylate, methylol acrylamide, or acrolein. Among them, preferred are radical polymerizable difunctional monomers, in particular, divinylbenzene and hexanediol diacrylate.

These cross-linking agents such as multifunctional monomers may be used alone or as a mixture. When the binder resin constituting the polymer primary particles is a crosslinkable resin, the amount of the cross-linking agent such as a multifunctional monomer in the total polymerizable monomer constituting the resin is preferably 0.005 mass % or more, more preferably 0.1 mass % or more, more preferably 0.3 mass % or mere and preferably 5 mass % or less, more preferably 3 mass % or less, and most preferably 1 mass % or less.

In the emulsion polymerization, any known emulsifier can be used, and one or more of the emulsifiers selected from cationic surfactants, anionic surfactants, and nonionic surfactants may be simultaneously used.

Examples of the cationic surfactants include dodecylammonium chloride, dodecylammonium bromide, dodecyltrimethylammonium bromide, dodecylpyridinium chloride, dodecylpyridinium bromide, and hexadecyltrimethylammonium bromide.

Examples of the anionic surfactants include sodium stearate, fatty acid soaps such as sodium stearate, sodium dodecanoate, sodium dodecylsulfate, sodium dodecylbenzenesulfonate, and sodium laurylsulfate.

Examples of the nonionic surfactants include polyoxyethylene dodecyl ether, polyoxyethylene hexadecyl ether, polyoxyethylene nonylphenyl ether, polyoxyethylene lauryl ether, polyoxyethylene sorbitan monooleate ether, and monodecanoyl sucrose.

The amount of the emulsifier used is usually 1 to 10 parts by weight on the basis of 100 parts by weight of polymerizable monomer. The emulsifier may be used with a single protective colloid or two or more different protective colloids. Examples the protective colloids include polyvinyl alcohols such as partially or completely saponified polyvinyl alcohol and cellulose derivatives such as hydroxyethyl cellulose.

Examples of polymerization initiators include hydrogen peroxide; persulfates such as sodium persulfate; organic peroxides such as benzoyl peroxide and lauroyl peroxide; azo compounds such as 2,2′-azobisisobutylonitrile and 2,2′-azobis(2,4-dimethylvaleronitrile); and redox polymerization initiators. In general, these initiators are used alone or in a combination at an amount about 0.1 to 3 parts by weight on the basis of 100 parts by weight of the polymerizable monomers. In particular, the initiator is preferably at least partially or totally hydrogen peroxide or an organic peroxide.

The polymerization initiator may be added to a polymerization system in any step, before, during, or after the addition of the polymerizable monomer or may be added to in two or more different steps, according to need.

In the emulsion polymerization, any known chain transfer agent may be used according so need. Examples of the chain transfer agent include t-dodecyl mercaptan, 2-mercaptoethanol, diisopropyl xanthogen, carbon tetrachloride, and trichlorobromomethane. The chain transfer agents may be used alone or in a combination, generally, at an amount of 5 mass % or leas to total polymerization monomers. Furthermore, the reaction system may further contain, for example, a pH adjuster, a polymerization modifier, and an antifoam.

In the emulsion polymerization, the polymerizable monomers are polymerized in the presence of the polymerization initiator. The polymerization temperature is usually 50° C. or higher, preferably 60° C. or higher, and more preferably 70° C. or higher and usually 120° C. or lower, preferably 100° C. or lower, and more preferably 90° C. or lower.

The polymer primary particles produced by emulsion polymerization have a volume-average particle diameter (Mv) of usually 0.02 μm or more, preferably 0.05 μm or more, and more preferably 0.1 μm or more and usually 3 μm or less, preferably 2 μm or less, and more preferably 1 μm or less. A smaller particle diameter than the above-mentioned range may cause a difficulty in control of agglomeration rate. A larger particle diameter than the range often coarsens the toner particles obtained by agglomeration, resulting in a difficulty in controlling the toner particle diameter.

The Tg by DSC of the binder resin at the polymer primary particles in the present invention is preferably 40° C. or higher and more preferably 55° C. or higher and preferably 80° C. or lower and more preferably 65° C. or lower. In this temperature range, satisfactory storage properties are obtained, and agglomeration properties are also retained. Since a higher Tg leads to poor agglomeration properties, it is necessary to use an excess amount of a flocculant or an excessively high agglomeration temperature. As a result, undesirable fine powder is readily generated. If the Tg of a binder resin cannot be precisely determined due to a change in heat quantity caused by other components, for example, due to the overlap of the melting peak with that of a polylactone or a wax, the Tg is defined as that determined by a system from which the other components are removed.

In the present invention, the acid number of the binder resin constituting the polymer primary particles is preferably 3 mg KOH/g or more and more preferably 5 mg KOH/g or more and usually 50 mg KOH/g or less and more preferably 30 mg KOH/g or less, when measured by a method according to JIS K0070.

The solid content of the polymer primary particles in the “dispersion of the polymer primary particles” used in the present invention is preferably 14 mass % or more and more preferably 21 mass % or more and preferably 30 mass % or less and more preferably 25 mass % or less. In such a range, the agglomeration rate of the polymer primary particles can be readily controlled empirically in the agglomeration step. As a result, the diameter, shape, and size distribution of the seed particles can be readily controlled within desired ranges.

In the present invention, the toner mother particles are produced by preparing a dispersion containing polymer primary particles formed by emulsion polymerization; mixing the dispersion with a dispersion of agents such as a colorant, a charge controlling agent, and a wax; agglomerating the primary particles in this dispersion into seed particles; and washing and drying the particles obtained by fusion (preferably after a shell-coating step for fixation or adhesion of, for example, resin microparticles).

The colorant is not particularly limited and may be any colorant that is usually used. Examples of the colorant include carbon blacks such as furnace black and lamp black; and magnetic colorants. The colorant is used at an amount sufficient for forming a visible image by developing the resulting toner and is preferably 1 part by weight or more and more preferably 3 parts by weight or more and preferably 25 parts by weight or less, more preferably 15 parts by weight or less, and most preferably 12 parts by weight or less.

The colorant may be magnetized. Examples of the magnetic colorants include ferromagnetic materials showing ferrimagnetism or ferromagnetism at about 0 to 60 C., which is ambient temperature at which, for example, printers and copiers are used. More specifically, examples of the magnetic colorants include magnetite (Fe₃O₄), maghematite (γ-Fe₂O₃), intermediates and mixtures of magnetite and maghematite, spinel ferrite (M_{z}Fe₃₋ₓO₄, wherein M is, for example, Mg, Mn, Fe, Co, Ni, Cu, Zn, or Cd), hexagonal ferrites such as BaO.6Fe₂O₃ and SrO.6Fe₂O₃, garnet oxides such as Y₃Fe₅O₁₂ and Sm₃Fe₅O₁₂, rutile oxides such as CrO₂, metals each as Cr, Mn, Fe, Co, and Ni, and their ferromagnetic alloys that show magnetism at about 0 to 60° C. Among them, preferred are magnetite, maghematite, and intermediates of magnetite and maghematite.

When a magnetic powder is used for inhibiting scattering or controlling charging of a toner while retaining the characteristics as a nonmagnetic toner, the amount of the magnetic powder is usually 0.2 mass % or more, preferably 0.5 mass % or more, and more preferably 1 mass % or more and usually 10 mass % or less, preferably 8 mass % or less, and more preferably 5 mass % or less. When a magnetic powder is used in a magnetic toner, the amount of the magnetic powder is usually 15 mass % or more and preferably 20 mass % or more and usually 70 mass % or less and preferably 60 mass % or less. An amount of the magnetic powder lower than the range may not achieve a sufficient magnetic force as a magnetic toner, and an amount higher than the range may cause fixation defects.

In the emulsion polymerization/agglomeration, usually, a dispersion of polymer primary particles and a dispersion of a colorant are mixed to form a dispersion mixture, and agglomeration of this dispersion mixture gives particle agglomerates. The colorant is preferably used in an emulsion state prepared by mechanical emulsification of the colorant in water in the presence of an emulsifier with, for example, a sand mill or a bead mill. The colorant dispersion preferably contains 10 to 30 parts by weight of the colorant and 1 to 15 parts by weight of the emulsifier on the basis of 100 parts by weight of water. The dispersing of the colorant is carried out under monitoring the particle diameter of the colorant in the dispersion such that the final volume-average particle diameter (Mv) is controlled to 0.01 μm or more and preferably 0.05 μm or more and preferably 3 μm or less and more preferably 0.5 μm or less. The amount of the colorant dispersion in the emulsion agglomeration is calculated such that the resulting agglomerated toner mother particles contain 2 to 10 mass % of the colorant.

The toner preferably contains a wax in order to, for example, enhance fixability. The wax may be contained in the polymer primary particles or in resin microparticles. In general, the difficulty in the regulation of agglomeration increases with the amount of the wax, resulting in a broad particle size distribution. Accordingly, in the emulsion polymerization/agglomeration, a wax dispersion is prepared by emulsification and dispersion of the wax in water so as to have a volume-average particle diameter (Mv) of 0.01 to 2.0 μm, more preferably 0.01 to 0.5 μm and added during the emulsion polymerization or agglomeration step. In order to disperse the wax in a toner at a suitable dispersion particle diameter, the wax is preferably added to the toner as a seed during the emulsion polymerization. By adding the wax as a seed, polymer primary particles containing the wax can be obtained. Consequently, the amount of the wax at the toner surface can be reduced, and thereby charging properties and heat resistance are prevented from decreasing. The amount of the wax used is calculated so that the polymer primary particles contain the wax in a concentration of preferably 4 mass % or more, more preferably 5 mass % or more, and most preferably 7 mass % or more and preferably 30 mass % or less, more preferably 20 mass % or less, and most preferably 15 mass % or less.

The wax may be added to the resin microparticles. In such a case, the wax is preferably added during the emulsion polymerization as a seed, as in the case of polymer primary particles. The amount of the wax in the resin microparticles is preferably lower than that in the polymer primary particles. In general, the wax added to the resin microparticles enhances the fixability, but increases the amount of fine powder, by the following reasons. The heated wax migrates to the toner surface at a higher rate and enhances the fixability. On the other hand, the addition of the wax contained to the resin microparticles broadens the particle size distribution and thus increases the difficulty of controlling the agglomeration, resulting in an increase in the amount of fine powder.

The toner used in the present invention may contain a charge-controlling agent for increasing the amount of charging and charging stability. The charge-controlling agent may be any conventional known compound. Example of the charge-controlling agent include metal complex compounds of hydroxycarboxylic acids, metal complexes of azo compounds, naphthol compounds, metal compounds of naphthols, nigrosine dyes, quaternary ammonium salts, and mixtures thereof. The amount of the charge-controlling agent is preferably 0.1 to 5 parts by weight on the basis of 100 parts by weight of the resin.

When a toner containing a charge-controlling agent is produced by emulsion polymerization/agglomeration, the charge-generating agent is added together with, for example, a polymerizable monomer in the emulsion polymerization step, or together with, for example, polymer primary particles and a colorant during the agglomeration step, or after the agglomeration of, for example, polymer primary particles and a colorant to an approximately suitable particle diameter as a toner. Among them, an emulsion containing particles with a volume-average particle diameter (Mv) of 0.01 to 3 μm prepared by emulsifying the charge-controlling agent in water using an emulsifier is preferably used. The amount of the charge-controlling agent dispersion used so the emulsion agglomeration is calculated such that the toner mother particles after agglomeration contain 0.1 to 5 mass % of the charge-controlling agent.

The volume-average particle diameters (Mv's) of, for example, the polymer primary particles, the resin microparticles, the colorant particles, the wax particles, and the charge-controlling agent particles are defined by values that are measured with Nanotrac by the methods described in the Examples.

In the agglomeration step of the emulsion polymerization/agglomeration, the components such as polymer primary particles, resin microparticles, colorant particles, and a charge-controlling agent and a wax may be mixed simultaneously or sequentially, according to need. However, the respective dispersions of the components, that is, dispersions of the polymer primary particles, resin particles, colorant particles, charge-controlling agent, and wax microparticles are preferably prepared in advance, from the viewpoints of uniformity in the composition and the particle diameter.

When these different dispersions are mixed, the agglomeration rates of the components contained in the dispersions are different from one another. Therefore, in order to achieve uniform agglomeration, it is preferable to gradually mix the dispersions continuously or periodically. Since the time required for appropriate addition varies depending on the amounts of dispersions to be mixed and the solid contents, the time is properly controlled. For example, a colorant particle dispersion is mixed with a polymer primary particles dispersion, preferably over 3 minutes. A resin microparticle dispersion is mixed with seed particles preferably conducted over 3 minutes.

The agglomeration treatment is carried out by a process, for example, heating in an agitation tank, admixing an electrolyte, reducing the concentration of the emulsifier in the system, or a combination thereof. In order to form particle agglomerates having a size similar to that of toner particles by agglomeration of primary particles under agitation, the size of the particle agglomerates is regulated by cohesive forces between the particles and shear forces by the agitation. The cohesive forces can be increased by the above-mentioned process.

The electrolyte used for agglomeration may be any organic salt or inorganic salt. Specific examples of the electrolyte include inorganic salts having monovalent metal cations such as NaCl, KCl, LiCl, Na₂SO₄, K₂SO₄, Li₂SO₄, CH₃COONa, and C₅H₅SO₃Na; inorganic salts having divalent metal cations such as MgCl₂, CaCl₂, MgSO₄, CaSO₄, and ZnSO₄; and inorganic salts having trivalent metal cations such as Al₂(SO₄)₃ and Fe₂(SO₄)₃. Among them, inorganic salts having bivalence or higher valences, i.e., multivalent metal cations can enhance the agglomeration rate and are therefore preferred from the viewpoint of productivity. However, since the amounts of particles, such as polymer primary particles, that have not been taken into seed particles are increased, fine powder not having a desired toner particle diameter is readily generated. Therefore, inorganic salts having monovalent metal cations, which do not have high agglomeration effect, are preferred from the viewpoint of suppressing the generation of fine powder.

The amount of the electrolyte is determined depending on, for example, the type of the electrolyte and the target particle diameter, and is usually 0.05 part by weight or more and preferably 0.1 part by weight or more and usually 25 parts by weight or less, preferably 15 parts by weight or less, and more preferably 10 parts by weight or less, on the basis of 100 parts by weight of solid components in the dispersion mixture. An amount smaller than the range may reduce the rate of the agglomeration reaction, whereby fine powder with a diameter of 1 μm or less remains after the agglomeration reaction and the average particle diameter of the agglomerate does not reach the desired size. An amount larger than the range may accelerate the rate of the agglomeration reaction to preclude the control of the particle diameter, resulting in yielding of agglomerate containing coarse particles and irregular-shaped particles.

The addition of the electrolyte is preferably carried out periodically or continuously over a certain time, not at one time. The time required for the addition varies depending on the amount of the electrolyte, but is preferably 0.5 minute or more. In general, since agglomeration starts immediately after the addition of the electrolyte, large amounts of polymer primary particles and colorant particles that are not agglomerated, or agglomerates thereof remains. These are one of sources of fine powder. The above-mentioned process can prevent such sharp agglomeration and thus achieve uniform agglomeration that does not generate fine powder.

The final temperature of the agglomeration step using an electrolyte is preferably 20° C. or higher and more preferably 30° C. or higher and preferably 70° C. or lower and more preferably 60° C. or lower. Furthermore, the particle diameter can be controlled within a specific range of the present invention by controlling the temperature before the agglomeration step. Some colorants used in the agglomeration step induce agglomeration, like the electrolyte. In the use of such a colorant, agglomeration may occur without the use of an electrolyte. This agglomeration can be prevented by cooling the polymer primary particle dispersion ahead of the admixing of the colorant dispersion. The agglomeration causes the occurrence of fine powder. In the present invention, the polymer primary particles is previously cooled to preferably 0° C. or higher and none preferably 2° C. or higher and preferably 15° C. or lower, more preferably 12° C. or lower, and most preferably 10° C. or lower. This method is effective for not only the agglomeration using the electrolyte but also the agglomeration not using the electrolyte, such as agglomeration by controlling pH or using a polar organic solvent. The application of the method is not limited to agglomeration.

The final temperature of the agglomeration step by heating as usually ((Tg of the polymer primary particles)—20°0 C.)) or higher and more preferably (Tg—10° C.) and usually Tg of the polymer primary particles or lower and more preferably (Tg—5° C.) or lower.

An exemplary method for preventing the sharp agglomeration, which induces the occurrence of fine powder, is use of desalted water. In the method using desalted water, agglomeration activity is lower than that of the method using an electrolyte, and, therefore, the method is not preferably employed in view of the production efficiency. Furthermore, since a large amount of filtrate is generated in the subsequent filtration step, it may be undesirable in some cases. However, such a method is very effective in the case that requires a delicate control of agglomeration as in the present invention. In the present invention, a combination of the method using desalted water and the method of heating or using an electrolyte is preferred. In such a case, the addition of desalted water after the addition of an electrolyte can readily control agglomeration, and such a method is particularly preferred.

The time required for agglomeration is optimised depending on the shape of the apparatus and the scale of the treatment. In order to obtain a desired particle diameter of toner mother particles, it takes preferably at least 30 minutes and more preferably one hour to increase the temperature from the temperature 8° C. lower than the temperature at the time for terminating the agglomeration step (hereinafter, optionally, abbreviated to “agglomeration final temperature”), for example, the temperature at the time for terminating the growth of seed particles by addition of an emulsifier or by control of pH, to the agglomeration final temperature. A prolonged time accelerates the taking-in of the polymer primary particles, colorant particles, and agglomerate thereof into seed particles or the agglomeration thereof to objective seed particles, resulting in a reduction in the amount of residual particles.

In order to obtain a toner satisfying all requirements (1) to 3), the agglomeration step is preferably carried out at an agglomeration rate not higher than that of usual agglomeration. The agglomeration rate is reduced by, for example, using a cooled dispersion, slowly adding a dispersion, using an electrolyte with a low agglomeration activity, adding an electrolyte continuously or periodically, increasing temperature at a low rate, or elongating the time required for agglomeration. The maturation step is preferably carried out so as not to cause redispersion of the agglomerated particles, for example, by reducing the rotation velocity, adding a dispersion stabilizer continuously or periodically, or mixing a dispersion stabilizer with water in advance. It is preferable that the toner satisfying all requirements (1) to 3) be obtained without a step for removing particles having a volume median diameter (Dv50) not satisfying the requirement from the finally obtained toner or toner mother particles by, for example, classification.

In the present invention, the toner mother particles are preferably prepared by agglomerating polymer primary particles into seed particles, applying the seed particles to shell-coating involving, for example, fixing or adhesion of resin microparticles to the seed particles, and fusion of the shell-coated particles, followed by washing and drying the resulting particles.

The rate of the resin microparticles is preferably 0.5 parts by weight or more and more preferably 5 parts by weight or more and preferably 30 parts by weight or less and more preferably 20 parts by weight or less on the basis of 100 parts by weight of the seed particles.

The resin microparticles may be produced by a method similar to that of the polymer primary particles without particular limitation. The total rate of the polar monomers is preferably 0.05 mass % or more, more preferably 0.1 mass % or more, and most preferably 0.2 mass % or more and preferably 3 mass % or less and more preferably 1.5 mass % or less on the basis of 100 mass % of the total polymerizable monomers constituting the binder resin of the resin microparticles. Within such a range, the dispersion stability of the resulting resin microparticles is increased, and the shapes and particle diameters of the particles can be readily controlled in the agglomeration step.

In addition, when the total amount of the polar monomers in the resin microparticles is less than that in the polymer primary particles on the basis of 100 mass % of all polymerizable monomers constituting the binder resin, the shapes and particle diameters of the particles can be readily controlled in the agglomeration step, the generation of fine power can be suppressed, and excellent charging characteristics can be obtained.

Furthermore, it is preferable that the Tg of the binder resin of the resin microparticles be higher than that of the binder resin of the polymer primary particles, from the viewpoint of storage stability.

In the present invention, toner mother particles can be formed by coating (adhesion or fixation) resin microparticles on the surfaces of the seed particles, according to need. The volume-average particle diameter (Mv) of the resin microparticles is preferably 0.02 μm or more and more preferably 0.05 μm or more and usually 3 μm or less and more preferably 1.5 μm or less. In general, the use of the resin microparticles enhances the generation of fine powder not reaching a certain toner particle diameter. Therefore, a toner coated with conventional resin microparticles contains fine powder not reaching a certain toner particle diameter in a large amount.

In the present invention, at a higher amount of wax, the fixability at high temperature is enhanced, but the wax readily bleeds to the toner surface, which may lead to degrade charging properties and heat resistance. However, such decreases in performance can be prevented by coating the surfaces of the seed particles with resin microparticles not containing waxes.

However, when both the resin microparticles and the wax are used for enhancing the fixability at high temperature, the resin microparticles adhering to the surfaces of the seed particles are readily detached. This is caused by that the particle size distribution of the resin microparticles is broadened to include coarse resin microparticles, which exhibits low adhesion. Accordingly, in order to decrease the detachment of the resin microparticles, a dispersion of particles of which the surfaces are coated with the resin microparticles is heated in the presence of an aqueous solution containing a dispersion stabilizer.

When “a heating process after the addition of an emulsifier” is employed, that is, when the maturation step is carried out after a sharp decrease of the agglomeration activity, the adhering resin microparticles may be readily detached due to the sharp decrease of the agglomeration activity. Therefore, it is preferable that the particles be fused after adhesion of the resin microparticles without decreasing the agglomeration activity but preventing an increase in the particle diameter.

In the emulsion polymerization/agglomeration, in order to increase the stability of the agglomerated particles, the maturation step for fusing the agglomerated particles is preferably carried out after the termination of growth of the toner mother particles by decreasing the agglomeration activity of the agglomerated particles by adding an emulsifies or a pH adjuster as a dispersion stabilizer.

The rate of the emulsifier used is not limited, but is preferably 0.1 part by weight or more, more preferably 1 part by weight or more, and most preferably 3 parts by weight or more and preferably 20 parts by weight or less, more preferably 15 parts by weight or less, and most preferably 10 parts by weight or less. The further agglomeration of the agglomerated particles generated in the agglomeration step can be suppressed by adding an emulsifier to agglomeration liquid or increasing the pH level of the agglomeration liquid before the completion of the maturation step. Therefore, the generation of coarse particles in the toner after the maturation step can be inhibited.

The particle diameter of a toner having a small particle diameter and a narrow particle size distribution, which is applied to the image-forming apparatus of the present invention is controlled to a specific range by, for example, reducing the rotation velocity before the addition of the emulsifies or the pH adjuster, that is, decreasing the shear force caused by the agitation. This method is preferably applied to a system with a low agglomeration activity, for example, a system where an emulsifier or a pH adjuster is added to the system at once for rapidly transferring the system to a stable (dispersion.) system. If the above-described method involving heating of a dispersion in the presence of a dispersion stabilizer is employed, the reduction of the rotation velocity in agitation causes excess agglomeration, resulting in generation of coarse particles.

As an example, the method can provide a toner having a specific particle size distribution and being applied to the image-forming apparatus of the present invention, that is, a toner satisfying all requirements (1) to (3) or a toner having the above-mentioned average sphericity. Furthermore, the amount of the fine powder particles can be controlled by regulating the degree of the reduction in the rotation velocity. For example, a toner with a smaller particle diameter and exhibiting a sharper particle size distribution than those of known toners can be provided by reducing the rotation velocity for agitation from 250 rpm to 150 rpm. Consequently, a toner with a specific particle size distribution that can be applied to the image-forming apparatus of the present invention can be prepared. This rotation velocity varies depending on, for example, the following conditions:

(i) the diameter of the agitator (as a general cylindrical one) and the maximum dimensions of the agitator blade (and its relative ratio),
(ii) the height of the agitator,
(iii) the circumferential velocity of the agitator blade end,
(iv) the shape of the agitator blade, and
(v) the position of the blade in the agitator container.
In particular, the circumferential velocity (iii) is preferably 1.0 to 2.5 m/sec, more preferably 1.2 to 2.3 m/sec, and most preferably 1.5 to 2.2 m/sec. Within this range, a suitable shear velocity can be applied to the particles without causing detachment of resin microparticles and coarsening of the toner particles.

The temperature of the maturation step is preferably higher than the Tg of the binder resin of polymer primary particles, more preferably at least 5° C. higher than the Tg. The temperature preferably does not exceed a temperature that is 80° C. higher than the Tg, more preferably not higher than a temperature that is 50° C. higher than the Tg. The time required for the maturation step varies depending on the shape of the objective toner, but the maturation temperature is kept for usually 0.1 hour or more and preferably 1 hour or more and usually 5 hours or less and preferably 3 hours or less after the temperature of the polymer constituting the polymer primary particles reached a temperature not lower than the glass transfer temperature.

The polymer primary particles in the agglomerate are fused to one another to be combined by the heat treatment, and the shape of the toner mother particles as the agglomerate becomes substantially spherical. The particle agglomerate before the maturation step is probably an assemble of polymer primary particles by electrostatic or physical agglomeration. After the maturation step, the polymer primary particles constituting the particle agglomerate are fused to one another, and the toner mother particles can be shaped into substantial spheres. In the maturation step, the toner can be shaped into various shapes by controlling, for example, the temperature and the time required for maturing, according to the purpose. For example, a grape-like shape is formed by the agglomeration of polymer primary particles, a potato-like shape is formed by the progress of fusion, and a spherical shape is formed by the further progress of fusion.

The particle agglomerate prepared through the steps described above is solid-liquid separated by a known method, and particle agglomerate is collected, and washed according to need, and dried to give objective toner mother particles.

Furthermore, the surfaces of the particles prepared by the emulsion polymerization/agglomeration may be provided with an outer layer with a thickness of preferably 0.01 to 0.5 μm of resin microparticles mainly containing a polymer by, for example, spray-drying, a in-situ method, or particle coating in liquid to give capsuled toner mother particles.

Toner mother particles that satisfy all the requirements (1) to (3) or the average sphericity can be prepared by the above-described creative method. Then, the treatment of the toner mother particles with an external addition described below can provide a toner that satisfies all the requirements (1) to (3) or the average sphericity.

The toner prepared by the emulsion polymerization/agglomeration has an average sphericity of 0.93 or more and most preferably 0.94 or more that is measured with a flow-type particle image analyzer, FPIA-2100. A higher sphericity causes less localization of charge density and tends to achieve uniform development. However, a completely spheric toner decreases cleaning ability. Therefore, the average sphericity is preferably 0.98 or less and more preferably 0.97 or less.

In molecular weight, peaks in gel permission chromatography (hereinafter, optionally, abbreviated to “GPC”) of the soluble part of the toner in tetrahydrofuran (hereinafter, optionally, abbreviated to “THF”), at least one of the peaks corresponds to a molecular weight of preferably 30000 or more, more preferably 40000 or more, and most preferably 50000 or more and preferably 200000 or less, more preferably 150000 or less, and most preferably 100000 or less. When all peak molecular weights are lower than the range, the mechanical durability in nonmagnetic-single-component development may be decreased. When all peak molecular weights are higher than the range, fixability at low temperature and fixation strength may be decreased.

The toner prepared by the emulsion polymerization/agglomeration may be charged positively or negatively, but preferred is a negatively charged toner. The charging properties of the toner can be controlled by, for example, selecting a charge-controlling agent and adjusting its amount or selecting an external additive and adjusting its amount.

### [Toner Preparation by Grinding]

Ground toner particles showing a specific particle size distribution for applicable to the image-forming apparatus of the present invention may be produced by any method without particular limitation. For example, the ground toner particles can be produced by a method involving excess classification.

The resin used for producing ground toner may be any known resin that is used for toners. Examples of the resin include resins of styrene, vinyl chloride, rosin-modified maleic acid, phenol, epoxies, saturated or unsaturated polyesters, ionomers, polyurethanes, silicones, ketones, ethylene-acrylate copolymers, xylene, and polyvinyl butyral. These resins may be used alone or in any combination.

The polyester resin is composed of a polyol and a polybasic acid and can be prepared by polymerization of a polymerizable monomer composite containing the polyol and the polybasic acid where at least one of the polyol and the polybasic acid is a multifunctional component (crosslinkable component) having three or more valents, according to need. Examples of bivalent alcohols used for synthesis of the polyester resin include diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, and 1,6-hexanediol; and bisphenol A alkylene oxide adducts such as bisphenol A, hydrogenated bisphenol A, polyoxyethylenated bisphenol A, and polyoxypropylenated bisphenol A. Among these monomers, the bisphenol A alkylene oxide adducts are preferably used as main components. In particular, adducts having an average alkylene oxide adduct number of 2 to 7 are preferred.

Examples of three or more valent polyols involved in the cross-linking of polyester include sorbitol, 1,2,3,6-hexane tetraol, 1,4-sorbitane, pentaerythritol, dipentaerythritol, tripentaerythritol, sucrose, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

Examples of the polybasic acid include maleic acid, fumaric acid, citraconic acid, itaconic acid, glucatonic acid, phthalic acid, isophthalic acid, terephthalic acid, cyclohexanedicarboxylic acid, succinic acid, adipic acid, sebacic acid, azelaic acid, malonic acid, anhydrides of these acids, lower alkyl esters, alkenyl or alkyl succinic acid such as n-dodecenylsuccinic acid and n-dodecylsuccinic acid, and other bivalent organic acids.

Examples of the three or higher valents polybasic acids being involved in the cross-linking of polyesters include 1,2,4-benzenetricarboxylic acid, 1,2,5-benzenetricarboxylic acid, 1,2,4-cyclohexanetricarboxylic acid, 2,5,7-naphthalenetricarboxylic acid, 1,2,4-naphthalenetricarboxylic acid, 1,2,5-hexanetricarboxylic acid, 1,3-dicarboxyl-2-methyl-2-methylenecarboxypropane, tetra(methylenecarboxyl)methane, 1,2,7,8-octanetetracarboxylic acid, and anhydrides thereof.

These polyester resins can be synthesized in a usual manner. Specifically, conditions such as the reaction temperature (170 to 250° C.) and the reaction pressure (5 mmHg to normal pressure) are determined according to the reactivity of the monomer, and the reaction is terminated after predetermined physical properties are obtained. The polyester resin of the present invention has an Sp of preferably 90° C. or more and more preferably 95° C. or more and preferably 135° C. or less and more preferably 133° C. or less. The range of the Tg is, for example, 50 to 65° C. for a softening point of 90° C., or 60 to 75° C. for a softening point of 135° C. If the Sp is loner than the range, an offset phenomenon in the fixation readily occurs. If one Sp is higher than the range, the fixation energy increases and the brilliance and the transparency tend to undesirably decrease in the case of color toners. In addition, if the Tg is lower than the range, the toner readily agglomerates and is fastened, and if the Tg is higher than the range, the strength of thermal fixation tends to undesirably decrease. The Sp can be controlled mainly by the molecular weight of the resin. The number-average molecular weight of a tetrahydrofuran-soluble resin when measured by GPC is preferably 2000 or more and more preferably 3000 or more and preferably 20000 or less and more preferably 12000 or less. The Tg can be controlled mainly by properly selecting monomer components constituting the resin. Specifically, the Tg is increased with use of an aromatic polybasic acid as a main component of the acidic component. That is, the main component is desirably phthalic acid, isophthalic acid, terephthalic acid, 1,2,4-benzenetricarboxylic acid, 1,2,5-benezenetricarboxylic acid, their anhydrides, or a lower alkyl ester, among the above-mentioned polybasic acids.

In the present invention, the Sp is defined as a value measured with a flow tester described in JIS K7210 and K6719. Specifically, the Sp is measured with a flow tester (CFT-500, manufactured by Shimadzu Corp.): About one gram of a sample is preliminarily heated at 50° C. for 5 minutes and then at a heating rate of 3° C./min while being extruded from a die with a pore size of 1 mm and a length of 10 mm under a load of 30 kg/cm² applied with a plunger with an area of 1 cm². A plunger stroke-temperature curve is drawn, the temperature corresponding to h/2 is defined as the softening point and where h is the height of the S-shape curve. The Tg can be defined as a value obtained by a usual method using a differential scanning calorimeter (Perkin-Elmer DSC7 or Seiko Denshi DSC120).

In general, a polyester resin having a higher acid number hardly achieves a stable high charge density and tends to show low charging stability as high-temperature and high-humidity. Accordingly, in the present invention, the acid number of the polyester resin is preferably 50 KOH mg/g or less, more preferably 30 KOH mg/g or less, and most preferably 3 to 15 KOH mg/g. The acid value may be adjusted to the range by controlling one ratio of an alcohol monomer and an acidic monomer used for resin synthesis. In addition, the acid value can be controlled by, for example, synthesizing the polyester resin by an acidic monomer component previously esterified to a lower alkylester by ester exchange reaction, or neutralizing residual acidic groups with a basic component such as amino group-containing glycol, but the control of the acid value is not limited to these methods and may be carried out by any known process. In the present invention, the acid value of the polyester resin is measured according to JIS K0070. In the case of low solubility resin in the solvent, a good solvent such as dioxane is used.

The polyester resin preferably exhibits physical properties within an area surrounded by straight lines defined by the following equations (a) to (d) in xy-coordinates of the glass transition temperature Tg (° C. of the polyester resin as a variant in x-axis and the softening point Sp (° C.) in y-axis:

Sp=4×Tg−110, Equation (a);

Sp=4×Tg−170, Equation (b);

Sp=90, Equation (c);

and

Sp=135. Equation (d);

A ground toner containing the polyester resin exhibiting the physical properties within an area surrounded by the straight lines defined by equations (a) to (d) can have significantly high resistance to mechanical stress and be prevented from agglomeration or solidification due to friction heat generated during continuous operation and can thus retain suitable charging properties over a long period of time.

Also in the ground toner, any colorant that is usually used can be used without particular limitation. For example, the colorant used in the above-described polymerized toner can be used. The content of the colorant is an amount that is sufficient for forming a visible image by developing the resulting toner and is similar to that in the polymerized toner, i.e., preferably 1 part by mass or more and more preferably 12 parts by mass and preferably 25 parts by mass or less, more preferably 15 parts by mass or less, and most preferably 12 parts by mass or less,

The ground toner may contain other components. For example, any known charge-controlling agent may be contained. Examples of the charge-controlling agent for positively charging include nigrosine dyes, amino group-containing vinyl copolymers, quaternary ammonium salt compounds, and polyamine resins. Examples of the charge-controlling agent for negatively charging include metal-containing azo dyes that contain metals such as chromium, zinc, iron, cobalt, and aluminum; and salts and complexes of salicylic acid or alkylsalicylic acids with the above-mentioned metals. The amount of the charge-controlling agent is preferably 0.1 part by mass or more and more preferably 1 part by mass or more and preferably 25 parts by mass (sic) and more preferably 15 parts by mass or less on the basis of 100 parts by mass of the resin. The charge-controlling agent may be mixed with the resin or adhere to the surfaces of the toner mother particles.

Among these charge-controlling agents, the amino group-containing vinyl copolymers and/or the quaternary ammonium salt compounds are preferred for positively charging, and salts and complexes of salicylic acid or alkylsalicylic acid with metals such as chromium, zinc, aluminum, and boron are preferred for negatively charging, from the viewpoints of charge-imparting ability and color toner adaptability (which means that charge-controlling agent itself is colorless or light-colored not to interfere the color tone of the toner).

Among them, the amino group-containing vinyl copolymers include copolymer resins of an aminoacrylate (such as N,N-dimethylaminomethylacrylate and N,N-diethylaminomethylacrylate) and styrene or methyl methacrylate. Examples of the quaternary ammonium salt compounds include salt-forming compounds of tetraethylammonium chloride or benzyltributylammonium chloride with naphtolsulfonic acid. The amino group-containing vinyl copolymers and the quaternary ammonium salt compounds for positively charging may be used alone or in a combination.

Among various known materials, preferred metal salts and metal complexes of salicylic acid or alkylsalicylic acids are complexes of 3,5-ditertiary-butylsalicylic acid with chromium, zinc, and boron. The colorant and the charge-controlling agent may be previously kneaded with a resin in preliminary dispersion treatment, so-called master batch treatment, in order to improve the dispersibility and compatibility in a toner.

The ground toner may contain any known material as other constituents, for example, a mold-releasing agent with a low melting point, such as a low molecular weight polyalkylene, a paraffin wax, or an ester wax.

An exemplary method for producing the ground toner exhibiting a specific particle size distribution of the present invention is as follows:

1. A resin, a charge-controlling material, a colorant, and additives used according to need are uniformly dispersed with a Henschel mixer;
2. The dispersion is melted and kneaded with a kneader, an extruder, or a roll mill;
3. The kneaded composite is roughly ground with a hammer mill or a cutter mill and then finely ground with a jet mill or an I-type mill;
4. The finely ground particles are classified with a dispersion classifier or a zig-zag classifier; and
5. An external additive such as silica is dispersed in the classified particles with a Henschel mixer.

In particular, the particles are classified so as to have a specific particle size distribution of the present invention in step 4, and thereby an electrostatic charge image-developing toner applied to the image-forming apparatus of the present invention can be produced by the grinding process.

### [Suspension Polymerization]

Suspension polymerization toner having a particle size distribution within a specific range of the present invention may be produced by any method without particular limitation. For example, the suspension polymerization is carried out by controlling, for example, the chemical structure such as the number of polar groups and the molecular weight distribution of binder polymer, the type and amount of additive (e.g., dispersion stabilizer) for improving the suspension state, the agitation intensity for suspension polymerization, the addition process of polymerizable monomer, the types and amounts of polymerization initiator and chain transfer agent, the polymerization temperature, or the degree of classification. A particularly preferred method is application of a high sheer force or an increased amount of dispersion stabilizer in the process of forming polymerizable monomer drops.

The raw material of a resin used for producing a suspension polymerization toner may be the same as those described in the emulsion polymerization/agglomeration.

### [Chemical Pulverization by Molten Suspension]

The toner exhibiting a particle size distribution in a specific range of the present invention may be produced by any chemical pulverization, such as molten suspension, without particular limitation. For example, the chemical pulverization is carried out by controlling, for example, the type, the chemical structure, or the molecular weight distribution of a binder polymer; the type and amount of an aqueous additive for improving the suspension status; the agitation intensity, the process, and the temperature when a polymer solution is added; and the degree of classification.

The resin used for producing a toner by the chemical pulverization such as molten suspension may be the same as those used in the grinding. Examples of other raw materials may be the same as those described in the suspension polymerization/agglomeration.

The toner applied to the image-forming apparatus of the present invention may be used in a two-component developer using a carrier for transferring a toner to an electrostatic latent image portion, a magnetic-single-component developer using a toner containing magnetic powder, or a nonmagnetic-single-component developer net containing magnetic power. However, in order to significantly utilise the effects of the present invention, the toner is preferably used as a nonmagnetic-single-component developer.

When the toner is used in a two-component developer, examples of the carrier for forming the developer together with the toner include known magnetic materials such as iron powder, ferrite, and magnetite carriers; the magnetic materials having surfaces coated with resin; and magnetic resin carriers. The coating resins on the carrier may be generally known resins, such as styrene resins, acrylic resins, styrene-acryl copolymer resins, silicone resins, modified silicone resins, and fluorine resins, but is not limited thereto. The average particle diameter of the carrier is not particularly limited, but is preferably 10 to 200 μm. The carrier is preferably used in a content of 5 to 100 parts by weight on the basis of one part by weight of the toner.

### [Structure of Electrophotographic Photoreceptor]

The image-forming apparatus and the cartridge of the present invention each have an electrophotographic photoreceptor including a specific photosensitive layer on an electroconductive support.

### [Electroconductive Support]

The electroconductive support used for the photoreceptor can be mainly formed of metal materials such as aluminum, aluminum alloys, stainless steel, copper, and nickel; resin materials provided with conductivity by being mixed with an electroconductive powder, such as a metal, carbon, or tin oxide; and resins, glass, and paper on which the surfaces are coated with an electroconductive material, such as aluminum, nickel, or ITO (indium oxide-tin oxide), by vapor deposition or coating. The shape of the electroconductive support may be, for example, a drum, a sheet, or a belt. Furthermore, an electroconductive material having an appropriate resistance value may be coated on an electroconductive support of a metal material for controlling conductivity or surface properties or for covering defect.

In the case of the electroconductive support composed of a metal material such as an aluminum alloy, the metal material is preferably used after the formation of a coating by anodization treatment. If the anodization coating is formed, it is desirable to conduct pore sealing treatment by a known

For example, an anodic oxide coating is formed by anodization in an acidic bath of, for example, chromic acrid, sulfuric acid, oxalic acid, boric acid, or sulfamic acid. Among them, anodization in sulfuric acid gives particularly effective results. In the case of the anodization in sulfuric acid, preferred, but nonlimiting, conditions are a sulfuric acid level of 100 to 300 g/L, a dissolved aluminum level of 2 to 15 g/L, a liquid temperature of 15 to 30° C., a bath voltage of 10 to 20 V, and a current density of 0.5 to 2 A/dm².

It is preferable to conduct pore sealing to the resulting anodic oxide coating. The pore sealing may be conducted by a known method and is preferably performed by, for example, low-temperature pore sealing treatment, dipping in an aqueous solution containing nickel fluoride as a main component, or high-temperature pore sealing treatment, dipping in an aqueous solution containing nickel acetate as a main component.

The concentration of the aqueous nickel fluoride solution used in the low-temperature pore sealing treatment may be appropriately determined, but the concentration in the range of 3 to 6 g/L can give a better result. Furthermore, in order to smoothly carry out the pore sealing treatment, the treatment temperature range is usually 25° C. or more and preferably 30° C. or more and usually 40° C. or lass and preferably 35° C. or less. In addition, the pH range of the aqueous nickel fluoride solution is usually 4.5 or more and preferably 5.5 or more and usually 6.5 or less and preferably 6.0 or leas. Examples of a pH regulator include oxalic acid, boric acid, formic acid, acetic acid, sodium hydroxide, sodium acetate, and aqueous ammonia. The treating time is preferably in the range of one to three minutes per micrometer of coating thickness. Furthermore, the aqueous nickel fluoride solution may contain, for example, cobalt fluoride, cobalt acetate, nickel sulfate, or a surfactant in order to further improve the coating physical properties. Then, washing with water and drying complete the low-temperature pore sealing treatment. Examples of the pore sealer for the high-temperature pore sealing treatment can include aqueous metal salt solutions of nickel acetate, cobalt acetate, lead acetate, nickel-cobalt acetate, and barium nitrate, and an aqueous nickel acetate solution is particularly preferred. The aqueous nickel acetate solution is preferably used in the concentration range of 5 to 20 g/L. The treatment temperature range is usually 0° C. or more and preferably 90° C. or more and usually 100° C. or less and preferably 98° C. or less. In addition, the pH of the aqueous nickel acetate solution is preferably in the range of 5.0 to 6.0. Examples of pH regulator can include aqueous ammonia and sodium acetate. The treating time is 10 minutes or more and preferably 20 minutes or more. Furthermore, the aqueous nickel acetate solution may also contain, for example, sodium acetate, organic carboxylic acid, or an anionic or nonionic surfactant in order to improve physical properties of the coating. Then, washing with water and drying complete the high-temperature pore sealing treatment. When the anodic oxide coating has a large average thickness, severer pore sealing conditions are required for treatment in a higher concentration of pore sealing solution at higher temperature for a longer period of time. In such a case, the productivity is decreased, and also surface defects, such as stains, blot, or blooming, may tend to occur on the coating surface. From these viewpoints, the anodic oxide coating is preferably formed so as to have an average thickness of usually 20 μm or less and particularly 7 μm or less.

The surface of the support may be smooth or may be roughened by specific milling or by grinding treatment. In addition, the surface may be roughened by mixing particles having an appropriate particle diameter to the material constituting the support. Furthermore, a drawing tube can be directly used, without conducting milling treatment, for cost reduction. In particular, in the case of use of an aluminum support without milling treatment, such as drawing, impacting, or die processing, blot or adherents such as foreign materials present on the surface or small scratches are eliminated by the treatment to give a uniform and clean support, and it is therefore preferred. Specifically, the electroconductive support preferably has a surface roughness Pa of 0.01 μm or more and 0.3 μm or less. A surface roughness Ra smaller than 0.01 μm may impair its adhesion, and a roughness Ra larger than 0.3 μm may readily cause image defects such as black spots. The particularly preferred range of the Ra is 0.01 to 0.20 μm.

The surface of the electroconductive support can be roughened so as to have a surface roughness within the range by a method of cutting the support surface with a cutting tool, a sandblasting process involving shooting microparticles onto the support surface, a process using an ice-particle washing device described in Japanese Unexamined Patent Application Publication No. 4-204538, or a horning process described in Japanese Unexamined Patent Application Publication No. 9-236937. Further usable examples are anodization, alumite treatment, a buffing process, a method by laser ablation described in Japanese Unexamined Patent Application Publication No. 4-233546, a method using a grinding tape described in Japanese Unexamined Patent Application Publication No. 8-001502, or a roller burnishing process described in Japanese Unexamined Patent Application Publication No. 8-001510. However, the method for roughening of support surface should not be limited thereto.

### [Definition and Measurement of Surface Roughness]

The surface roughness Ra means an arithmetic average roughness and is expressed by the average of absolute deviations from the average line. Specifically, a reference length is extracted from a roughness curve in tee direction in which the average line extends, and the sum of absolute deviations from the average line to the roughness curve in the extracted portion is determined. The surface roughness Ra is the average value of the deviations calculated from the sum. In Examples described below, the surface roughness Ra was measured with a surface roughness meter (Surfcom 570A, Tokyo Seimitsu). The measurement may be conducted with any other device that can give the same results within error of measurement.

Examples of the electroconductive material include metal drums of, for example, aluminum or nickel, plastic drums by vapor deposition coated with, for example, aluminum, tin oxide, or indium oxide, and paper or plastic drums coated with an electroconductive material. The raw material of the electroconductive support preferably has a specific resistance of 103 Ωcm (sic) or less.

### [Undercoat Layer]

The photoreceptor used in the image-forming apparatus of the present invention preferably includes an undercoat layer. The undercoat layer preferably contains a binder resin and metal oxide particles with a refractive index of 2.0 or less. The agglomerated secondary particles of the metal oxide particles preferably have a volume-average particle diameter of 0.1 μm or less and a 90% cumulative particle diameter of 0.3 μm or less in a liquid of the undercoat layer dispersed in a solvent mixture of methanol and 1-propanol at a weight ratio of 7:3. More preferably, the volume-average particle diameter is 0.09 μm or less, and the 90% cumulative particle diameter is 0.2 μm or less. A smaller volume-average particle diameter may cause insufficient cleaning and contamination of devices. Accordingly, the volume-average particle diameter is preferably 0.01 μm or more, and the 90% cumulative particle diameter is preferably 0.05 μm or more.

### [Metal Oxide Particles]

In the present invention, the undercoat layer preferably contains metal oxide particles. The metal oxide particles may be those generally used in electrophotographic photoreceptors. Examples of such metal oxide particles include particles of oxides of single metal elements, such as titanium oxide, aluminum oxide, silicon oxide, zirconium oxide, zinc oxide, and iron oxide; and particles of oxides of multiple metal elements, such as calcium titanate, strontium titanate, and barium titanate. Among them, metal oxide particles having a band gap of 2 to 4 eV are preferred. The metal oxide particles may be composed of one type or any combination of different types. Among these metal oxide particles, preferred are titanium oxide, aluminum oxide, silicon oxide, and zinc oxide, and more preferred are titanium oxide and aluminum oxide, and most preferred is titanium oxide.

The crystal form of the titanium oxide particles may be any of rutile, anatase, brookite, or amorphous. In addition, these crystal forms of the titanium oxide particles may be present together.

The metal oxide particles may be subjected to various kinds of surface treatment, for example, treatment with an inorganic material such as tin oxide, aluminum oxide, antimony oxide, zirconium oxide, or silicon oxide or an organic material such as stearic acid, a polyol, or an organic silicon compound. In particular, when titanium oxide particles are used, surface treatment is preferably conducted with an organic silicon compound. Examples of the organic silicon compound generally include silicone oils such as dimethylpolysiloxane and methylhydrogenpolysiloxane; organosilanes such as methyldimethoxysilane and diphenyldimethoxysilane; silazanes such as hexamethyldisilazane; and silane coupling agents such as vinyltrimethoxysilane, γ-mercaptopropyltrimethoxysilane, and γ-aminopropyltriethoxysilane. More preferred is a silane treating agent represented by the following Formula (1), which has favorable reactivity with metal oxide particles.

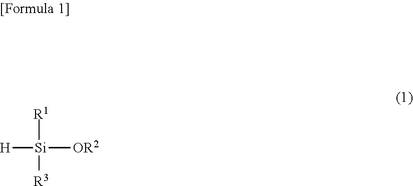

In Formula (1), R¹ and R² each independently represent an alkyl group, more specifically, represent a methyl group or an ethyl group. R³ represents an alky group or an alkoxy group, more specifically, represents a group selected from the group consisting of a methyl group, an ethyl group, a methoxy group, and an ethoxy group. The outermost surfaces of these surface-treated particles are treated with such a treating agent. In addition, before the surface treatment, the titanium oxide particles may be treated with a treating agent, such as aluminum oxide, silicon oxide, or zirconium oxide. The titanium oxide particles may be composed of one type of particles or any combination of different types of particles.

The metal oxide particles used usually have an average primary particle diameter of 500 nm or less, preferably 100 nm or less, and more preferably 50 nm or less and preferably 1 nm or more and more preferably 5 nm or more. This average primary particle diameter can be determined based on the arithmetic mean value of the diameters of particles that are directly observed by a transmission electron microscope (hereinafter, optionally, referred to as “TEM”.

Also, the metal oxide particles used may have various refractive index values, and those that can be used in electrophotographic photoreceptors can be used. The refractive index is preferably 1.4 or more and 3.0 or less. The refractive index of metal oxide particles are described in various publications. For example, they are shown in the following Table 1 according to Filler Katsuyo Jiten (Filler Utilization Dictionary, edited by Filler Society of Japan, Taiseisha LTD., 1994).

TABLE 1

| | Refractive index |
|---|---|
| Titanium oxide (rutile) | 2.76 |
| Lead titanate | 2.70 |
| Potassium titanate | 2.68 |
| Titanium oxide (anatase) | 2.52 |
| Zirconium oxide | 2.40 |
| Zinc sulfide | 2.37 to 2.43 |
| Zinc oxide | 2.01 to 2.03 |
| Magnesium oxide | 1.64 to 1.74 |
| Barium sulfate (precipitated) | 1.65 |
| Calcium sulfate | 1.57 to 1.61 |
| Aluminum oxide | 1.56 |
| Magnesium hydroxide | 1.54 |
| Calcium carbonate | 1.57 to 1.60 |
| Quartz glass | 1.46 |

In the metal oxide particles, commercially available examples of the titanium oxide particles include ultrafine titanium oxide particles without surface treatment, “TTO-55 (N)”, ultrafine titanium oxide particles coated with Al₂O₃, “TTO-55 (A)” and “TTO-55(B)”; ultrafine titanium oxide particles surface-treated with stearic acid, “TTO-55 (C)”; ultrafine titanium oxide particles surface-treated with Al₂O₃ and organosiloxane, “TTO-55 (S)”; high-purity titanium oxide “CR-EL”; titanium oxide produced by a sulfate process, “R-550”, “R-680”, “R-630”, “R-670”, “R-680”, “R-780”, “A-100”, “A-220”, and “W-10”; titanium oxide produced by a chlorine process, “CR-50”, “CR-58”, “CR-60”, “CR-60-2”, and “CR-67”; and electroconductive titanium oxide, “SN-100P”, “SN-100D”, and “ET-300W” (these are manufactured by Ishihara Industry Co., Ltd.); titanium oxide such as “R-60”, “A-100”, and “A-150”; titanium oxide coated with Al₂O₃, “SR-1”, “R-GL”, “R-5N”, “R-5N-2”, “R-52N”, “RK-1”, and “A-SP”; titanium oxide coated with SiO₂and Al₂O₃, “R-GX” and “R-7E”; titanium oxide coated with ZnO, SiO₂, and Al₂O₃, “R-650”; titanium oxide coated with SiO₂ and Al₂O₃, “R-61N” (these are manufactured by Sakai Chemical Industry Co., Ltd.); and titanium oxide surface-treated with SiO₂ and Al₂O₃, “TR-700”; titanium oxide surface-treated with ZnO, SiO₂, and Al₂O₃, “TR-840” and “TA-500”; titanium oxide without surface treatment, “TA-100”, “TA-200”, and “TA-300”; titanium oxide surface-treated with Al₂O₃, “TA-400” (these are manufactured by Fuji Titanium Industry Co., Ltd.); titanium oxide without surface treatment, “MT-150W” and “MT-500B”; titanium oxide surface-treated with SiO₂ and Al₂O₃, “MT-100SA” and “MT-500SA”; and titanium oxide surface-treated with SiO₂, Al₂O₃ and organosiloxane, “MT-100SAS” and “MT-500SAS” (these are manufactured by Tayca Corp.).

Commercially available examples of the aluminum oxide particles include “Aluminium Oxide C” (manufactured by Nippon Aerosil Co., Ltd.).

Commercially available examples of the silicon oxide particles include “200CF” and “R972” (manufactured by Nippon Aerosil Co., Ltd.) and “KEP-30” (manufactured by Nippon Shokubai Co., Ltd.).

Commercially available examples of the tin oxide particles include “SN-100P” (manufactured by Ishihara Industry Co., Ltd.). Commercially available examples of the zinc oxide particles include “MZ-305S” (manufactured by Tayca Corp.). The metal oxide particles used in the present invention are not limited thereto.

In a coating liquid for forming the undercoat layer of the electrophotographic photoreceptor in the present invention, the amount of the metal oxide particles is preferably 0.5 to 4 parts by weight on the basis of 1 part by weight of the binder resin.

### [Binder Resin]

The undercoat layer can contain any binder resin without particular limitation, as long as that the binder resin is soluble in an organic solvent that is generally used in coating liquid for forming an undercoat layer of the electrophotographic photoreceptor and that the undercoat formed is insoluble or hardly soluble in and substantially immiscible with an organic solvent that is used in a coating liquid for forming a photosensitive layer.

Examples of such a binder resin include phenoxy resins, epoxy resins, polyvinylpyrrolidone, polyvinyl alcohol, casein, polyacrylic acid, celluloses, gelatin, starch, polyurethane, polyimide, and polyamide. These resins may be used alone or in the cured form with a curing agent. Among these, polyamide resins such as alcohol-soluble copolymerized polyamides and modified polyamides exhibit favorable dispersibility and coating characteristics, and are preferred.

Examples of the polyamide resin include so-called copolymerized nylons, such as copolymers of 6-nylon, 66-nylon, 610-nylon, 11-nylon, and 12-nylon; and alcohol-soluble nylon resins, such as chemically modified nylons, e.g., N-alkoxymethyl-modified nylon and N-alkoxyethyl-modified nylon. Examples of commercially available products include “CM4000” and “CM8000” (these are manufactured by Toray Industries, Inc.), “F-30K”, “MF-30”, and “EF-30T” (these are manufactured by Nagase Chemtex Corporation).

Among these polyamide resins, particularly preferred is a copolymerized polyamide resin containing a diamine component corresponding to a diamine represented by the following Formula (2):

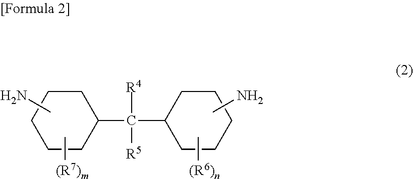

In Formula (2), each of R⁴ to R⁷ represents a hydrogen atom or an organic substituent, and m and n each independently represent an integer of from 0 to 4, when a plurality of the substituents are present, these substituents may be different from each other. Preferred examples of the organic substituent represented by R⁴ to R⁷ include hydrocarbon groups that may contain hetero atoms having up to 20 or less carbon atoms. More preferred examples are alkyl groups such as a methyl group, an ethyl group, an n-propyl group, and an isopropyl group; alkoxy groups such as a methoxy group, an ethoxy group, an n-propoxy group, and an isopropoxy group; and aryl groups such as a phenyl group, a naphthyl group, an anthryl group, and a pyrenyl group. More preferred are an alkyl group and an alkoxy group; and most preferred are a methyl group and an ethyl group.

Other examples of the copolymerized polyamide resin containing a diamine component corresponding to Formula (2) include binary, tertiary, and quaternary copolymers with lactams such as γ-butyrolactam, ε-caprolactam, and lauyllactam; dicarboxylic acids such as 1,4-butanedicarboxylic acid, 1,12-dodecanedicarboxylic acid, and 1,20-eicosanedicarboxylic acid; diamines such as 1,4-butanediamine, 1,6-hexamethylenediamine, 1,8-octamethylenediamine, and 1,12-dodecanediamine; and piperazine. The copolymerization ratio is not particularly limited, but the amount of the diamine component represented by the formula is generally 5 to 40 mol % and preferably 5 to 30 mol %.

The number average molecular weight of the copolymerized polyamide is preferably 10000 or more and most preferably 15000 or more and preferably 50000 or less and most preferably 35000 or less. If the number average molecular weight is too small or too large, the layer tends to be difficult to maintain the uniformity. The copolymerized polyamide may be produced by any method without particular limitation and is properly produced by usual polycondensation of polyamide. For example, polycondensation such as melt polymerization, solution polymerization, or interfacial polymerization can be properly employed. Furthermore, in the polymerization, for example, monobasic acids such as acetic acid or benzoic acid; or monoacidic bases such as hexylamine or aniline may be contained in a polymerization system as a molecular weight adjuster.

In addition, thermal stabilizers such as sodium phosphite, sodium hypophosphite, phosphorous acid, hypophosphorous acid, and hindered phenol, and other polymerization additives may be used. Examples of the copolymerized polyamide are shown below. In these examples, the copolymerization ration represents the feed ratio (molar ratio) of monomers.

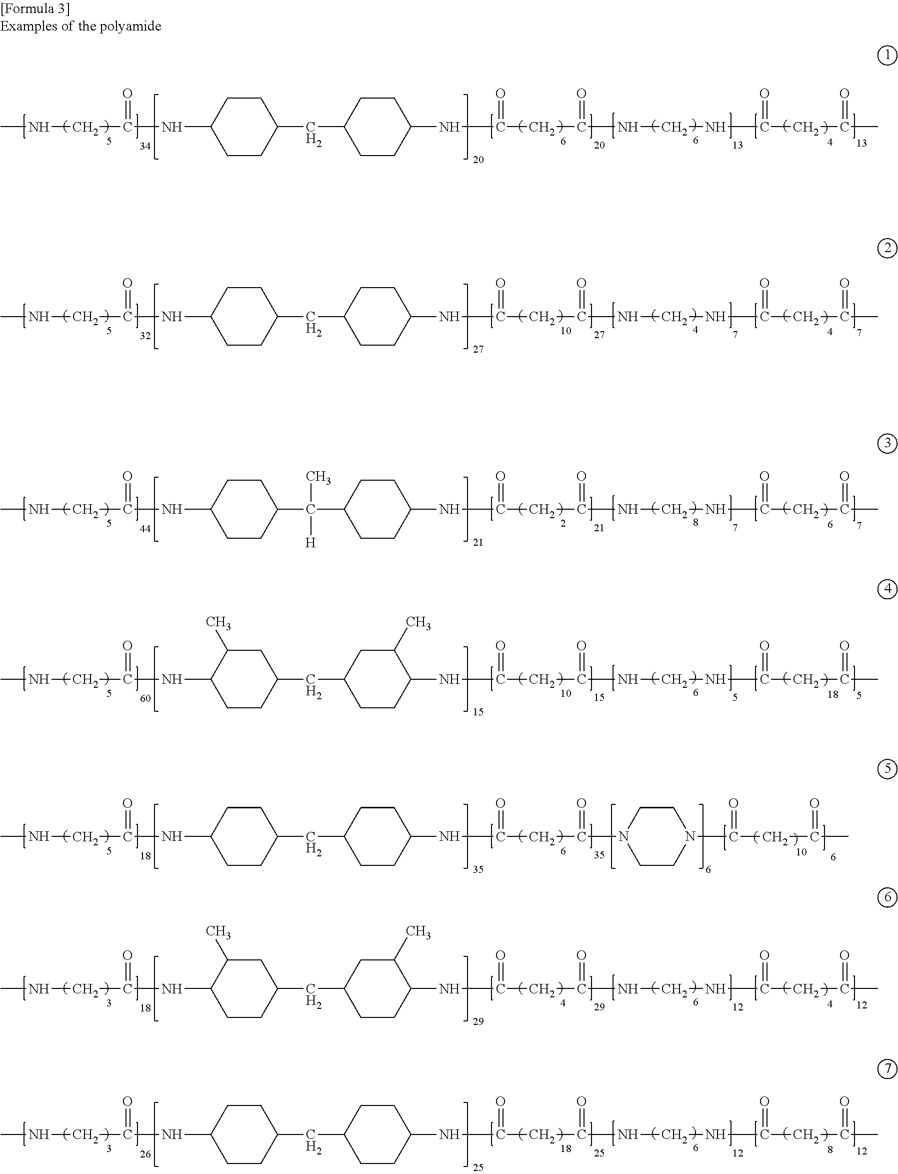

The electrophotographic photoreceptor used in the image-forming apparatus of the present invention preferably contains one or more curing resins. The curing resins are preferably contained in the undercoat layer. Preferred examples are thermosetting resins, photosetting resins, and EB-setting resins. These resins induce interpolymer reaction after the coating to form cross-links, resulting in hardening of the polymer.

An example of the curing resin will be specifically described. The thermosetting resin is a generic name of resins that are hardened by a chemical reaction caused by heat. Examples of the thermosetting resin include phenol resins, urea resins, melamine resins, epoxy resin cured products, urethane resins, and unsaturated polyester resins. Furthermore, a thermoplastic polymer may be provided with a curable substituent to have hardenability. In general, the thermosetting resin is also called a condensation-crosslinked polymer or addition-crosslinked polymer and is a polymer having a three-dimensional cross-link structure. In general, the reaction in the curing resin production proceeds with lapse of time to increase the reaction rate and molecular weight. This causes an increase in elastic modulus, a decrease in specific volume, and a significant decrease in solubility to solvents.

General thermosetting resins will be described. The phenol resin, which is a synthetic resin made of a phenol and formaldehyde, has advantages of inexpensiveness and ease of finely shaping. In general, the reaction between a phenol (P) and formaldehyde (F) under acidic conditions provides a resin with a molar ratio F/P of about 0.6 to 1, and the reaction in the presence of a base catalyst provides a resin with a ratio F/P of about 1 to 3.

The urea resin is a synthetic resin made of a reaction between urea and formalin and has advantages in that it is a transparent colorless solid and can be freely colored. In general, the reaction between urea and formaldehyde under acidic conditions produces polymethylene urea not having a methylol group, and the reaction under basic conditions produces a mixture of methylol ureas.

The melamine resin is a thermosetting resin obtained by a reaction between a melamine derivative and formaldehyde and has advantages in that it is excellent in hardness, water-resistance, and heat-resistance and also is colorless and transparent and can be freely colored, though it is more expensive than the urea resin. Therefore, the melamine resin is suitable for lamination and bonding.

The epoxy resin is a general name of thermosetting resins that can be hardened by graft polymerization with the epoxy group remaining in the polymer. A prepolymer before the graft polymerization is mixed with a curing agent, and the mixture is hardened with heat to provide a product. Both the prepolymer and the resin as the product are each called an epoxy resin. The prepolymer has two or more epoxy groups in one molecule and is mainly a liquid compound. This polymer forms three-dimensional polymers through reactions (mainly polyadditon) with various curing agents to provide cured epoxy resin products. The cured epoxy resin products have satisfactory bonding and adherent characteristics and exhibit excellent heat-resistance, chemical resistance, and electric stability. General-purpose epoxy resins are bisphenol A diglydyl (sic) ethers. Other glycidyl ester and glycidyl amine resin and cyclic aliphatic epoxy resins are also included. Examples of typical curing agents include aliphatic or aromatic polyamines, acid anhydrides, and polyphenols. These curing agents react with epoxy groups by polyaddition to form polymers and three-dimensional compounds. Other curing agents are, for example, tertiary amines and Lewis acids.

The urethane resin is a polymer compound generally composed of monomers copolymerized by urethane bonds that are formed by condensation of an isocyanate group and an alcohol group. In general, it consists of a liquid main component and a liquid curing agent at ambient temperature, and these two liquids are well mixed to give a solid polymer.

The unsaturated polyester resin consists of a liquid resin and a liquid curing agent at ambient temperature, and these two liquids are well mixed to give a solid polymer. The resin has high transparency, but high shrinkage after polymerization hardening, in other words, low size stability. The unsaturated resins that are commercially available may contain volatile solvents. Such resins are gradually deformed even after the hardening with volatilization of the solvent.

The photosetting resin is composed of a mixture of an oligomer (low polymer) each as epoxy acrylate or urethane acrylate, a reactive diluent (monomer), and a photopolymerization initiator such as benzoin or acetophenone.

Furthermore, addition-crosslinked polymers, which are obtained by copolymerization of multifunctional monomers such as divinylbenzene and ethylene glycol dimethacrylate, can be used.

It is preferable to simultaneously use a polymer other than curing resins. In particular, polyamide resins such as alcohol-soluble copolymerized polymides and the modified polyamides, which exhibit favorable dispersibility and coating characteristics, are preferred.

Any organic solvent can be used in the coating liquid for forming an undercoat layer as long as it can dissolve the binder resin for the undercoat layer. Examples of such organic solvents include alcohols containing at most five carbon atoms, such as methanol, ethanol, isopropyl alcohol, and n-propyl alcohol; halogenated hydrocarbons such as chloroform, 1,2-dichloroethane, dichloromethane, trichlene, carbon tetrachloride, and 1,2-dichloropropane; nitrogen-containing organic solvents such as dimethylforamide; and aromatic hydrocarbons such as toluene and xylene. These solvents can be used as a solvent mixture in any combination in any ratio. Furthermore, even if a single organic solvent cannot dissolve the binder resin for the undercoat layer, this organic solvent can be used in the form of a mixture with, for example, the above-mentioned organic solvents provided that the mixture can dissolve the binder resin. In general, a solvent mixture can reduce unevenness in coating.

The ratio of the solid components, such as the binder resin and the titanium oxide particles, to the organic solvent used in the coating liquid for forming an undercoat layer varies depending on the method for coating the coating liquid for forming an undercoat layer and may be determined such that a uniform coating can be formed by an applied coating method.

The coating liquid for forming a layer preferably contains metal oxide particles. In such a case, the metal oxide particles are dispersed in the coating liquid. The dispersion of the metal oxide particles can be prepared by, for example, wet dispersion using a known mechanical pulverizer, such as a ball mill, a sand grind mill, a planetary mill, or a roll mill, but a dispersion using a dispersion medium is preferred.

Any known dispersing apparatus can be used for dispersing using a dispersion medium. Examples of such dispersing apparatus include a pebble mill, a ball mill, a sand mill, a screen mill, a gap mill, a vibration mill, a paint shaker, and an attritor. Among them, preferred are those that can perform the dispersion by circulating the coating liquid. From the viewpoints of, for example, dispersion efficiency, final particle size, and continuous operation, wet agitating ball mills such as a sand mill, a screen mill, and a gap mill are particularly preferred. These mills may be either of a vertical type or a horizontal type. In addition, the disk of the mill may have any shape, and, for example, a flat plate type, a vertical pin type, or a horizontal pin type can be used. Preferred is a liquid circulating type sand mill.

The wet agitating ball mill includes a cylindrical stator, a slurry supplying port disposed at one end of the stator, a slurry discharging port disposed at the other end of the stator, a pin, disk, or annular rotor agitating and mixing the medium packed in the stator and the slurry supplied from the supplying port, and an impeller separator that is connected to the discharging port, rotates in synchronization with the rotor or rotates independently of the rotor, separates the slurry from the medium by centrifugal force, and discharges the slurry from the discharging port. In such wet agitating ball mills, a hollow discharging path connected to the discharging port is preferably disposed in the center of the shaft rotating the separator.

In such a wet agitating ball mill, the slurry separated from the medium by the separator is discharged through the center of the shaft. Since the centrifugal force does not work at the center of the shaft, the slurry discharged has no kinetic energy. Consequently, since wasteful kinetic energy is not generated, excess energy is not consumed.

Such a wet agitating ball mill may be horizontally disposed, but is preferably vertically disposed in order to increase the filling ratio of the medium. In the vertical installation, the discharging port is disposed at the upper end of the mill. Furthermore, the separator is desirably disposed at a position above the level of the packed medium. When the discharging port is disposed as the upper end of the mill, the supplying port is disposed at the bottom of the mill. In this case, more preferably, the supplying port consists of a valve seat and a vertically movable valve element that is fitted to the valve seat and has a V-shape, a trapezoidal shape, or a cone shape so as to be in line contact with the edge of the valve seat. With this, an annular slit can be formed between the edge of the valve seat sad the V-shape, a trapezoidal shape, or a cone shape valve element to prevent a medium from passing through. Therefore, raw slurry is supplied without deposition of the medium. In addition, the medium can be discharged by spreading the slit by lifting the valve element, or the mill can be sealed by closing the slit by lowering the valve element. Furthermore, since the slit is defined by the valve element and the edge of the valve seat, coarse particles in the raw slurry are barely caught in and, even if caught, the particles can be readily removed upward or downward. Thus, occlusion hardly occurs.

Such a wet agitating ball mill is desirably provided with a screen for separating the medium and a product slurry outlet at the bottom so that the product slurry remaining in the mill can be discharged after the completion of dispersion.

In the present invention, the wet agitating ball mill used for dispersing a coating liquid for forming an undercoat layer than has satisfactory applicability may have a separator of a screen or slit mechanism, but an impeller-type is desirable and a vertical impeller type is preferable. The wet agitating ball mill is desirably of a vertical type having a separator at the upper portion of the mill. In particular, when the filling rate of the medium is adjusted to 80 to 90%, pulverization is most efficiently performed, and the separator can be placed at a position higher than the level of the packed medium. This can prevent leakage of a medium which is carried on the separator.

An example of the wet agitating ball mill having such a structure is an Ultra Apex Mill manufactured by Kotobuki Industries Co., Ltd.

The output of an ultrasonic oscillator is not particularly limited, but is usually 100 W to 5 kW. In general, dispersion treatment of a small amount of the coating liquid with ultrasound from a low output ultrasonic oscillator is more efficient compared to that of a large amount of the coating liquid with ultrasound from a high output ultrasonic oscillator, Therefore, the amount of the coating liquid to be treated at once is preferably 1 L or more, more preferably 5 L or more, and most preferably 10 L or more and preferably 50 L or less, more preferably 30 L or less, and most preferably 20 L or less. The output of an ultrasonic oscillator in such a case is preferably 200 W or more, more preferably 300 W or more, and most preferably 500 W or more and preferably 3 kW or less, more preferably 2 kW or less, and most preferably 1.5 kW or less.

The method of applying ultrasonic vibration to the coating liquid for forming an undercoat layer is not particularly limited. For example, the treatment is carried, out by directly immersing an ultrasonic oscillator in a container containing the coating liquid for forming an undercoat layer, bringing an ultrasonic oscillator into contact with the outer wall of a container containing the coating liquid for forming an undercoat layer, or immersing a solution (sic) containing the coating liquid, for forming an undercoat layer in a liquid to which vibration is applied with an ultrasonic oscillator. Among these methods, a preferred method is the immersing of a solution (sic) containing the coating liquid for forming an undercoat layer in a liquid to which vibration is applied with an ultrasonic oscillator. In such a case, examples of the liquid to which vibration is applied with an ultrasonic oscillator include water; alcohols such as methanol; aromatic hydrocarbons such as toluene; and oils such as a silicone oil. In particular, water is preferred, in consideration of safe manufacturing operation, cost, washing properties, and other factors. In the immersion of the solution (sic) containing the coating liquid for forming an undercoat layer in a liquid to which vibration is applied with an ultrasonic oscillator, since the efficiency of the ultrasonic treatment varies depending on the temperature of the liquid, it is preferable to maintain the temperature of the liquid constant. The applied vibration may raise the temperature of the liquid that is subjected to the ultrasonic vibration. The temperature of the liquid subjected to the ultrasonic treatment is in the range of usually 5° C. or more, preferably 10° C. or more, and more preferably 15° C. or more and usually 60° C. or less, preferably 50° C. or less, and more preferably 40° C. or less.

The container for containing the coating liquid for forming an undercoat layer to be treated with ultrasound may be any container that is usually used for containing the coating liquid for forming an undercoat layer, which is used for forming a photosensitive layer of an electrophotographic photoreceptor. Examples of the container include containers made of resins such as polyethylene or polypropylene, glass containers, and metal cans. Among them, metal cans are preferred. In particular, an 18-liter metal can prescribed, in JIS Z1602 is preferred because of its high resistances to organic solvents and impacts.

The coating liquid for forming an undercoat layer may be filtered before use, in order to remove coarse particles, according to need. The filtration medium in such a case may be any filtering material that is usually used for filtration, such as cellulose fiber, resin fiber, or glass fiber. Preferred forms of the filtration medium include a so-called wound filter, which is made of a fiber wound around a core material and has a large filtration area to achieve high efficiency. Any known, core material can be used, and examples thereof include stainless steel core materials and core materials made of resins, such as polypropylene, that are not dissolved in the coating liquid for forming an undercoat layer.

To the resulting coating liquid for forming an undercoat layer, a binder and other auxiliary agents are further added to be used for forming an undercoat layer.

A dispersion medium with an average particle diameter of 5 to 200 μm is preferably used for dispersing metal oxide particles such as titanium oxide particles in the coating liquid for forming an undercoat layer.

Since the dispersion medium is, in general, substantially spherical, the average particle diameter can be determined by a sieving method using sieves described in, for example, JIS Z8801:2000 or image analysis, and the density can be measured by Archimedes's method. For example, the average particle diameter and the sphericity can be measured with an image analyzer represented by LUZEX50 manufactured by Nireco Corp. The average particle diameter of the dispersion medium is usually 5 μm or more and preferably 10 μm or more and usually 200 μm or less and preferably 100 μm or less. A dispersion medium having a smaller particle diameter tends to give a homogeneous dispersion within a shorter period of time. However, a dispersion medium having an excessively small particle diameter has significantly small mass, which precludes efficient dispersion.

The density of the dispersion medium is usually 5.5 g/cm³ or more, preferably 5.9 g/cm³ or more, and more preferably 6.0 g/cm³ or more. In general, a dispersion medium having a higher density tends to give homogeneous dispersion within a shorter time. The sphericity of the dispersion medium used is preferably 1.08 or less and more preferably 1.07 or less.

As the material of the dispersion medium, any known dispersion medium can be used, as long as it is insoluble in the coating liquid for forming an undercoat layer, has a specific gravity higher than that of the coating liquid for forming an undercoat layer, and does not react with or decompose the coating liquid for forming an undercoat layer. Examples of the dispersion medium include steel balls such as chrome balls (bearing steel balls) and carbon balls (carbon steel balls); stainless steel balls; ceramic balls such as silicon nitride, silicon carbide, zirconium, and alumina balls; and balls coated with films of, for example, titanium nitride or titanium carbonitride. In particular, ceramic balls are preferred, and fired zirconium balls are particularly preferred. More specifically, fired zirconium beads described in Japanese Patent No. 3400836 are particularly preferred.

### [Formation of Undercoat Layer]

In the present invention, a suitable undercoat layer is formed by applying the coating liquid for forming an undercoat layer onto a support by a known method, such as dip coating, spray coating, nozzle coating, spiral coating, ring coating, bar-coat coating, roll-coat coating, or blade coating, and drying it.

Examples of the spray coating include air spray, airless spray, electrostatic air spray, electrostatic airless spray, rotary atomizing electrostatic spray, hot spray, and hot airless spray. In consideration of the fineness of grains for obtaining a uniform thickness and adhesion efficiency, a preferred method is rotary atomizing electrostatic spray disclosed in Japanese Domestic Re-publication (Saikohyo) No. 1-805198, that is, continuous conveyance without spacing in the axial direction with rotation of a cylindrical work. This can give an electrophotographic photoreceptor that exhibits high uniformity of thickness of the undercoat layer with overall high adhesion efficiency.

Examples of the spiral coating method include a method using an injection applicator or a curtain applicator, which is disclosed in Japanese Unexamined Patent Application Publication No. 52-119651; a method of continuously spraying a coating liquid in the form of a line from a small opening, which is disclosed in Japanese Unexamined Patent Application Publication No. 1-231966; and a method using a multi-nozzle body, which is disclosed in Japanese Unexamined Patent Application Publication No. 3-193161.

In the case of the dip coating, in general, the total solid content in a coating liquid for forming an undercoat layer is in a range of usually 1 mass % or more and preferably 10 mass % or more and usually 50 mass % or less and preferably 35 mass % or less; and the viscosity is in a range of preferably 0.1 m Pa·s or more and preferably 100 m Pa·s or less.

After the application, the coating is dried. It is preferable that the drying temperature and times be adjusted so as to achieve necessary and sufficient drying. The drying temperature is usually 100° C. or more, preferably 110° C. or more, and more preferably 115° C. or more and usually 250° C. or less, preferably 170° C. or less, and more preferably 140° C. or less. The drying step can be carried out using a hot air dryer, a steam dryer, an infrared dryer, or far-infrared dryer.

### [Charge-generating Material]

The photosensitive layer formed on the electroconductive support may have a monolayer structure including a single layer containing a charge-generating material and a charge-transporting material dispersed in a binder resin, or a laminated structure including a charge-generating layer containing a charge-generating material dispersed in a binder resin and a charge-transporting layer containing a charge-transporting material dispersed in a binder resin, these layers being separated from each other.

The electrophotographic photoreceptor used in the present inventions contains oxytitanium phthalocyanine (hereinafter, optionally, referred to as “oxytitanium phthalocyanine of a specific crystal form”) showing main diffraction peaks at Bragg angles (2θ±0.2°) or 9.0° and 27.2° and at least one main diffraction peak in the range of 9.3° to 9.8° to CuKα characteristic X-rays (wavelength: 1.541 angstroms) in the photosensitive layer. The method of measuring the Bragg angle (diffraction peak) to CuKα characteristic X-rays (wavelength: 1.541 angstroms) and the definition in the present invention are according to the method described in Examples.

Oxytitanium phthalocyanine of a specific crystal form that can be used in the present invention may show any diffraction peak, in addition to the main diffraction peaks at Bragg angles (2θ±0.2°) of 9.0° and 27.2° and at least one main diffraction peak in the range of 9.3° to 9.8° to CuKα characteristic X-rays (wavelength: 1.541 angstroms). Examples of the positions of the other peaks include 14.3°, 14.8°, 18.0°, 23.8°, and 24.2°. From the viewpoints of characteristics of the electrophotographic photoreceptor, it is preferable that at least one, preferably two and more, and more preferably three and more diffraction peaks of the above-mentioned diffraction peaks be observed, in addition to the main diffraction peaks at 9.0° and 27.2° and at least one main diffraction peak in the range of 9.3° to 9.8°.

The at least one diffraction peak in the range of 9.3° to 9.8° is preferably shown in a range of 9.4° to 9.7°, more preferably 9.4° to 9.6°. In such a range, a plurality of peaks may be observed.

The advantages of the present invention can be achieved by an electrophotographic photoreceptor including a photosensitive layer containing oxytitanium phthalocyanine of a specific crystal form. The electrophotographic photoreceptor including a photosensitive layer containing oxytitanium phthalocyanine of a specific crystal form can be produced by bringing low-crystalline oxytitanium phthalocyanine or amorphous oxytitanium phthalocyanine, which is a precursor of oxytitanium phthalocyanine of a specific crystal form, into contact with, for example, an organic solvent for crystal transformation to give oxytitanium phthalocyanine of a specific crystal form and producing an electrophotographic photoreceptor using the resulting oxytitanium phthalocyanine; or can be produced using oxytitanium phthalocyanine showing a main diffraction peak at Bragg angle (2♭±0.2°) of 27.2° to CuKα characteristic X-rays (wavelength: 1.541 angstroms), which is different from the specific crystal form, and transforming this oxytitanium phthalocyanine into oxytitanium phthalocyanine of a specific crystal form in a preparation step of a photoreceptor, such as a preparation step of a coating liquid for forming a photosensitive layer. Either of the methods can be used, but, from the viewpoints of difficulty and production efficiency in crystal transformation into the oxytitanium phthalocyanine of a specific crystal form, the electrophotographic photoreceptor including a photosensitive layer containing the oxytitanium phthalocyanine of a specific crystal form is preferably produced using oxytitanium phthalocyanine showing a main diffraction peak at Bragg angle 2θ±0.2°) of 27.2° to CuKα characteristic X-rays (wavelength: 1.541 angstroms), which is different from the specific crystal form, and transforming this oxytitanium phthalocyanine into the oxytitanium phthalocyanine of a specific crystal form in the preparation step of a photoreceptor, such as the preparation step of a coating liquid for forming a photosensitive layer.

The oxytitanium phthalocyanine showing a main diffraction peak at Bragg angle (2θ±0.2°) of 27.2° to CuKα characteristic X-rays (wavelength: 1.541 angstroms), which is different from the specific crystal form, may be any known oxytitanium phthalocyanine, but is preferably oxytitanium phthalocyanine showing main diffraction peaks at Bragg angle (2θ±0.2°) of 0.0°, 14.2°, 23.9°, and 27.1° to CuKα characteristic X-rays (wavelength: 1.541 angstroms).

The oxytitanium phthalocyanine showing a main diffraction peak at Bragg angle (2θ±0.2°) of 27.2° to CuKα characteristic X-rays (wavelength: 1.541 angstroms), which is different from the specific crystal form, may be transformed into oxytitanium phthalocyanine of a specific crystal form by any known process, preferably, for example, a transformation process by a mechanical and physical force or a transformation process by collision between different dispersion systems of oxytitanium phthalocyanine showing a main diffraction peak at Bragg angle (2θ±0.2°) of 27.2° to CuKα characteristic x-rays (wavelength: 1.541 angstroms), which is different from the specific crystal form.

Examples of the apparatus used in the process of applying a mechanical and physical force include a planetary mill, a vibration mill, a CF mill, a roll mill, a sand, mill, a kneader, and a paint shaker. These apparatuses may be used with known media such as glass beads, steel beads, alumina beads, or zirconium beads.

In the present invention, charge-generating materials and dyes and pigments can be optionally used together with the crystalline phthalocyanine of a specific crystal form. Examples of the optional charge-generating materials are various types of photoconductive materials including inorganic photoconductive materials such as selenium and alloys thereof and cadmium sulfide; and organic pigments such as phthalocyanine pigments, azo pigments, dithioketopyrrolopyrrole pigments, squalene (squalilium) pigments, quinacridone pigments, indigo pigments, perylene pigments, polycyclic quinone pigments, anthanthrone pigments, and benzimidazole pigments. In the present invention, preferred are organic pigments, and particularly preferred are phthalocyanine pigments and azo pigments.

Examples of the phthalocyanine used include various crystal forms of metal-free phthalocyanine and phthalocyanine pigments with which metals such as copper, indium, gallium, tin, titanium, zinc, vanadium, silicon, and germanium, or oxides thereof, halides thereof, hydroxides thereof, or alkoxides thereof are coordinated. In particular, preferred are crystal forms with high-sensitivity, e.g., metal-free phthalocyanines of X-type and τ-type, oxytitanium phthalocyanine (alias: oxytitanium (sic) phthalocyanine) such as A-type (alias: β-type), B-type (alias: α-type), and D-type (alias: Y-type), vanadyl phthalocyanine, chloroindium phthalocyanine, chlorogallium phthalocyanine such as II-type, hydroxygallium phthalocyanine such as V-type, μ-oxo-gallium phthalocyanine dimer such as G-type and I-type, and μ-oxo-aluminum phthalocyanine dimer cases as II-type. Among these phthalocyanine pigments, particularly preferred are A-type (β-type), B-type (α-type), and D-type (Y-type) oxytitanium phthalocyanine, II-type chlorogallium phthalocyanine, V-type hydroxygallium phthalocyanine, and G-type μ-oxo-gallium phthalocyanine dimer.

In addition, the azo pigment used is preferably, for example, a bisazo pigment or a trisazo pigment. Preferred examples of the azo pigments are shown below. In the following formulae, Cp¹, Cp², and Cp³ represent couplers.

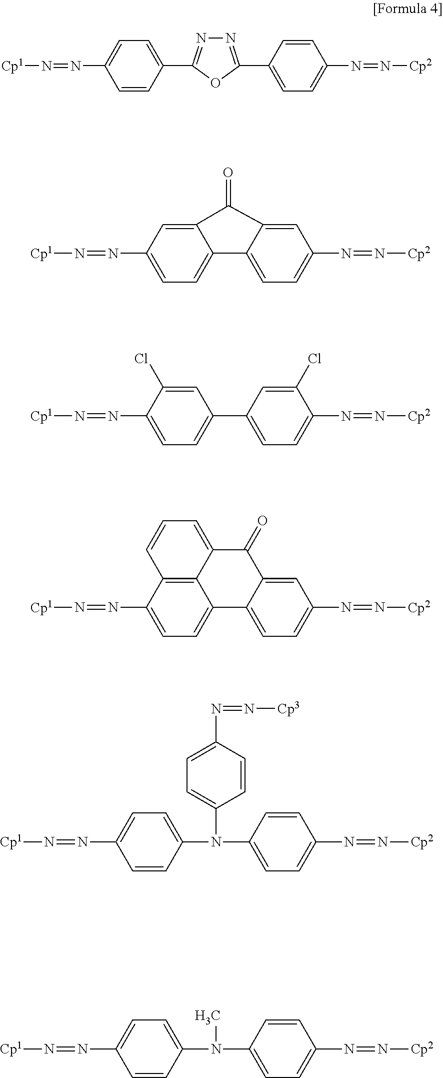

The couplers, Cp¹, Cp², and Cp³, preferably have the following structures:

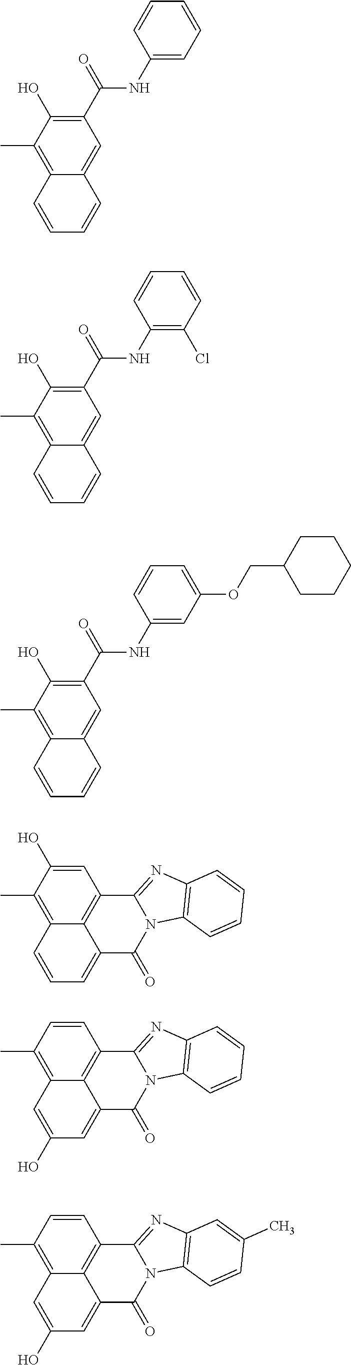

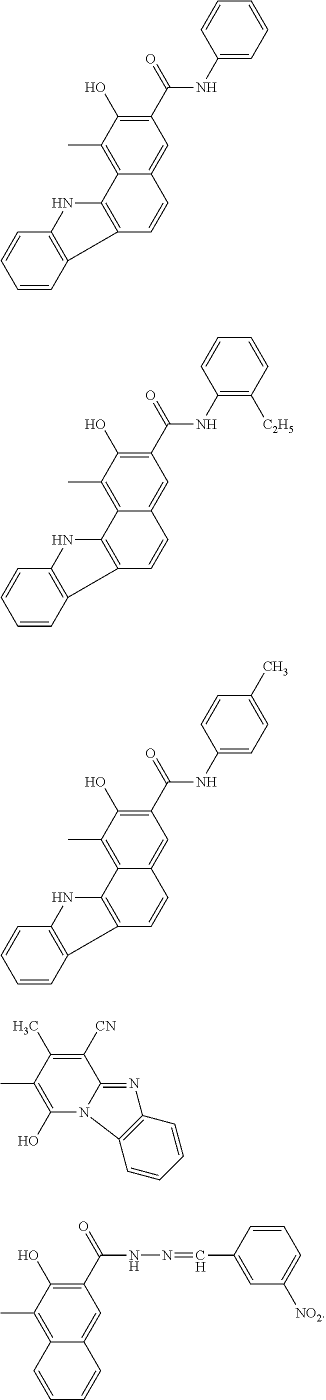

Examples of the binder resin that can be used for the charge-generating layer of a layered photoreceptor include, but not limited to, insulating resins such as polyvinyl acetal-based resins, e.g. a polyvinyl butyral resin, a polyvinyl formal resin, and partially acetal-modified polyvinyl butyral resins in which the butyral groups are partially modified with, for example, formal, or acetal, a polyarylate resin, a polycarbonate resin, a polyester resin, an ether-modified polyester resin, a phenoxy resin, a polyvinyl chloride resin, a polyvinylidene chloride resin, a polyvinyl acetate resin, a polystyrene resin, an acrylic resin, a methacrylic resin, a polyacrylamide resin, a polyamide resin, a polyvinyl pyridine resin, a cellulose-based resin, a polyurethane resin, an epoxy resin, a silicone resin, a polyvinyl alcohol resin, a polyvinyl pyrrolidone resin, casein, vinyl chloride-vinyl acetate-based copolymers, e.g. a vinyl chloride-vinyl acetate copolymer, a hydroxyl-modified vinyl chloride-vinyl acetate copolymer, a carboxyl-modified vinyl chloride-vinyl acetate copolymer, and a vinyl chloride-vinyl aceate-maleic anhydride copolymer, a styrene-butadiene copolymer, a polyvinylidene chloride-acrylonitrile copolymer, a styrene-alkyd resin, a silicone-alkyd resin, and a phenol-formaldehyde resin; and organic photoconductive polymers such as poly-N-vinylcarbazole, polyvinylanthracene, and polyvinylperylene. These binder resins may be used alone or in any combination of two or more. Among them, preferred are polyvinyl acetal resins, such as a polyvinyl butyral resin, a polyvinyl formal resin, and partially acetal-modified polyvinyl butyral resins in which the butyral groups are partially modified with preferably formal and more preferably with acetal.

Examples of the solvent or dispersion medium include saturated aliphatic solvents such as pentane, hexane, octane, and nonane; aromatic solvents such as toluene, xylene, and anisole; halogenated aromatic solvents such as chlorobenzene, dichlorobenzene, and chloronaphthalene; amide solvents such as dimethylformamide and N-methyl-2-pyrrolidone; alcohol solvents such as methanol, ethanol, isopropanol, n-butanol, and benzyl alcohol; aliphatic polyols such as glycerin and polyethylene glycol; straight, branched, or cyclic ketone solvents such as acetone, cyclohexanone, methyl ethyl ketone, and 4-methoxy-4-methyl-2-pentanone; ester solvents such as methyl formate, ethyl acetate, and n-butyl acetate; halogenated hydrocarbon solvents such as methylene chloride, chloroform, and 1,2-dichloroethane, straight or cyclic ether solvents such as diethyl ether, dimethoxy ethane, tetrahydrofuran, 1,4-dioxane, methyl cellosolve, and ethyl cellosolve; aprotic polar solvents such as acetonitrile, dimethyl sulfoxide, sulforane, and hexamethyl phosphate triamide; nitrogen-containing compounds such as n-butylamine, isopropanolamine, diethylamine, triethanolamine, ethylenediamine, and triethyldiamine; mineral oils such as ligroin; and water, and those that do not dissolve the undercoat layer described below are preferably used. These solvents may be used alone or in any combination of two or more.

In the charge-generating layer of the layered photoreceptor, the amount (weight) of the charge-generating layer is 10 to 1000 parts by weight and preferably 30 to 500 parts by weight on the basis of 100 parts by weight of the binder resin. The thickness of the charge-generating layer is generally 0.1 μm or more and preferably 0.15 μm or more and usually 4 μm or less and preferably 0.6 μm or less. A larger amount of the charge-generating material may cause a decrease in stability of the coating liquid due to undesirable agglomeration of the charge-generating material, and a smaller amount may cause insufficient sensitivity of a photoreceptor. Accordingly, it is preferable that the charge-generating material be used in the above-mentioned range. The charge-generating material may be dispersed by any known dispersion method, for example, ball-mill dispersion, attritor dispersion, or sand-mill dispersion. In this process, it is effective for the dispersion to reduce the particle diameter of the charge-generating material to 0.5 μm or less, preferably 0.3 μm or less, and more preferably 0.15 μm or less.

The laminated charge-generating layer contains the charge-generating material and preferably contains a charge-transporting material described below from the viewpoint of reproducibility of thin lines. The amount of the charge-transporting material is preferably 0.1 mol or more and 5 mol or less, on the basis of 1 mol of the charge-generating material. The amount is more preferably 0.2 mol or more and most preferably 0.5 mol or more. Since a larger amount may decrease the sensitivity, the upper limit is preferably 3 mol or less and more preferably 2 mol or less.

### [Charge-transporting Material]

The photosensitive layer formed on the electroconductive support may have a monolayer structure having a single layer contains a charge-generating material and a charge-transporting material dissolved or dispersed in a binder resin or a laminated structure including a charge-generating layer containing a charge-generating material dissolved or dispersed in a binder resin and a charge-transporting layer containing a charge-transporting material dispersed in a binder resin, these layers being separated from each other. In general, the photosensitive layer contains a binder resin and other components used according to need. Specifically, the charge-transporting layer can be formed by, for example, preparing a coating liquid by dissolving or dispersing a charge-transporting material and a binder resin in a solvent and applying this coating liquid onto a charge-generating layer in the case of a normally laminated photosensitive layer or onto an electroconductive support in the case of a reversely laminated photosensitive layer (or onto an interlayer if it is provided); and drying the coating.

The photosensitive layer so the present invention preferably contains a charge-transporting material with an ionization potential of 4.8 eV or more and 5.7 or less. The ionization potential can be readily measured with AC-1 (Riken) in air in the form of powder or film. Since a smaller ionization potential represents low resistance to ozone, the ionization potential is preferably 4.9 eV or more and more preferably 5.0 eV or more. Since a larger ionization causes a reduction in injection efficiency of charge from the charge-generating material, and the ionization potential is preferably 5.6 eV or less and more preferably 5.5 eV or less.

Specifically, the photoreceptor in the present invention preferably contains a compound represented by the following Formula (5):

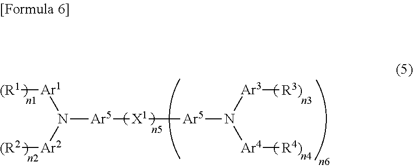

(in Formula (5), Ar¹ to Ar⁶ each independently represent an aromatic moiety optionally having a substituent or an aliphatic moiety optionally having a substituent, X¹ represents an organic moiety, R¹ to R⁴ each independently represent an organic group, and n1 to n6 each independently represent integers of 0 to 2).

In Formula (5), Ar¹ to Ar⁶ each independently represent an aromatic moiety optionally having a substituent or an aliphatic moiety optionally having a substituent. Examples of the aromatic moiety include moieties of aromatic hydrocarbons such as benzene, naphthalene, anthracene, pyrene, perylene, phenanthrene, and fluorene; and moieties of aromatic heterocycles such as thiophene, pyrrole, carbazole, and imidazole. The number of carbon atoms is preferably 5 to 20, more preferably 16 or less, and more preferably 10 or less. The lower limit is usually 6 or more, from the viewpoint of electric characteristics. Among these aromatic hydrocarbon moieties are preferred, and, in particular, a benzene moiety is preferred.

The number of carbon atoms of the aliphatic moieties is preferably 1 to 20, more preferably 16 or less, and most preferably 10 or less. In particular, in the case of the saturated aliphatic moiety, the number of carbon atoms is preferably 6 or less. In the case of the unsaturated aliphatic moiety, the number of carbon atoms is preferably 2 or more. Examples of the saturated aliphatic moieties include branched or linear alkyls such as methane, ethane, propane, isopropane, and isobutane; and examples of the unsaturated aliphatic moieties include alkenes such as ethylene and butylene.

Their substituents are not particularly limited. Examples of the substituent include alkyl groups such as a methyl group, an ethyl group, a propyl group, and an isopropyl group; alkenyl groups such as an allyl group; alkoxy groups such as a methoxy group, an ethoxy group, and a propoxy group; aryl groups such as a phenyl group, an indenyl group, a naphthyl group, an acenaphthyl group, a phenanthryl group, and a pyrenyl group; and heterocyclic groups such as an indolyl group, a quinolyl group, and a carbazolyl group. These substituents may form a ring through a linking group or by a direct bond.

The introduction of the substituent can control intramolecular charge to increase charge mobility. However, a bulky substituent may decrease charge mobility due to distortion of the intramolecular conjugate plane and intermolecular steric repulsion. Accordingly, the number of carton atoms of the substituent is usually 1 or more and preferably 6 or less, more preferably 4 or less, and most preferably 2 or less.

A plurality of substituents is preferred because it is effective for preventing crystal precipitation. However, a larger number of substituents may contrarily decrease charge mobility due to intramolecular conjugate distortion and intermolecular steric repulsion. Accordingly, the number of the substituents is preferably 2 or less per ring. The substituent is preferably not bulky for improved stability and electric characteristics of the compound in a photosensitive layer. More specifically, the substituent is preferably a methyl group, an ethyl group, a butyl group, an isopropyl group, or a methoxy group.

In particular, when Ar¹ to Ar⁴ are benzene moieties, they preferably have substituents. In such a case, the substituents are preferably alkyl groups, and a methyl group is particularly preferred. When Ar⁵ or Ar⁶ is a benzene moiety, the substituent is preferably a methyl group or a methoxy group. Furthermore, in Formula (5), Ar¹ preferably has a fluorene structure.

In Formula (5), X¹ represents an organic moiety, for example, an aromatic moiety optionally having a substituent; a saturated aliphatic moiety; a heterocyclic moiety; an organic moiety having an ether structure; or an organic moiety having a divinyl structure. The number of carbon atoms in the organic moiety is preferably 1 to 15. In particular, an aromatic moiety and a saturated aliphatic moiety are preferred. In the case of an aromatic moiety, the number of carbon atoms is preferably 6 to 14, and more preferably 10 or less. In the case of a saturated aliphatic moiety, the number of carbon atoms is preferably 1 to 10, and more preferably 8 or less.

X¹ of the organic moiety may have a substituent, and the substituent of X¹ is not particularly limited. Examples of the substituent include a alkyl groups such as a methyl group, an ethyl group, a propyl group, and an isopropyl group; alkenyl groups such as an allyl group; alkoxy groups such as a methoxy group, an ethoxy group, and a property group; aryl groups such as a phenyl group, an indenyl group, a naphthyl group, an acenaphthyl group, a phenanthryl group, and a pyrenyl group; and heterocyclic groups such as an indolyl group, a quinolyl group, and a carbazolyl group. Furthermore, these substituents may form a ring through a linking group or by a direct bond. The number of carbon atoms of the substituent is preferably 1 or more and preferably 10 or less, more preferably 6 or less, and most preferably 3 or less. More specifically, preferred are a methyl group, an ethyl group, a butyl group, an isopropyl group, and a methoxy group.

A plurality of substituents is preferred, because it is effective for preventing crystal precipitation. However, a larger number of the substituents may contrarily decrease charge mobility due to intramolecular conjugate distortion and intermolecular steric repulsion. Accordingly, the number of the substituents is preferably 2 or less per X¹.

R¹ to R⁴ (sic) each independently represent an integer of 0 to 2, and n1 is preferably 1 and n2 is preferably 0 or 1.

R¹ to R⁴ each independently represent an organic group, preferably having 30 or less carbon atoms, and more preferably 20 or less.

Furthermore, n5 and n6 each independently represent an integer of 0 to 2. When n5 is 0, X¹ represents a direct bond. When n6 is 0, n5 is preferably 0. When both n5 and n6 are 1, X¹ is preferably an alkylidene group, an arylene group, or a group having an ether structure. Examples of the alkylidene structure preferably include phenylmethylidene, 2-methylpropylidene, 2-methylbutylidene, and cyclohexylidene. Examples of the arylene structure preferably include phenylene and naphthylene. Furthermore, examples of the group having an ether structure preferably include —O—CH₂—O—.

Both n5 and n6 are 0, Ar⁵ is preferably a benzene moiety or a fluorene moiety. In particular, when Ar⁵ is a benzene moiety, the benzene moiety is preferably substituted by an alkyl group or an alkoxy group. The substituent is more preferably a methyl group or a methoxy group. In particular, the substituent is preferably bonded at the para-position with respect to the nitrogen atom. When n6 is 2, X¹ preferably a benzene moiety.

Examples of specific combinations of n1 to n6 are shown below.

| n1 | n2 | n3 | n4 | n5 | n6 |
|---|---|---|---|---|---|
| 1 | 0 | 0 | 0 | 0 | 0 |
| 1 | 1 | 0 | 0 | 0 | 0 |
| 1 | 0 | 1 | 0 | 0 | 1 |
| 1 | 1 | 1 | 1 | 0 | 1 |
| 2 | 2 | 0 | 0 | 0 | 0 |
| 1 | 0 | 0 | 0 | 0 | 0 |
| 2 | 2 | 2 | 2 | 1 | 1 |
| 1 | 1 | 1 | 0 | 2 | 1 |
| 1 | 1 | 1 | 1 | 1 | 2 |

Specific examples of a structure suitable for the charge-transporting material of the present invention are shown below.

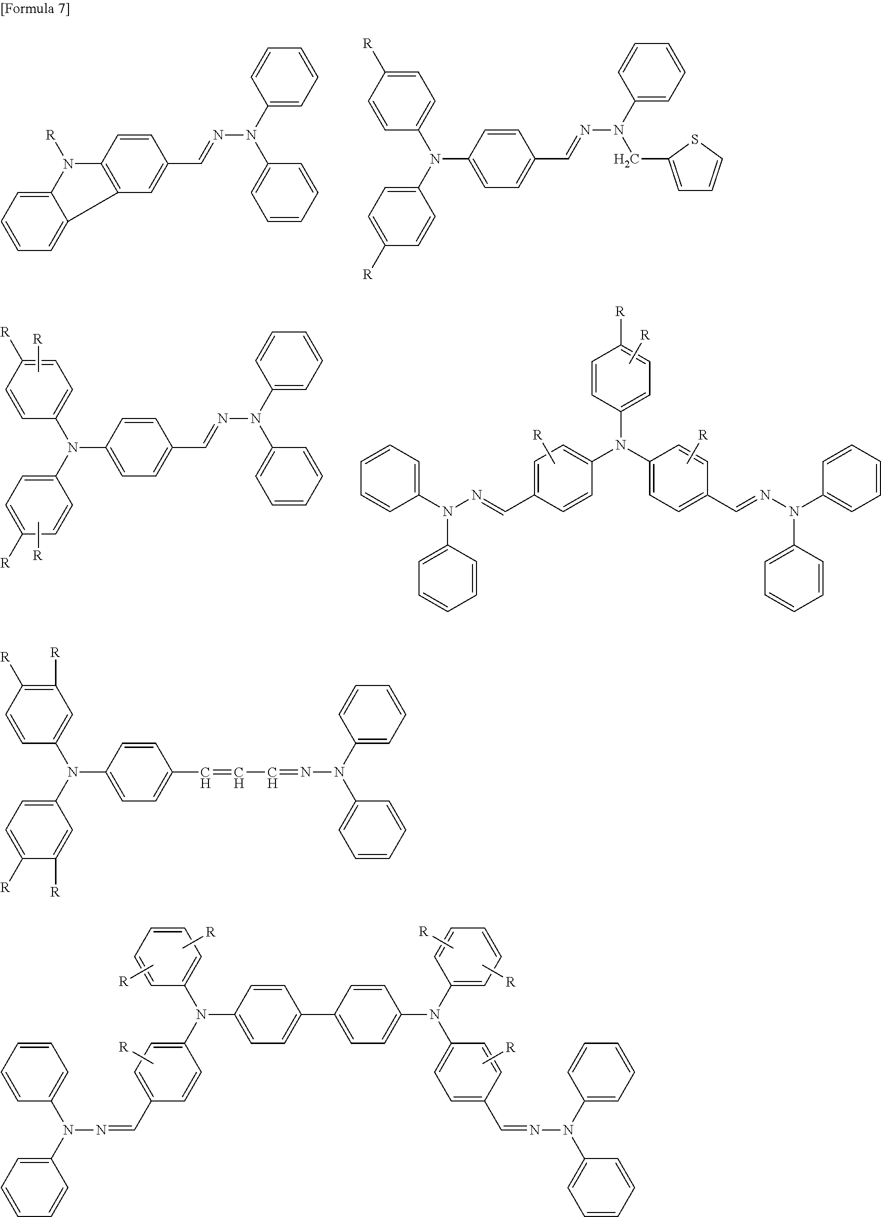

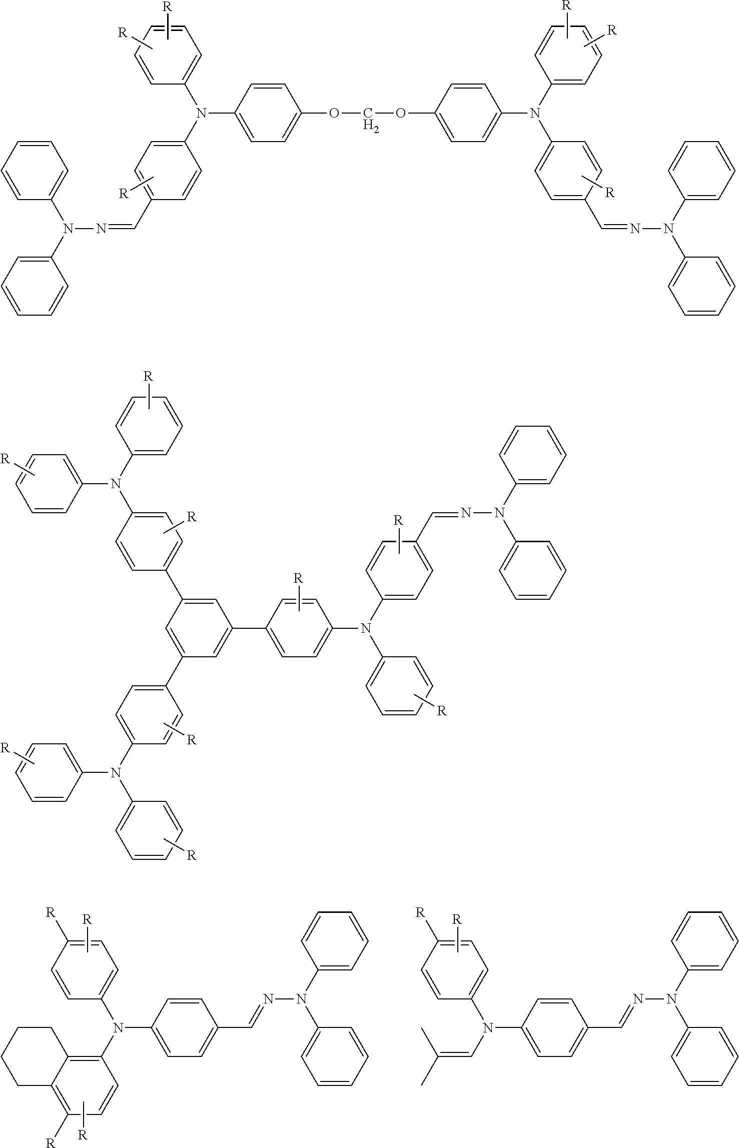

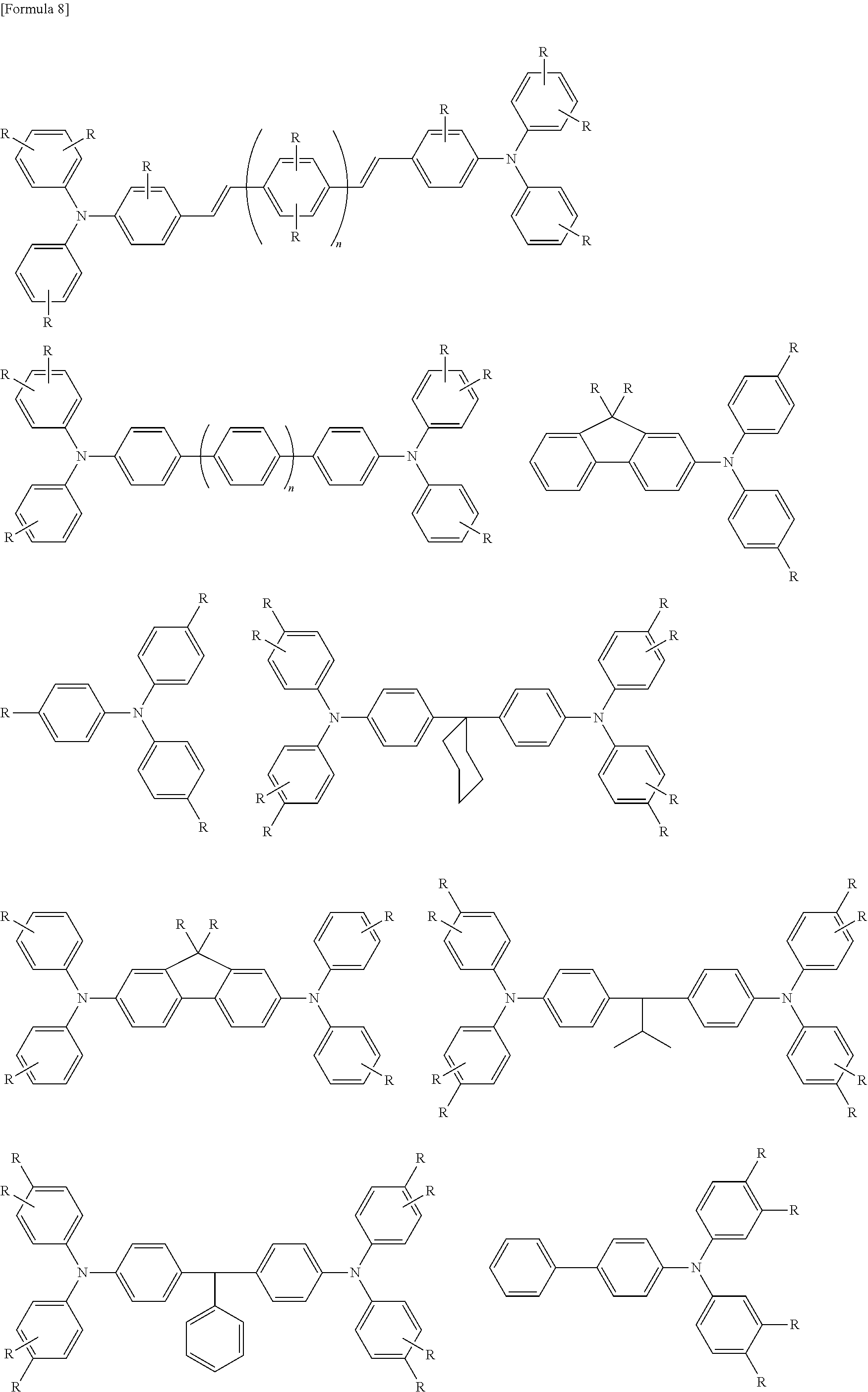

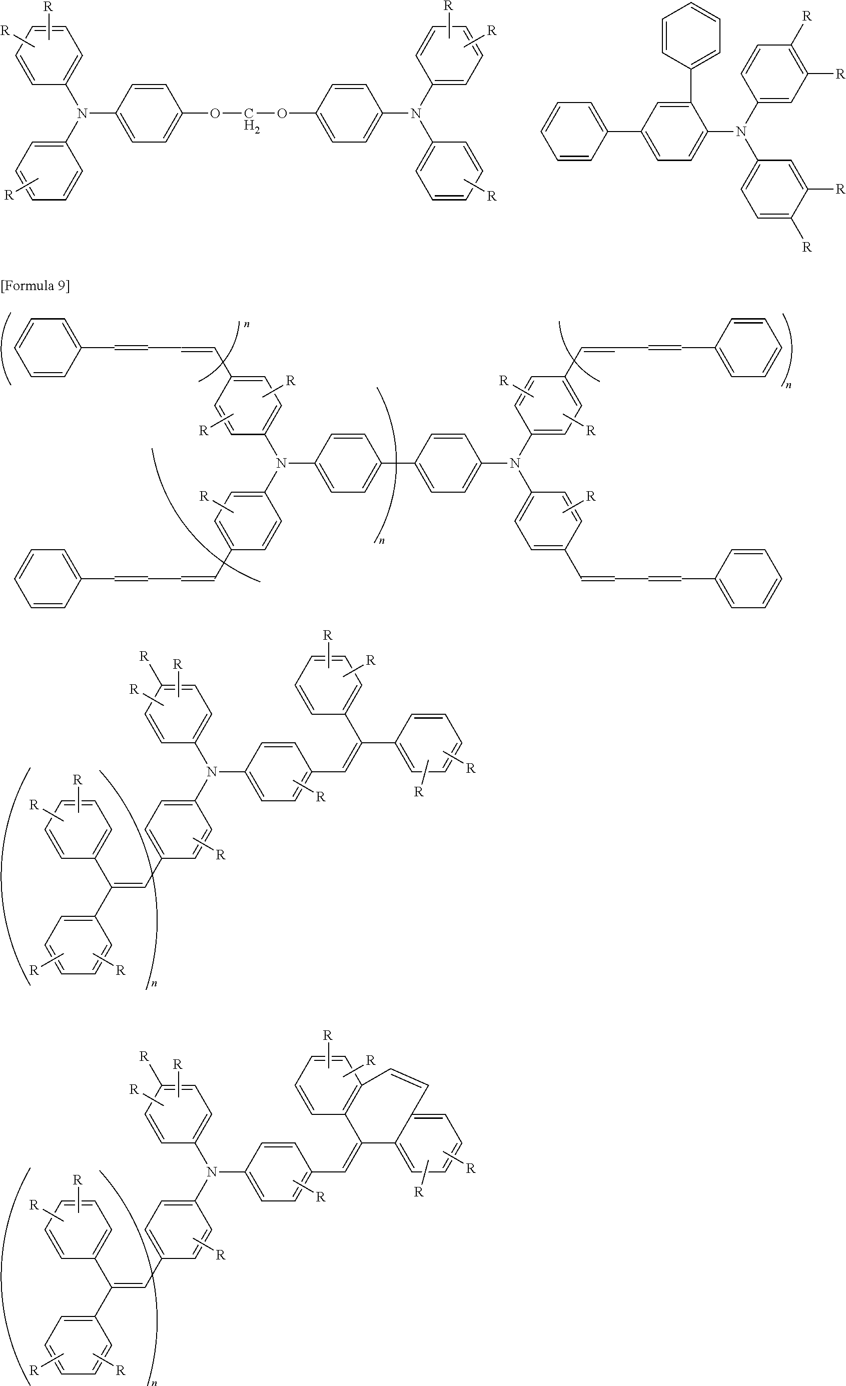

In the formulae, Rs may be the same or different from each other. Specifically, R is a hydrogen atom or a substituent. The substituent is preferably an alkyl group, an alkoxy group, or an aryl group. Particularly preferred is a methyl group or a phenyl group. Furthermore, n represents an integer of 0 to 2.

The charge-transporting material preferably satisfies the relation: 200 (angstroms³)≦α≦55 (angstroms³) (sic), where the polarizability αcal is calculated using geometry optimization based on a semiempirical molecular orbital calculation using an AM1 parameter of the charge-transporting organic material (herein after, referred to as “by semiempirical molecular orbital calculation (AM1)”, simply). In addition, the dipole moment Pcal based on a semiempirical molecular orbital calculation using the AM1 parameter preferably satisfies the relation: 0.2(D)<P<2.1(D) (sic).

The geometry optimization of a charge-transporting material calculated with PM3 has been reported, but, in the present invention, AM1 is used for the following reasons.

Reason 1: The charge-transporting material is made of carbon, hydrogen, oxygen, and nitrogen, in many cases. It is predicted that the use of AM1 where their parameters are fixed is suitable for the geometry optimization.

Reason 2: AM1 is reliable more than PM3 in calculation of charge distribution, which is necessary for calculation of dipole moment.

The polarizability αcal is preferably 70 or more and more preferably 90 or more from the viewpoint of thin-line reproducibility, and also 180 or less, preferably 150 or less, and more preferably 130 or less from the viewpoint of a change in images quality during repeated operations.

The dipole moment Pcal is preferably 0.4(D) or more and more preferably 0.6(D) or more from the viewpoint of memory due to transfer, and also preferably 2.0(D) or less, more preferably 1.7(D) or less, more preferably 1.5(D) or less, and most preferably 1.3(D) or less from the viewpoint of mobility.

Furthermore, a compound represented by Formula (5) may be used together with any known charge-transporting material. Examples of the known charge-transporting material include aromatic nitro compounds such as 2,4,7-trinitrofluorenone; cyano compounds such as tetracyanoquinodimethane; electron-attractive materials such as diphenoquinone; heterocyclic compounds such as carbazole derivatives, and benzofuran derivatives, imidazole derivatives, orazole derivatives, pyrazole derivatives, thiadiazole derivatives, and benzofuran derivatives; aniline derivatives, hydrazone derivatives, aromatic amine derivatives, stilbene derivatives, butadiene derivatives, enamine derivatives, and products in which some of these compounds are bonded to each other; and electron-donating materials such as polymers having groups composed of these compounds in their main chains or side chains. Among them, carbazole derivatives, aromatic amine derivatives, stilbene derivatives, butadiene derivatives, enamine derivatives, and products in which some of these compounds are bonded to each other are preferred. These charge-transporting materials may be used alone or in any combination of two or more.

### [Binder Resin]

In the formation of a charge-transporting layer of a photoreceptor having functionally separated charge-generating layer and charge-transporting layer or the formation of the photosensitive layer of a single-layer photoreceptor, a binder resin for dispersing the compounds is used for enhancing the layer strength. The functionally separated charge-transporting layer can be produced by application and drying of a coating liquid prepared by dissolving or dispersing a charge-transporting material and a binder resin in a solvent. The photosensitive layer of a single-layer photoreceptor can be produced by application and drying of a coating liquid prepared by dissolving or dispersing a charge-generating material, a charge-transporting material, and a binder resin in a solvent. Various resins can be used as the binder resin. Examples of the resins include butadiene resins, styrene resins, vinyl acetate resins, vinyl chloride resins, acrylic acid ester resins, methacrylic acid ester resins, vinyl alcohol resins, polymers and copolymers of vinyl compounds such as ethyl vinyl ether, polyvinyl butyral resins, polyvinyl formal resins, partially modified polyvinyl acetal, polycarbonate resins, polyester resins, polyarylate resins, polyamide resins, polyurethane resins, cellulose ester resins, phenoxy resins, silicone resins, silicone-alkyd resins, and poly-N-vinylcarbazole resins. These binder resins may be modified with a silicon reagent or any other reagent.

In the present invention, one or more different polymers prepared by interfacial polymerization are preferably used. The interfacial polymerization represents polycondensation proceeding at the interface between two or more immiscible solvents (in many cases, an organic solvent-water system). For example, a solution of dicarboxylic acid chloride dissolved in an organic solvent and a solution of a glycol component dissolved in, for example, alkaline water are mixed at ambient temperature and are separated into two phases. A polymer is produced by polycondensation at the interface between these two phases. Another example of two components is a combination of phosgene and an aqueous glycol solution. Furthermore, as in the condensation of a polycarbonate oligomer by interfacial polymerization, the interface may be used as a site for polymerization, not for separating two components into two phases.

The reaction solvent is preferably composed of two phases of an organic phase and an aqueous phase. The organic phase is preferably methylene chloride, and the aqueous phase is preferably an aqueous alkaline solution. Furthermore, a catalyst is preferably incorporated in the interfacial polymerization reaction. For example, in the case of interfacial polymerization using a glycol component, the amount of the catalyst used in the reaction is usually 0.005 mol % or more and preferably 0.03 mol % or more and usually 0.1 mol % or less and preferably 0.08 mol % or less on the basis of the glycol component. The use of the catalyst in an amount larger than 0.1 mol % may require many hours for extractive removal of the solvent in the washing step after the polycondensation.

The reaction temperature is 80° C. or less, preferably 60° C. or less, and more preferably in the range of 10° C. to 50° C. The reaction time varies depending on reaction temperature, but is usually 0.5 minute or more and preferably 1 minute or more and usually 20 hours or less, preferably 15 hours or less, and most preferably 10 hours or less. When the reaction temperature is too high, side reaction may not be controlled. On the other hand, a lower reaction temperature is a preferable condition for reaction control, but it may increase the refrigeration load to cause an increase in cost by that much.

The concentration of the component in the organic phase may be in the range wherein the resulting composite can dissolve the component, and, specifically, is about 10 to 40 mass %. The volume ratio of the organic phase to the aqueous alkali metal hydroxide solution, i.e., the aqueous phase, is preferably 0.2 to 1.0.

The amount of the solvent is preferably controlled so that the concentration of the resin produced in the organic phase by polycondensation is in the range of 5 to 30 mass % or less. After a certain period of time, an aqueous phase containing water and alkali metal hydroxide is further added thereto, and an optional condensation catalyst is also added to the mixture for controlling the polycondensation conditions, and desired polycondensation is accomplished by an interfacial polycondensation process. The volume ratio of the organic phase and the aqueous phase in the polycondensation is about 1:0.2 to 1:1.

Particularly preferred polymers produced by the interfacial polymerization are polycarbonate resins and polyester resins (polyacrylate resins are particularly preferred). The raw material of the polymer is preferably an aromatic diol, and preferred examples of the aromatic diol are represented by the following Formula (A):

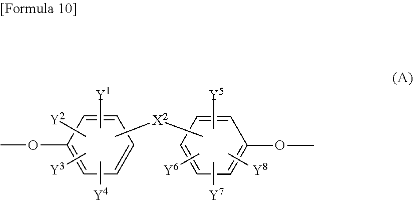

In Formula (A), X² represents a single bond or a linker, Y¹ to Y⁸ each independently represent a hydrogen atom or a substituent with 1 to 20 atoms.

In Formula (A), X² preferably represents a single bond or a linker having a structure shown below. The term “single bond” means that the two benzene rings in Formula (A) are directly bonded without the atom “X²”. In particular, it is preferable that X² do not have a cyclic structure.

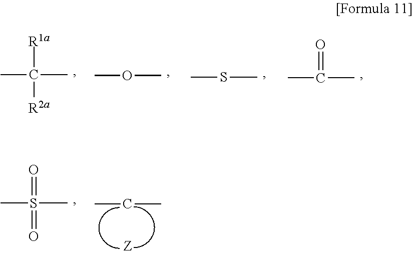

In the formulae, R^{1a} and R^{2a} each independently represent a hydrogen atom, an alkyl group with 1 to 20 carbon atoms, an optionally substituted aryl group, or an alkyl halide group; and Z represents an optionally substituted carbon hydride with 4 to 20 carbon atoms.

In particular, polycarbonate resins and polyarylate resins containing a bisphenol or biphenol component having a structure shown below are preferred from the viewpoints of sensitivity and residual potential. Among them, the polycarbonate resins are more preferred from the viewpoint of mobility.

The structures of the bisphenol or biphenol that can be suitably used in the polycarbonate resins are shown below. However, these are merely exemplified for clarifying the concept, and accordingly the present invention is not limited to these structures shown below, within the scope of the present invention.

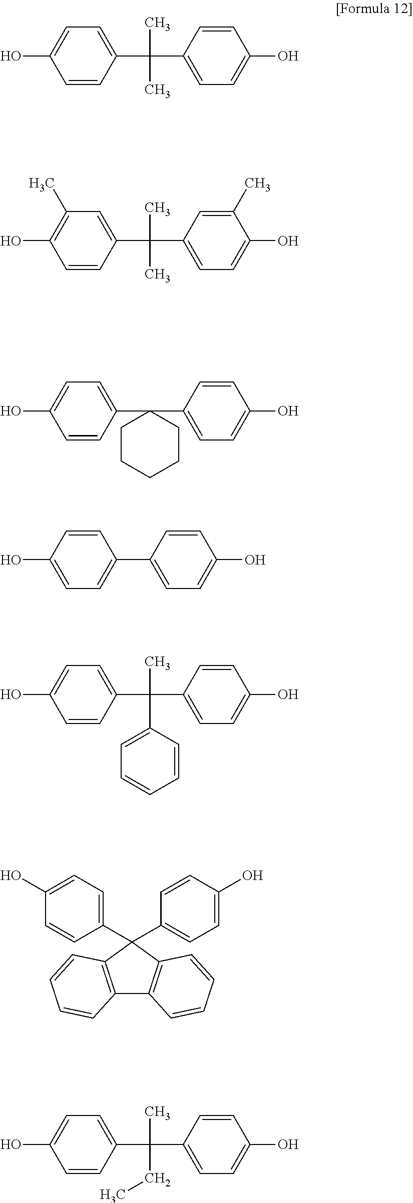

In particular, in order to achieve the highest advantages of the present invention, preferred are polycarbonates containing bisphenol derivatives having the following structures:

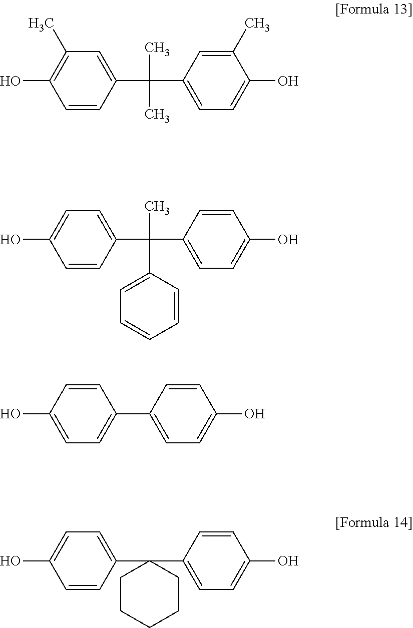 [SMILES: Cc1cc(C(C)(C)c2ccc(O)c(C)c2)ccc1O ; CC(c1ccccc1)(c1ccc(O)cc1)c1ccc(O)cc1 ; Oc1ccc(-c2ccc(O)cc2)cc1 ; Oc1ccc(C2(c3ccc(O)cc3)CCCCC2)cc1]

In order to improve mechanical characteristics, polyesters, in particular, polyarylate is preferably used. In such a case, the bisphenol components preferably have the following structures:

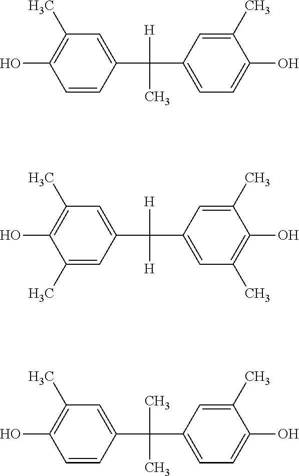 [SMILES: Cc1cc(C(C)c2ccc(O)c(C)c2)ccc1O ; Cc1cc(Cc2cc(C)c(O)c(C)c2)cc(C)c1O ; Cc1cc(C(C)(C)c2ccc(O)c(C)c2)ccc1O]

The acid components preferably have the following structures:

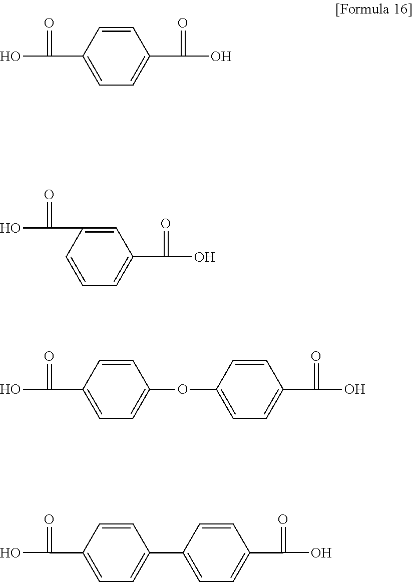 [SMILES: O=C(O)c1ccc(C(=O)O)cc1 ; O=C(O)c1cccc(C(=O)O)c1 ; O=C(O)c1ccc(Oc2ccc(C(=O)O)cc2)cc1 ; O=C(O)c1ccc(-c2ccc(C(=O)O)cc2)cc1]

In the case using the terephthalic acid and isophthalic acid, a higher molar ratio of terephthalic acid is preferred.

In both the charge-transporting layer of a laminated photoreceptor and the photosensitive layer of a single-layer photoreceptor, the amount of the charge-transporting material is usually 20 parts by weight or more on the basis of 100 parts by weight of the binder resin, preferably 30 parts by weight or more from the viewpoint of a decrease in the residual potential, and more preferably 40 parts by weight or more from the viewpoints of stability in repeated operation and charge mobility. On the other hand, the amount of the charge-transporting material is usually 150 parts by weight or less from the viewpoint of the thermal stability of the photosensitive layer, preferably 120 parts by weight or less from the viewpoint of the compatibility of the charge-transporting material and the binder resin, and more preferably 100 parts by weight or less from the viewpoint of printing durability, and most preferably 80 parts by weight or less from the viewpoint of scratch resistance.

In the single-layer photoreceptor, a charge-generating material is further dispersed in the medium containing the charge-transporting material in such an amount. In the single-layer photoreceptor, the particle diameter of the charge-generating material should be sufficiently small, and is preferably 1 μm or less and more preferably 0.5 μm or less. A smaller amount of the charge-generating material dispersed in the photosensitive layer cannot exhibit sufficient sensitivity, whereas a larger amount causes some disadvantages, i.e., a decrease in charging properties and a decrease in sensitivity. For example, the amount of the charge-generating material used is usually 0.1 mass % or more, preferably 1 mass % or more and usually 50 mass% or less and preferably 20 mass % or less.

The thickness of the photosensitive layer of the single-layer photoreceptor is usually 5 μm or more and preferably 10 μm Or more and usually 100 μm or less and preferably 50 μm or less. The thickness of the charge-transporting layer of a normally laminated photoreceptor is usually in the range of 5 to 50 μm, and preferably 10 to 45 μm from the viewpoints of long service life and image stability, and more preferably 10 to 30 μm from the viewpoint of high resolution.

The photosensitive layer may further contain known additives such as an antioxidant, a plasticizer, an ultraviolet absorber, an electron-attractive compound, a leveling agent, and a visible light-shielding agent in order to improve film-forming characteristics, flexibility, coating characteristics, contamination resistance, gas stability, light stability, or other characteristics. Furthermore, the photosensitive layer may optionally contain various additives such as a leveling agent, an antioxidant, or a sensitizer in order to improve coating characteristics. Examples of the antioxidant include hindered phenol compounds and hindered amine compounds. Examples of the visible light-shielding agent include a variety of coloring compounds and azo compounds. Examples of the leveling agent include silicone oils and fluorinated oils.

### [Antioxidant]

The antioxidant is one of the stabilizers that are used for preventing oxidation of components contained in a photoreceptor. The antioxidant functions as a radical scavenger. Examples of the antioxidant include phenol derivatives, amine compounds, phosphonate esters, sulfur compounds, vitamins, and vitamin derivatives. Among them, preferred are phenol derivatives, amine compounds, and vitamins. Particularly preferred are hindered phenol and trialkyl amine derivatives that have one of more bulky substituents near the hydroxy group. In particular, preferred are aryl derivatives having a t-butyl group at the o-position relative to the hydroxy group, and more preferred are aryl derivatives having two t-butyl groups at the o-position to the hydroxy group.

An antioxidant having a higher molecular weight may exhibit poor antioxidation effect. Preferred antioxidant has a molecular weight of 1500 or less and preferably 1000 or less and 100 or more, preferably 150 or more, and most preferably 200 or more.

The antioxidant that can be used in one present invention will be described below. The antioxidant may be any known antioxidant, ultraviolet absorber, or light stabilizer used for, for example, plastics, rubber, petroleum, or oils. In particular, preferably used are materials selected from the following compound group:

(1) Phenols disclosed in Japanese Unexamined Patent Application Publication No. 57-122444, phenol derivatives disclosed in Japanese Unexamined Patent Application Publication No. 60-188956, and hindered phenols disclosed in Japanese Unexamined Patent Application Publication No. 63-018356;
(2) Paraphenylenediamines disclosed in Japanese Unexamined Patent Application Publication No. 57-122444, paraphenylenediamine derivatives disclosed in Japanese Unexamined Patent Application Publication No. 60-188956, and paraphenylenediamines disclosed in Japanese Unexamined Patent Application Publication No. 63-18356;
(3) Hydroquinones disclosed in Japanese Unexamined Patent Application Publication No. 57-122444, hydroquinone derivatives disclosed in Japanese Unexamined Patent Application Publication No. 60-188956, and hydroquinones disclosed in Japanese Unexamined Patent Application Publication No. 63-18356;
(4) Sulfur compounds disclosed in Japanese Unexamined Patent Application Publication No. 57-188956 and organic sulfur compounds disclosed in Japanese Unexamined Patent Application Publication No. 63-18356;
(5) Organic phosphor compounds disclosed in Japanese Unexamined Patent Application Publication No. 57-122444 and organic phosphor compounds disclosed in Japanese Unexamined Patent Application Publication No. 63-18356;
(6) Hydroxyanisoles disclosed in Japanese Unexamined Patent Application Publication No. 57-122444;
(7) Piperidine derivatives and oxopiperidine derivatives having a specific skeleton structure disclosed in Japanese Unexamined Patent Application Publication No. 63-018355; and
(8) Carotenes, amines, tocopherols, Ni(II) complexes, and sulfides disclosed in Japanese Unexamined Patent Application Publication No. 60-188956.

Particularly preferred are the following hindered phenols (hindered phenols are phenols having bulky substituents near the hydroxy groups): dibutylhydroxyltoluene, 2,2′-methylenebis(6-t-butyl-4-methylphenol), 4,4′-butylidenebis(6-t-butyl-3-methylphenol), 4,4′-thiobis(6-t-butyl-3-methylphenol), 2,2′-butylidenebis(6-t-butyl-4-methylphenol), α-tocopherol, β-tocopherol, 2,2,4-trimethyl-6-hydroxy-7-t-butyl chromane, pentaerystiltetrakis[3-(3,5-di-t-butyl-4-hydroxyphenyl)propionate], 2,2′-thiodiethylenebis[3-(3,5-di-t-butyl-4-hydroxyphenyl)propionate], 1,6-hexanediolbis[3-(3,5-di-t-butyl-4-hyroxyphenyl)propionate], butyl hydroxyanisole, dibutyl hydroxyanisole, octadecyl 3,5-di-tert-butyl-4-hydroxyhydrocinnamate, and 1,3,5-trimethyl-2,4,6-tris-(3,5-di-tert-4-hydroxybenzyl)-benzene.

Among hindered phenols, particularly preferred are the following compounds: octadecyl 3,5-di-tert-butyl-4-hydroxyhydrocinnamate and 1,3,5-trimethyl-2,4,6-tris-(3,5-di-tert-butyl-4-hydroxybenzyl)-benzene.

These compounds are commercially available as antioxidants for, for example, rubber, plastics, and oils.

The amount of the antioxidant in the surface layer of the photoreceptor applied to the image-forming apparatus of the present invention is not particularly limited, but is preferably 0.1 part by weight or more and 20 parts by weight or less on the basis of 100 parte by weight of the binder resin. If the amount is outside the range, satisfactory electric characteristics cannot be achieved. The amount is particularly preferably 1 part by weight or more. A larger amount of the antioxidant causes not only poor electric characteristics but also low printing durability. The amount is preferably 15 parts by weight or less and more preferably 10 parts by weight or less.

### [Electron-attractive Compound]

The photoreceptor preferably contains an electron-attractive compound. Preferred examples of the electron-attractive compound include sulfonic acid ester compounds, carboxylic acid ester compounds, organic cyano compounds, nitro compounds, aromatic halogen derivatives. Sulfonic acid ester compounds and organic cyano compounds are more preferred, and sulfonic acid ester compounds are most preferred.

The electron attractivity may be predicted based on the energy level of LUMO. In particular, preferred are compounds having an energy level of LUMO of −1.0 eV to −3.0 eV in geometry optimization using semiempirical molecular orbital calculation with a parameter PM3 (hereinafter, simply, referred to as “by semiempirical molecular orbital calculation (PM3)”). An energy absolute level of LUMO smaller than 1.0 eV cannot achieve sufficient electron attractivity. A larger absolute level larger than 3.0 eV may deteriorate the charging characteristics. Accordingly, the absolute energy level of LUMO is preferably 1.5 eV or more, more preferably 1.7 eV or more, and most preferably 1.9 eV or more. The upper level is preferably 3.7 eV or less and more preferably 2.5 eV or less.

In the calculation regarding the electron attractive compound, PH3 Hamiltonian was used based on the following reasons: as electron-attractive compound usually includes heteroatoms such as sulfur and halogens, in addition to carbon, nitrogen, oxygen, and hydrogen. The PM3 determined with parameters of these many different atoms by the least-square method is believed to be suitable for geometry optimization of the electron-attractive compound.

Examples of the electron-attractive compounds include the following compounds:

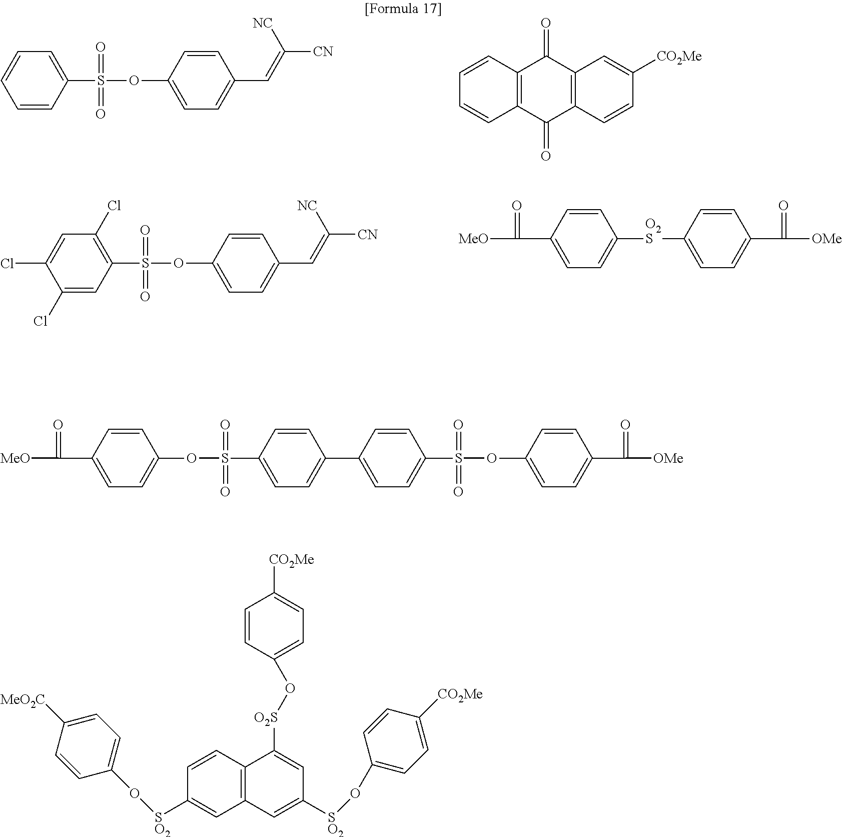 [SMILES: N#CC(C#N)=Cc1ccc(OS(=O)(=O)c2ccccc2)cc1 ; COC(=O)c1ccc2c(c1)C(=O)c1ccccc1C2=O ; N#CC(C#N)=Cc1ccc(OS(=O)(=O)c2cc(Cl)c(Cl)cc2Cl)cc1 ; COC(=O)c1ccc(S(=O)(=O)c2ccc(C(=O)OC)cc2)cc1 ; COC(=O)c1ccc(OS(=O)(=O)c2ccc(-c3ccc(S(=O)(=O)Oc4ccc(C(=O)OC)cc4)cc3)cc2)cc1 ; COC(=O)c1ccc(OS(=O)(=O)c2ccc3c(S(=O)(=O)Oc4ccc(C(=O)OC)cc4)cc(S(=O)(=O)Oc4ccc(C(=O)OC)cc4)cc3c2)cc1]

### [Outermost Layer]

The charge-generating material and the charge-transporting material may be contained in any layer, but it is preferable that the outermost layer contain fluorine atoms and silicon atoms, from the viewpoints of improvement of toner transfer properties and cleaning properties. These atoms may be contained in any of the additive, the charge-generating material, the charge-transporting material, or the binder resin.

The adhesive properties of the surface of the photoreceptor can be detected as the surface free energy (a synonym for surface tension). The surface free energy of the outermost layer is preferably in the range of 35 to 65 mN/m. A lower surface free energy may cause flow out of the toner, and a higher surface free energy may cause low transfer efficiency of the toner and poor cleaning properties. The lower limit is preferably 40 mN/m or more, and the upper limit is preferably 55 mN/m or less and more preferably 50 mN/m or less.

### [Surface Free Energy]

The surface free energy will now be described. The adhesion of the photoreceptor surface and foreign materials such as residual toner is a physical binding caused by intermolecular force (van der Waals' force). The surface free energy (γ) is a phenomenon caused by the intermolecular force on the outermost surface. “Wetting” of a substance is roughly classified into three types: “adhesional wetting” where substance 1 adheres to substance 2, “extentional wetting” where substance 1 extends on substance 2, and “immersional wetting” where substance 1 is immersed in or infiltrates into substance 2.

Regarding the adhesional wetting, the relation between substance 1 and substance 2 for the surface free energy (γ) and wetting characteristics is defined by the following equation based on Young's equation:

[Equation 1]

γ₁=γ₂·COS θ₁₂·γ₁₂ Equation (1-1)

where γ₁: surface free energy of the surface of substance 1,
γ₂: surface free energy of substance 2,
γ₁₂: interfacial free energy of substance 1/substance 2, and
θ₁₂: contact angle of substance 1/substance 2.

In the case of adhesion of, for example, foreign materials or water to the photoreceptor surface in an image-forming apparatus in Equation (1-1), the photoreceptor is substance 1, and the foreign materials are substance 2.

Equation (1-1) shows that the control of γ₁, γ₂, and γ₁₂ is important for control of surface properties. It is preferable that the surface be hardly wetted, which is effectively achieved by increasing the value θ₁₂, increasing the surface free energy γ₁ of the photoreceptor surface, that is, “work of wetting” between the photoreceptor and the toner, or reducing the values γ₂ and γ₁₂.

In the cleaning process of electrophotographs, the right side of Equation (1-1) expressing the adhesion state can be determined by regulating the surface free energy γ₂ of the photoreceptor. In addition, during a durability test, it is believed that γ₂ is constant because the toner and other foreign materials are sequentially supplied freshly. On the other hand, the surface free energy γ₁ of the photoreceptor varies during the test. The value of the right side in Equation (1-1) changes as γ₂ varies by Δγ₁. That is, a change in the adhesion state of foreign materials on the photoreceptor surface causes a change in load on the cleaning properties or the cleaning mechanism. In other words, the cleaning properties of the photoreceptor, i.e., ease of cleaning, can be maintained constant through regulation of Δγ₁.

Regarding the wetting between a solid and a liquid, the contact angle θ₁₀ can be directly measured. However, the contact angle θ₁₂ between a solid and another solid as in a photoreceptor and a toner cannot be measured. The photoreceptor and the toner of the present invention are usually solids and therefore belong to this case.

KITASAKI, Yoshiaki and HATA, Toshio show that Fowkes's theory relating to nonpolar intermolecular force regarding interfacial free energy (a synonym for surface tension) can he extended to the intermolecular force of polar or hydrogen-bonding components, in Nippon Secchaku Kyokai Shi (Journal of Japanese Adhesion Society), 8(3), 131-141 (1972). With this extended Fowkes's theory, the surface free energy of each material can be determined with two or three components. The theory using three components will be shown below as an example case of adhesional wetting. The theory works based on the following hypothesis.

1. Addition rule of surface free energy (γ): γ=γ^{a}+γ^{p}+γ^{h} (1-2),
where γ^{a}: dispersion component (nonpolar wetting=adhesion),
γ^{p}: polar component (polar-depending wetting=adhesion), and
γ^{h}: hydrogen-bonding component (hydrogen-bonding-depending wetting=adhesion).

The interfacial free energy γ₁₂ of two substances is expressed by the following equation by applying the above to Fowkes's theory;

[Equation ]

γ₁₂=γ₁+γ₂−1—(γ₁^{a}·γ₂^{a})^{1/2}−2·(γ₁^{p}·γ₂^{p})^{1/2}−2·(γ₁^{h}·γ₂^{h})^{1/2} Equation (1-3)

### Furthermore,

$$[ Equation 3 ] \\ {γ}_{u} = {\{ \sqrt{( {γ}_{1}^{d} )} - \sqrt{( {γ}_{2}^{d} )} \}}^{2} + {\{ \sqrt{( {γ}_{1}^{p} )} - \sqrt{( {γ}_{2}^{p} )} \}}^{2} - {\{ \sqrt{( {γ}_{1}^{h} )} - \sqrt{( {γ}_{2}^{h} )} \}}^{2} \qquad Equation ( 1 \text{-} 4 )$$

The surface free energy can be calculated through measurement of the ease of adhesion of the photoreceptor surface to a reagent used, where the components p, d, and h, of the surface free energies is known. Specifically, pure water, methylene iodide, and α-bromonaphthalene are used as the reagents, and the contact angle of each reagent with the photoreceptor surface is measured with an automatic contact angle meter, CA-VP, manufactured by Kyowa Interface Science Co., Ltd. The surface free energy γ is calculated based on the resulting contact angles, using surface free energy analysis software, FAMAS, available from the same company. Any combination of other proper reagents where the components p, d, and h are known can also be used, and the contact angle can be measured by another method such as a Wilhelmy method (vertical plate method) or Due Nui method.

As described above, “wetting” is classified into several types. In the cases that a toner is fixed or fused to the photoreceptor surface, the toner remaining on the photoreceptor surface adheres to the photoreceptor and spreads on the photoreceptor surface as a coating by repeating cleaning and charging processes, resulting in an increase in adhesion force of the toner. This corresponds to so-called “adhesional wetting”.

Also, in the cases of fixation of paper powder or foreign materials such as rosin and talc, the contact area (hereinafter, referred to as “interface”) with the photoreceptor after the adhesion is similarly increased to cause strong wetting. In addition, the “wetting” of the photoreceptor surface, which is caused by that the photoreceptor surface is brought into contact with moisture through the foreign materials or directly, causes so-called “high-humidity diffusion”, which leads to image blur at high humidity.

During the process of forming an electrophotographic image, various materials including the toner adhere to the photoreceptor surface once as the foreign materials. The “residual toner” and the other foreign materials that have net been transferred to a transfer material are necessarily removed by cleaning within a certain period of time. The term “a certain period of time” herein means the period from the actual time when the various materials adhere to the photoreceptor surface once to the time when the interface area with the photoreceptor surface is increased by diffusion and/or further adhesion.

The characteristics relating to the cleaning during the certain period of time, that is, the “adhesional wetting” and further “extensional wetting” by the foreign materials adhering so the photoreceptor, are important factors that actually affect the cleaning properties, cleaning device, and service life of the photoreceptor. Therefore, the inventors have believed that regulation of the surface free energy γ is effective, and have conducted intensive studies and, as a result, have found that an electrophotographic image with high quality and high durability can be obtained by regulating the surface free energy γ. Substance 2, i.e., the foreign materials, may be a toner, paper powder, moisture, silicone oil, or other components.

In the present invention, the surface free energy γ₁ of the photoreceptor surface serving as substance 1 to which substance 2 adheres is regulated. Though substance 2 is occasionally supplied during the durability test, the γ₂ of the photoreceptor as substance 1 varies during the test. Accordingly, in the investigation of durability of an electrophotographic apparatus for forming an image, it is important to control the variation Δγ₁.

### [Control]

In order to stably form high-quality images, the cleaning properties of the photoreceptor, in particular, the load on the photoreceptor by cleaning is controlled. Satisfactory cleaning properties with a low load can be achieved by regulating the surface free energy γ level of the photoreceptor to usually 35 mN/m or more and preferably 40 mN/m or more and usually 65 mN/m or less and more preferably 60 mN/m or less. In addition, the deviation in the load on both the photoreceptor and the cleaning device can be reduced to stabilize the cleaning properties for a long time by regulating the Δγ that varies during the durability test within a range of 25 mN/m or less and preferably 15 mN/m or less.

In particular, the outermost layer of the photoreceptor may have a protective layer, in order to prevent abrasion of the photosensitive layer or prevent or reduce deterioration of the photosensitive layer, which is caused by materials or the like generated from a charging device or other portions. For example, the protective layer can be made of a suitable binding resin containing an electroconductive material or a copolymer of a charge-transportable compound, such as a triphenylamine skeleton described in Japanese Unexamined Patent Application Publication No. 9190004 or 10-252377. Examples of the electroconductive material can include, but are not limited to, aromatic amino compounds such as TPD (N,N′-diphenyl-N,N′-bis-(m-tolyl)benzidine, and metal oxides such as antimonium oxide, indium oxide, tin oxide, titanium oxide, tin oxide-antimonium oxide, aluminum oxide, and zinc oxide.

The binder resin used in the protective layer may be any known resin, and examples thereof include polyamide resins, polyurethane resins, polyester resins, epoxy resins, polyketone resins, polycarbonate resins, polyvinyl ketone resins, polystyrene resins, polyacrylamide resins, and siloxane resins. In addition, copolymers of such resins and charge-transportable skeletons, such as a triphenyl amine skeleton described in Japanese Unexamined Patent Application Publication No. 9-190004 or 10-252377, can be used.

The protective layer preferably has an electric resistance of 10⁹ to 10¹⁴ Ω·cm. An electric resistance higher than 10¹⁴ Ω·cm may increases the residual potential to form a foggy image. On the other hand, an electric resistance lower than 10⁹ Ω·cm may cause a blur image or a decreased resolution. In addition, the protective layer must be designed to ensure the transmission of light for image exposure.

Furthermore, the surface layer may contain, for example, a fluorine resin, a silicone resin, a polyethylene resin, or a polystyrene resin in order to decrease friction resistance and abrasion of the photoreceptor surface and to increase transfer efficiency of a toner from the photoreceptor to a transfer belt or paper. The surface layer may also contain particles of these resins or inorganic compounds.

### [Layer-forming Process]

Layers constituting a photoreceptor are formed in series by repeating the coating and drying steps of coating liquids each containing materials constituting each layer onto a support by a known method.

The solid content in the coating liquid for a single-layer photoreceptor or a charge-transporting layer of a laminated photoreceptor is usually 5 mass % or more and preferably 10 mass % or more and usually 40 mass % or less and preferably 35 mass % or less. In addition, the viscosity of these coating liquids is usually 10 mPa·s or more a an preferably 50 mPa s or more and usually 500 mPa·s or less and preferably 400 mPa·s or less.

In the coating liquid for a charge-generating layer of a laminated photoreceptor, the solid content is usually 0.1 mass % or more and preferably 1 mass % or more and usually 15 mass % or less and preferably 10 mass % or less. In addition, the viscosity of this coating liquid is usually 0.01 mPa·s or more and preferably 0.1 mPa·s or more and usually 20 mPa·s or less and preferably 10 mPa·s or less.

The application of the coating liquid can be conducted by dip coating, spray coating, spin coating, bead coating, wire-bar coating, blade coating, roller coating, air-knife coating, curtain, coating, or any other known coating method.

The coating liquid is preferably dried by contact drying at room temperature and then heat drying at a temperature ranging from 30 to 200° C. for 1 minute to 2 hours with or without ventilation. The heating temperature may be constant or variable during the drying step.

### [Image-forming Apparatus]

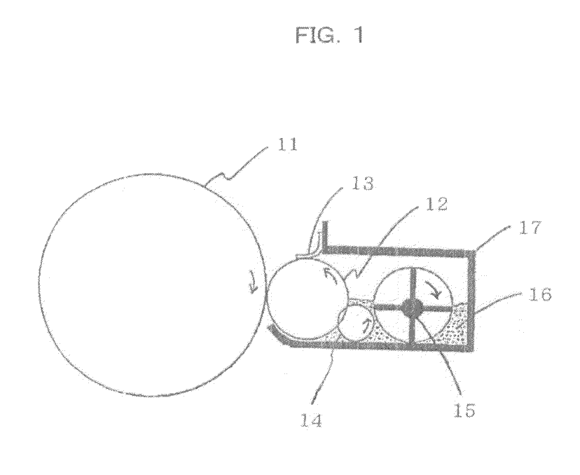

The process for forming an image using the image-forming apparatus of the present invention will be described in further detail with reference to the drawings. FIG. 1 is a schematic view illustrating a nonmagnetic-single-component toner developer that can be used in the process for forming art image. In FIG. 1, the toner 16 packed in a toner hopper 17 is forcibly collected to a sponge roller (auxiliary toner feeder) 14 with an agitating blade 15 to be supplied to the sponge roller 14. The toner fed to the sponge roller 14 is transferred to a toner-transferring member 12 by the rotation of the sponge roller 14 in the direction indicated by the arrow. The toner is frictioned and electrostatically or physically adheres to the toner-transferring member 12. The toner-transferring member 12 is strongly rotated in the direction indicated by the arrow, and the toner is shaped into a uniform thin toner layer with an elastic steel blade (toner layer thickness regulator) 13 and is frictionally electrified at the same time. Then, the toner is transferred onto the surface of an electrostatic latent image carrier 11 that is in contact with the toner-transferring member 12 to develop a latent image. The latent image is formed in an organic photoreceptor by, for example, charging with a DC of 500 V and the subsequent exposure.

Since the toner applied to the image forming apparatus of the present invention exhibits a sharp charge density distribution, contamination (toner scattering) of the inside of the image-forming apparatus caused by defectively charged toner is very low. This effect is significant, in particular, in high-speed image-forming apparatuses that conduct the development to an electrostatic latent image carrier at a speed of 100 mm/sec or more.

The toner applied to the image-forming apparatus of the present invention exhibits a sharp charge density distribution, excellent development properties, so that the amount of the toner particles accumulating without being used for development is very small. This effect is significant, in particular, in image-forming apparatuses that consume toners at a high speed. specifically, the toner can sufficiently exhibit the advantages of the present invention when it is applied to an image-forming apparatus satisfying the following expression (G):

(the number of sheets of guaranteed service life of a processor filled with a developer)×(printing ratio)≧400 (sheets). (G)

In expression (G), the “printing ratio” is represented by the sum of the printed areas divided by the total area of the printing medium, in a printed material for determining the guaranteed service life indicated by the number of sheets showing the performance of the image-forming apparatus. For example, the “printing ratio” of “5%” printing is “0.05”.

Since the toner applied to the image-forming apparatus of the present invention exhibits a sharp charge density distribution, reproducing properties of a latent image are excellent. Therefore, this advantage of the present invention is significant when the toner is applied to, in particular, an image-forming apparatus of which the resolution to an electrostatic latent image carrier is 600 dpi or more.

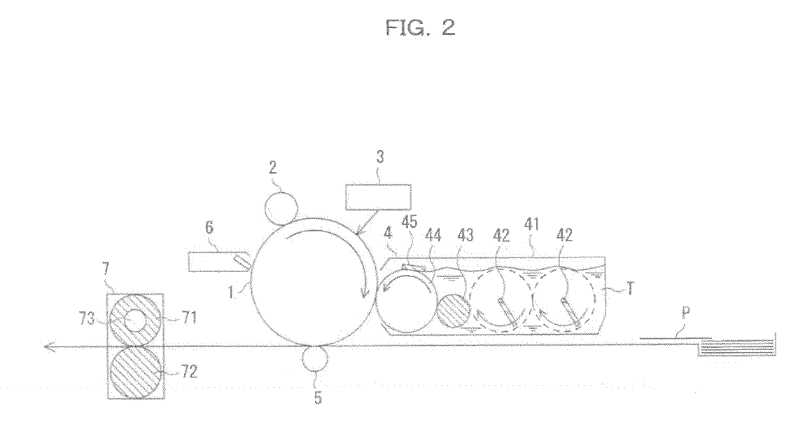

Regarding an embodiment on electrophotographic peripherals at an image-forming apparatus of the present invention, the main structure of the apparatus will now be described with reference to FIG. 2. However, the embodiment is not limited to the following description, and various modifications can be conducted within the scope of the present invention.

As shown in FIG. 2, the image-forming apparatus includes an electrophotographic photoreceptor 1, a charging device 2, an exposure device 3, and a development device 4. In addition, the Image-forming apparatus optionally includes a transfer device 5, a cleaning devise 6, and a fixing device 7.

The electrophotographic photoreceptor 1 is the above-described electrophotographic photoreceptor of the present invention without any additional requirement. FIG. 1 shows, as such an example, a drum photoreceptor having the above-described photosensitive layer on the surface of a cylindrical electroconductive support. Along the outer surface of this electrophotographic photoreceptor 1, a charging device 2, an exposure device 3, a development device 4, a transfer device 5, and a cleaning device 6 are arranged.

The charging device 2 charges the electrophotographic photoreceptor 1 such that the surface of the electrophotographic photoreceptor 1 is uniformly charged to a predetermined potential. FIG. 2 shows a roller charging device (charging roller) as an example of the charging device 2, but other charging devices, for example, corona charging devices such as corotron or scorotron and contacting charging devices such as a charging brush, are widely used.

In many cases, the electrophotographic photoreceptor 1 and the charging device 2 are integrated into a cartridge (hereinafter, optionally, referred to as “photoreceptor cartridge”) that is detachable from the body of an image-forming apparatus. When the electrophotographic photoreceptor 1 or the charging device 2 are degraded, the photoreceptor cartridge can be replaced with a new one by detaching the used photoreceptor cartridge from the image-forming apparatus body and attaching the new one to the image-forming apparatus body. In addition, in many cases, toner described below is also stored be a toner cartridge detachable from an image-forming apparatus body. When the toner in the toner cartridge is exhausted in use, the toner cartridge can be detached from the image-forming apparatus body, and a new toner cartridge can be attached to the apparatus body. Furthermore, a cartridge including all the electrophotographic photoreceptor 1, the charging device 2, and the toner may be used.

The exposure device 3 may be of any type that can form an electrostatic latent image on a photosensitive surface of the electrophotographic photoreceptor 1 by exposure to the electrophotographic photoreceptor 1, and examples thereof include halogen lamps, fluorescent lamps, lasers such as a semiconductor laser and a He—Ne laser, and LEDs. Furthermore, the exposure may be conducted by a photoreceptor internal exposure system. Any light can be used for the exposure. For example, the exposure may be carried out with monochromatic light having a wavelength of 700 to 850 nm; monochromatic light having a slightly shorter wavelength of 600 to 700 nm; or monochromatic light having a shorter wavelength of 300 to 500 nm.

In particular, in the electrophotographic photoreceptor containing only a phthalocyanine compound having a specific crystal form that can be used in the present invention as a charge-generating material, monochromatic light of a wavelength of 700 to 850 nm is preferably used. In the electrophotographic photoreceptor also containing an azo compound, monochromatic light of a wavelength of 700 nm or less is preferably used. The electrophotographic photoreceptor containing an azo compound can exhibit a sufficient sensitivity even in the use of a monochromatic input light source of a wavelength of 500 nm or less. Accordingly, a monochromatic light source of a wavelength of 350 to 500 nm is particularly preferred.

The development device 4 is not particularly limited and may be of any type. Examples of the development device 4 include dry development systems such as cascade development, one-component conductive toner development, and two-component magnetic brush development; and wet development systems. The development device 4 shown in FIG. 2 includes a development tank 41, agitators 42, a supply roller 43, a development roller 44, a regulator 45, and the development tank 41 containing a toner T. In addition, the development device 4 may be provided with an optional refill device (not shown) for refilling the toner T. This refill device can refill the development tank 41 with toner T from a container such as a bottle or a cartridge.

The supply roller 43 is made of, for example, an electroconductive sponge. The development roller 44 is, for example, a metal roller made of, e.g., iron, stainless steel, aluminum, or nickel or a resin roller made of each a metal roller coated with, e.g., a silicone resin, a urethane resin, or a fluorine resin. The surface of this development roller 44 may be optionally smoothed or roughened.

The development roller 44 is arranged between the electrophotographic photoreceptor 1 and the supply roller 43 and abuts on both the electrophotographic photoreceptor 1 and the supply roller 43. The supply roller 43 and the development roller 44 are rotated by a rotary drive mechanism (not shown). The supply roller 43 carries the toner T stored and supplies it to the development roller 44. The development roller 44 carries the toner T supplied from the supply roller 43 and brings it into contact with the surface of the electrophotographic photoreceptor 1.

The regulator 45 is made of, for example, a resin blade of, e.g., a silicoses resin or a urethane resin; a metal blade of, e.g., stainless steel, aluminum, copper, brass, or phosphor bronze; or a blade made of such a metal blade coated with a resin. The regulator 45 abuts on the development roller 44 and is biased toward the development roller 44 at a predetermined force (a usual blade line pressure is 5 to 500 g/cm) with, for example, a spring. The regulator 45 may have an optional function charging the toner T by frictional electrification.

The agitators 42 are each rotated by a rotary drive mechanism and agitate the toner T and transfer it so the supply roller 43. The blade shapes and sizes of the agitators 42 may be different from each other.

The toner T may be the above-mentioned toner. The toner may have various shapes from a spherical shape to a non-spherical shape such as a potato-like shape. Polymerized toner exhibits superior charging uniformity and transferring characteristics and, therefore, can be suitably used for forming high-quality images.

The transfer device 5 may be of any type without particular limitation, and devices employing, for example, electrostatic transfer such as corona transfer, roller transfer, or belt transfer; pressure transfer; or adhesive transfer can be used. The transfer device 5 includes a transfer charger, a transfer roller, and a transfer belt that are arranged so as to face the electrophotographic photoreceptor 1. The transfer device 5 transfers a toner image formed in the electrophotographic photoreceptor 1 to recording sheet (paper, any other medium) P by a predetermined voltage (transfer voltage) with an opposite polarity to the charged potential of the toner T.

The cleaning device 6 may be of any type without particular limitation, and examples thereof include a brush cleaner, a magnetic brush cleaner, an electrostatic brush cleaner, a magnetic roller cleaner, and a blade cleaner. The cleaning device 6 collects remaining toner adhering to the photoreceptor 1 by scraping the remaining toner with a cleaning member. The cleaning device 2 is unnecessary when the amount of toner remaining on the surface of the photoreceptor is small or substantially zero.

The fixing device 7 is composed of an upper fixing member (pressurizing roller) 71 and a lower fixing member (fixing roller) 72, and the fixing member 71 or 72 is provided with a heater 73 therein. FIG. 2 shows an example of the heater 73 provided inside the upper fixing member 71. The upper and lower fixing members 71 and 72 may be known thermal fixing members, for example, a fixing roller in which a pipe of a metal material, such as stainless steel or aluminum, is coated with a silicone rubber, a fixing roller further having a Teflon (registered trademark) resin coating, or a fixing sheet. The fixing members 71 and 72 may have a structure for supplying a mold-releasing agent, such as a silicone oil, for improving mold release properties or may have a structure for applying a pressure to each other with, for example, a spring,

The toner transferred onto a recording sheet P is heated to be melted when passing through between the upper fixing member 71 and the lower fixing member 72 that are heated to a predetermined temperature, and then is fixed on the recording sheet P by cooling thereafter. The fixing device may be of any type without particular limitation, and examples thereof include, in addition to that described here, devices employing a system of heat roller fixation, flash fixation, oven fixation, or pressure fixation.

In the electrophotographic apparatus having a structure described above, an image is recorded as follows: The surface (photosensitive surface) of the photoreceptor 1 is charged to a predetermined potential (for example, −600 V) with the charging device 2. The charging may be conducted by a direct-current voltage or by a direct-current voltage superimposed by an alternating-current voltage. Subsequently, the charged photosensitive surface of the photoreceptor 1 is exposed with the exposure device 3 depending on the image to be recorded. Thereby, an electrostatic latent image is formed in the photosensitive surface. This electrostatic latent image formed in the photosensitive surface of the photoreceptor 1 is developed by the development device 4.

In the development device 4, the toner T supplied by the supply roller 43 is spread into a thin layer with the regulator (developing blade) 45 and, simultaneously, is charged by friction so as to have a predetermined polarity (here, the toner is charged into negative polarity, which is the same as the polarity of the charge potential of the photoreceptor 1). This toner T is held on the development roller 44 and is conveyed and brought into contact with the surface of the photoreceptor 1. The charged toner T held on the development roller 44 comes into contact with the surface of the photoreceptor 1, so that a toner image corresponding to the electrostatic latent image is formed on the photosensitive surface of the photoreceptor 1. This toner image is transferred to a recording sheet P with the transfer device 5. Thereafter, the toner remaining on the photosensitive surface of the photoreceptor 1 without being transferred is removed with the cleaning device 6.

After the transfer of the toner image to the recording sheet P, the recording sheet P passes through the fixing device 7 to thermally fix the toner image set the recording sheet P. Thereby, an image is finally recorded.

The image-forming apparatus may have a structure that can conduct, for example, a charge elimination step, in addition to the above-described structure. The charge elimination step neutralizes the electrophotographic photoreceptor by exposing the electrophotographic photoreceptor with light. Examples of such a device for the charge elimination include fluorescent lamps and LEDs. In many cases, the light used in the charge elimination step has an exposure energy intensity at least 3 times that of the exposure light.

The structure of the image-forming apparatus may be further modified. For example, the image-forming apparatus may have a structure that conducts steps such as a pre-exposure step and a supplementary charging step, that performs offset printing, or that includes a full-color tandem system using different toners.

In addition, a system that exhibits excellent image characteristics, low smear of image, and high transfer efficiency can be constructed by applying the photoreceptor having excellent physical and electrical surface characteristics and the toner so the image-forming apparatus of the present invention.

### EXAMPLES

The present invention will now be further specifically described with reference to Examples, but is not limited thereto within the scope of the present invention. Throughout Examples, the term “part(s)” and “%” mean “part(s) by weight” and “mass %”, respectively, unless otherwise specified.

### [Measurement and Definition of Volume-average Particle Diameter (Mv)]

The volume-average particle diameter (Mv) of particles having a volume-average particle diameter (Mv) of 1 μm or less was measured with a model, Microtrac Nanotrac 150 (hereinafter, abbreviated to “Nanotrac”) manufactured by Nikkiso Co., Ltd. according to the instruction manual of Nanotrac and using analysis software of this company, Microtrac Particle Analyzer Ver10.1.2.-019EE, using deionized water with an electric conductivity of 0.5 μS/cm as a dispersion medium under the following conditions or by inputting the following conditions.

The conditions for wax dispersion and polymer primary particle dispersion were as follows:

Refractive index of solvent: 1.333

Run time: 100 sec

Number of measurement: one

Refractive index of particles: 1.59

Transparency: transparent

Shape: spherical

Density: 1.04

The conditions for pigment premix solution and colorant dispersion were as follows:

Refractive index of solvent: 1.333

Run time: 100 sec

Number of measurement: one

Refractive index or particles: 1.59

Transparency: absorptive

Shape: non-spherical

Density: 1.00

### [Measurement and Definition of Volume Median Diameter (Dv50)]

The finally obtained toner after an external addition step was pre-treated for measurement as follows: A toner (0.100 g) was placed into a cylindrical polyethylene (PE) beaker having an internal diameter of 47 mm and a height of 51 mm with a spatula, and 0.15 g of aqueous 20 mass % DBS solution (Neogen S-20S, DAI-ICHI KOGYO SEIYAKU CO., LTD.) was added thereto with a pipette. On this occasion, the toner and the aqueous 20% DBS solution were placed on the bottom of the beaker so as not to spatter to, for example, the edge of the beaker. The toner and the aqueous 20% DBS solution were stirred with a spatula for 3 minutes to give a paste. The stirring was conducted such that the toner and the aqueous 20% DBS solution did not spatter to the edge of the beaker on this occasion too.

Subsequently, 30 g of a dispersion medium, Isotone II, was added to the paste, followed by stirring with a spatula for 2 minutes to give a uniform solution as a whole by visual observation. Then, a fluorine resin-coated rotor with a length 31 mm and a diameter of 6 mm was placed into the beaker, followed by dispersion with a stirrer at 400 rpm for 20 minutes. In this dispersion treatment, coarse particles visually observed at the gas-liquid interface and the edge of the beaker were moved toward the bottom of the beaker with a spatula every 3 minutes for giving a uniform dispersion. Subsequently, the resulting dispersion was filtered through a mesh of 63 μm. The resulting filtrate was used as “toner dispersion”.

Regarding the measurement of particle diameter during the process of producing toner mother particles, slurry in the process of agglomeration was filtered through a mesh of 63 μm. The resulting filtrate was used as “slurry”.

The volume median diameter (Dv50) of particles was measured with a Multisizer III (aperture diameter: 100 μm) manufactured by Beckman Coulter, Inc. (hereinafter, abbreviated to “Multisizer”), using Isotone II of the same company as the dispersion medium, diluting the “toner dispersion” or the “slurry” to a dispersion concentration of 0.03 mass %, and using Multisizer III analysis software at a KD value of 118.5. The range of the particle diameter to be measured was 2.00 to 64.00 μm. This range was divided into 256 sections at the same width on a logarithmic scale. The volume median diameter (Dv50) is determined by the statistical values on the basis of volume.

### [Measurement and Definition of the Content (% by Number: Dns) of Toner Particles Having a Particle Diameter of 2.00 μm or More and 3.56 μm or Less]

The toner after the external addition step was pre-treated tor measurement as follows: A toner (0.100 g) was placed in a cylindrical polyethylene (PE) beaker having an internal diameter of 47 mm and a height of 51 mm with a spatula, and 0.15 g of aqueous 20 mass % DBS solution. (Neogen S-20A, DAI-ICHI KOGYO SEIYAKU CO., LTD.) was added thereto with a pipette. On this occasion, the toner and the aqueous 20% DBS solution were placed on the bottom of the beaker not to spatter to, for example, the edge of the beaker. The toner and the aqueous 20% DBS solution were stirred with a spatula for 3 minutes to give a paste. The stirring was conducted such that the toner and the aqueous 20% DBS solution do not spatter to the edge of the beaker on this occasion too.

Subsequently, 30 g of a dispersion medium, Isotone II, was added to the paste, followed by stirring with a spatula for 2 minutes to give a uniform solution as a whole by visual observation. Then, a fluorine resin-coated rotor with a length 31 mm and a diameter of 6 mm was put in the beaker, followed by dispersion with a stirrer at 400 rpm for 20 minutes. In this dispersion treatment, coarse particles visually observed at the gas-liquid interface see the edge of the header were moved toward the bottom of the beaker with a spatula every 3 minutes for giving a uniform dispersion. Subsequently, the resulting dispersion was filtered through a mesh of 63 μm. The resulting filtrate was used as “toner dispersion”.

The content (% by number: Dns) of toner particles having a particle diameter of 2.00 to 3.56 μm was measured with Multisizer (aperture diameter: 100 μm), using Isotone II of the same company as the dispersion medium, diluting the “toner dispersion” or the “slurry” to a dispersion concentration of 0.03 meet %, and using Multisizer III analysis software at a KD value of 118.5.

The lower limit of the particle diameter of 2.00 μm is the detection limit of the measurement apparatus Multisizer, and the upper limit of the particle diameter of 3.56 μm is the value prescribed by the channel of the measurement apparatus Multisizer. In the present invention, this particle diameter range of 2.00 to 3.56 μm was defined as a fine powder region.

The range of the particle diameter to be measured was 2.00 to 64.00 μm. This range was divided into 256 sections at the same width on a logarithmic scale. “Dns” is the ratio of the particles having a diameter in the range of 2.00 to 3.56 μm on the basis of the number of the particles calculated from the statistical values.

### [Method of Measurement and Definition of Average Sphericity]

The “average sphericity” of the present invention was measured and defined as follows: Toner mother particles were dispersed in a dispersion medium (Isotone II, manufactured by Beckman Coulter, Inc.) in the range of 5720 to 7140 particles/μL. The sphericity was measured with a flow-type particle image analyzer (FPIA2100, manufactured by Sysmex Co., (formerly Toa Medical Electronics Co., Ltd.)) under the following operation conditions, and the value obtained was defined as the “average sphericity”. In the present invention, the measurement was repeated three times and the arithmetic average of the three measurement values was defined as the “average sphericity”.

Mode: HPF

Volume of HPF analysis: 0.35 μL

HPF detection number: 2000 to 2500

The “sphericity”, which is measured and automatically calculated and is displayed by the analyzer, is defined by the following Equation:

(Sphericity)=(perimeter of a circle having the same projected area as a particle image)/(perimeter of the particle image).

Then, 2000 to 2500 particles, which corresponds to the HPF detection number, are subjected to the measurement, and the arithmetic mean (arithmetic average) of the sphericities of these particles is displayed on the analyzer as an “average sphericity”.

### [Measurement and Definition of Number Variation Coefficient]

The “number variation coefficient” in the present invention is defined as follows:

(Number variation coefficient)=100×(standard deviation of number-based particle distribution)/(number average particle diameter)

In the present invention, the standard deviation of the number-based particle distribution and the number average particle diameter were measured with Multisizer III according to the method for measuring the volume median diameter (Dv50). The range of the particle diameter to be measured was 2.00 to 64.00 μm. This range was divided into 256 sections at the same width on a logarithmic scale. The standard deviation of the number-based particle distribution, and the number average particle diameter were determined based on the number-based statistical values, and the number variation coefficient was calculated from the above-mentioned equation.

### [Measurement of Electric Conductivity]

The electric conductivity was measured with a conductometer (Personal SC meter model SC72 with a detector SC72SN-11, manufactured by Yokogawa Corp.) by a usual method according to the instruction manual.

### [Measurements of Melting Point Peak Temperature, Half Width of Fusion Curve, Crystallization Temperature, and Half Width of Crystallization Curve]

The melting point peak temperature and the half width of the fusion curve were measured with an analyzer, model SSC5200 manufactured by Seiko Instruments Inc., according to the instruction manual of this company from an endothermic curve from 10° C. to 110° C. at a heating rate of 10° C./min., and the crystallization temperature and the half width of the crystallization curve were measured from an exothermic curve from 110° C. to 10° C. at a cooling rate of 10° C./min.

### [Measurement of Solid Content]

The solid content was measured with a solid content analyzer, solid Infrared Moisture Determination Balance FD-100 manufactured by Kett Electric Laboratory, precisely weighing 1.00 g of a sample containing solid components on a scale, at a heater temperature of 300° C. for a heating time of 90 minutes.

### [Measurement of Charge Density Distribution (Standard Deviation of Charge Density)]

A toner (0.8 g) and a carrier (19.2 g, ferrite carrier: F150, manufactured by Powdertec Co., Ltd.) were placed into a glass sample bottle and agitated with a Recipro shaker NR-1 (Taitec Inc.) at 250 rpm for 30 minutes. The agitated toner/carrier mixture was subjected to the measurement of a charge density distribution using a charge density distribution analyzer, E-Spart (Hosokawa Micron Ltd.). Regarding each particle, the value obtained by dividing the charge density by each particle diameter was determined (the range of −16.197 C./μm to +16.197 C./μm was divided into 128 sections every 0.2251 C./μm), and the standard deviation was determined from the results of 3000 particles and was used as the standard deviation of the charge density.

### [Method of Actual Printing Evaluation]

### [Actual Printing Evaluation 1]

Using “photoreceptor 2” described below, 80 g of a toner was charged in a cartridge of a machine of 600 dpi having a guaranteed service life of 30000 sheets at a printing ratio of 5%, and a chart of a printing ratio of 1% was printed continuously on 50 sheets by a nonmagnetic-single-component development system, roller charging, a rubber roller-contacting development system, a process speed (development speed) of 164 mm/sec, belt transfer, and a blade drum cleaning system.

### [Actual Printing Evaluation 2]

Using “photoreceptor 2” described below, 200 g of a toner was charged in a cartridge of a machine of 600 dpi having a guaranteed service life of 8000 sheets at a printing ratio of 5%, and a chart of a printing ratio of 5% was printed continuously until a sign of out-of-toner is displayed, by a nonmagnetic-single-component development system, roller charging, a rubber roller-contacting development system, a process speed (development speed) of 100 mm/sec, belt transfer, and a blade drum cleaning system.

### [Smear]

In the “actual printing evaluation 1” using the electrophotographic photoreceptor 2 described below, smears in an image printed after printing of 50 sheets was visually observed and evaluated according to the following criteria:

Excellent: no smear,

Good: acceptable smear,

Fair: partially observed slight smear, and

Poor: partially or wholly distinct smear.

### [Residual Image (Ghost)]

In the “actual printing evaluation 2” using the electrophotographic photoreceptor 2 described below, a solid image was printed. Image density at the anterior end area and image density at the area printed after two turns of the development roller were measured with X-rite 938 (available from X-Rite), and the rate (%) of the image density after two turns of the development roller to that of the anterior end area was determined.

Excellent: no problem (98% or more)

Good: acceptable difference in image density (95% or more and less than 98%)

Fair: slightly recognizable difference in image density (85% or more and less than 95%)

Poor: distinct difference in image density (less than 85%)

### [Thin Spot (Imperfect Solid Images)]

In the “actual printing evaluation 2” using the electrophotographic photoreceptor 2 described below, a solid image was printed. Image density at the preceding area and image density at the posterior end area were measured with X-rite 938 (available from X-Rite), and the rate (%) of the image density at the posterior end area to that of the exterior end area was determined.

Excellent: no problem (80% or more)

Good: acceptable difference that the posterior is slightly light (70% or more and less than 80%)

Peer: distinct difference that the posterior is highly light (less than 70%)

### [Cleaning Properties]

In the “actual printing evaluation 2” using the electrophotographic photoreceptor 2 described below, smears in an image printed after printing of 8000 sheets was visually observed, and smear in the image due to insufficient cleaning was evaluated.

Good: no smear

Fair: partially observed slight smear

Poor: partially or wholly distinct smear

### Toner Production Example 1

### [Preparation of Wax/Long-chain Polymerizable Monomer Dispersion A1]

Twenty seven parts (540 g) of paraffin wax (HNP9, manufactured by Nippon Seiro Co., Ltd., surface tension: 23.0 mN/m, melting point peak temperature: 82° C., heat of fusion: 220 J/g, half width of fusion curve: 8.2° C., crystallization temperature: 66° C. half width of crystallization curve: 13.0° C.), 2.8 parts of stearyl acrylate (manufactured by TOKYO CHEMICAL INDUSTRY CO., LTD.), 1.9 parts of an aqueous 20 mass % sodium dodecylbenzenesulfonate solution (Neogen S20A, manufactured by DAI-ICHI KOGYO SEIYAKU CO., LTD., hereinafter, abbreviated to “aqueous 20% DBS solution”), and 68.3 parts of desalted water were heated to 90° C., and were agitated with a homomixer (model: Mark II f, manufactured by Tokusyu Kika Kogyo Co., Ltd.) for 10 minutes.

Then, the resulting dispersion was heated to 90° C., and was circulation-emulsified in a homogenizer (model: 15-M-8PA, manufactured by Gaulin) under a pressure of 25 MPa. While the particle diameter was measured with Nanotrac, the dispersion was continued to give a volume-average particle diameter (Mv) of 250 nm, thereby a wax/long-chain polymerizable monomer dispersion A1 (solid content of the emulsion=30.2 mass %) as prepared.

### [Preparation of Polymer Primary Particle Dispersion A1]

A reactor (internal capacity: 21 L, internal diameter: 250 mm, height: 420 mm) equipped with an agitator (three blades), a heater/cooler, a concentrator, and a device for charging various raw materials and additives was charged with 35.6 parts (712.12 g) of the wax/long-chain polymerizable monomer dispersion A1 and 259 parts of desalted water, which were then heated to 90° C. under a nitrogen stream with agitation.

Thereafter, while the agitation of the solution was continued, a mixture of the following “polymerizable monomers” and “an aqueous emulsifier solution” was added thereto over a period of 5 hours. The “initiation of the polymerization” was defined as the starting time of the dropwise addition of the mixture. Thirty minutes after the initiation of the polymerization, the following “aqueous initiator solution” was added over a period of 4.5 hours. Furthermore, 5 hours after the initiation of the polymerization, the following “aqueous additional initiator solution” was added over a period of 2 hours, and the polymerization was continued at an internal temperature of 90° C. for further 1 hour with agitation.

### [Polymerizable Monomers]

Styrene: 76.8 parts (1535.0 g)

Butyl acrylate: 23.2 parts

Acrylic acid: 1.5 parts

Hexanediol diacrylate: 0.7 part

Trichlorobromomethane: 1.0 part

### [Aqueous Emulsifier Solution]

Aqueous 20% DBS solution: 1.0 part

Desalted water: 67.1 parts

### [Aqueous Initiator Solution]

Aqueous 8 mass % hydrogen peroxide solution: 15.5 parts

Aqueous 8 mass % L(+)-ascorbic acid solution: 15.5 parts

### [Aqueous Additional Initiator Solution]

Aqueous 8 mass % L(+)-ascorbic acid solution: 14.2 parts

After completion of the polymerization reaction. the reaction system was cooled to give a milky white polymer primary particle dispersion A1. The volume-average particle diameter (Mv) measured with Nanotrac was 280 nm, and the solid content was 21.1 mass %.

### [Preparation of Polymer Primary Particle Dispersion A2]

A reactor (internal capacity: 21 L, internal diameter: 250 mm, height: 420 mm) equipped with an agitator (three blades). a heater/cooler, a concentrator, and a device for charging various raw materials and additives was charged with 1.0 part of an aqueous 20 mass % DBS solution and 312 parts of desalted water, which were then heated to 90° C. under a nitrogen stream, and 3.2 parts of an aqueous 8 mass % hydrogen peroxide solution and 3.2 parts of an aqueous 8 mass % L(+)-ascorbic acid solution were simultaneously added thereto with agitation. The “initiation of the polymerization” was defined as the time 5 minutes after the simultaneous addition.

A mixture of the following “polymerizable monomers” and “aqueous emulsifier solution” was added over a period of 5 hours from the initiation of the polymerization. Furthermore, the following “aqueous initiator solution” was added over a period of 6 hours, and the polymerization was continued at an internal temperature of 90° C. for further 1 hour with agitation.

### [Polymerizable Monomers]

Styrene: 92.5 parts (1850.0 g)

Butyl acrylate: 2.5 parts

Acrylic acid: 0.5 part

Trichlorobromomethane: 0.5 part

### [Aqueous Emulsifier Solution]

Aqueous 20% DBS solution: 1.5 parts

Desalted Water: 66.0 parts

### [Aqueous Initiator Solution]

Aqueous 8 mass % hydrogen peroxide solution: 18.9 parts

Aqueous 8 mass % L(+)-ascorbic acid solution: 18.9 parts

After completion of the polymerization reaction, the reaction system was cooled to give a milky white polymer primary particle dispersion A2. The volume-average particle diameter (Mv) measured with Nanotrac was 290 nm, and the solid content was 19.0 mass %.

### [Preparation of Colorant Dispersion A]

A container having an internal capacity of 300 L and equipped with an agitator (propeller blade) was charged with 20 parts (40 kg) of carbon black (Mitsubishi Carbon Black MP100S, manufactured by Mitsubishi Chemical Corp.) that was prepared by a furnace process and had an ultraviolet absorption of 0.02 in a toluene extract and a true density of 1.8 g/cm³, 1 part of an aqueous 20% DBS solution, 4 parts of a nonionic surfactant (Emargen 120, manufactured by Kao Corp.), and 75 parts of deionized water having an electric conductivity of 2 μS/cm for predispersion to give a pigment premix solution. The volume-average particle diameter (Mv) of the carbon black in the dispersion after the pigment premix treatment measured with Nanotrac was about 90 μm.

The pigment premix solution was supplied to a wet bead mill as raw material slurry for one-path dispersion. The stator had an internal diameter of 75 mm, the separator had a diameter of 60 mm, and the distance between the separator and the disk was 15 mm. The medium for dispersion was zirconia beads (true density: 6.0 g/cm²) with a diameter of 100 μm. Since the stator having an effective internal capacity of 0.5 L was filled with 0.35 L of the medium, the filling rate of the medium was 70 mass %. The rotation speed of the rotor was maintained constant (the peripheral velocity at the rotor end: 11 m/sec), and the pigment premix solution was continuously supplied to the mill at a supply rate of 50 L/hr from a supply port with a non-pulsing metering pump and was continuously discharged from a discharging port to give a black colorant dispersion A. The volume-average particle diameter (Mv) of the colorant dispersion A measured with Nanotrac was 150 nm, and the solid content was 24.2 mass %.

### [Preparation at Toner Mother Particles A]

Toner mother particles A were produced by the following agglomeration step (core material agglomeration step and shell-coating step), spheronization step, washing step, and drying step using the following components:

Polymer primary particle dispersion A1: 95 parts as solid components (998.2 g as solid components),

Polymer primary particle dispersion A2: 5 parts as solid components,

Colorant, dispersion A: 6 parts as colorant solid components,

Aqueous 20% DBS solution: 0.2 part as solid components in the core material agglomeration step, and

Aqueous 20% DBS solution: 6 parts as solid components in the spheronization step.

Core Material Agglomeration Step

A mixer (capacity: 12 L, internal diameter: 208 mm, height: 355 mm) equipped with an agitator (double helical blade), a heater/cooler, a concentrator, and a device for charging various raw materials and additives was charged with the polymer primary particle dispersion A1 and the aqueous 20% DBS solution, which were then mixed for 5 minutes into a homogeneous mixture at an internal temperature of 7° C. Subsequently, an aqueous 5 mass % ferrous sulfate solution (0.52 part as FeSO₄.7H₂O) was added to the mixture with agitation at 250 rpm over 5 minutes at an internal temperature of 7° C., and then the colorant dispersion A was added thereto over 5 minutes. The resulting mixture was continuously mixed at an internal temperature of 7° C. into a homogeneous mixture, and an aqueous 0.5 mass % aluminum sulfate solution (0.10 part of solid components on the basis of the resin solid components) was dropwise added thereto over 8 minutes under the same conditions. Then, at a rotation speed of 250 rpm, the internal temperature was increased to 54.0° C. While the volume median diameter (Dv50) was measured with Multisizer, the particles were allowed to grow up to a diameter of 5.32 μm.

Shell-coating Step

Then, the polymer primary particle dispersion A2 was added thereto over 3 minutes at an internal temperature of 54.0° C. at a rotation speed of 250 rpm. The resulting mixture was maintained under the same conditions for 60 minutes.

Spheronization Step

Subsequently, the rotation speed was decreased to 150 rpm (the peripheral velocity at the rotor end: 1.56 m/sec, a 40% decrease relative to the rotation speed in the agglomeration step), and after the reduction of the rotation speed, the aqueous 20% DBS solution (6 parts as solid components) was added thereto over 10 minutes. The resulting mixture was heated to 81° C. over 30 minutes, and the temperature and the agitation were maintained to give an average sphericity of 0.943. Then, the mixture was cooled to 30° C. over 20 minutes to give slurry.

Washing Step

The resulting slurry was extracted and was filtered by suction with an aspirator through a filter paper No. 5C (manufactured by Toyo Roshi Co., Ltd.). The cake remaining on the filter paper was transferred to a stainless steel container having an internal capacity of 10 L and equipped with an agitator (propeller blade), and 8 kg at deionized water with an electric conductivity of 1 μS/cm was added thereto. The resulting mixture was agitated at 50 rpm into a homogeneous dispersion and was continuously agitated for further 30 minutes.

Then, the mixture was filtered by suction with an aspirator through a filter paper No. 5C (manufactured by Toyo Roshi Co., Ltd.) again. The solid remaining on the filter paper was transferred to a container having an internal capacity of 10 L, equipped with an agitator (propeller blade), and containing 8 kg of deionized mater having an electric conductivity of 1 μS/cm, and the resulting mixture was agitated at 50 rpm for 30 minutes into a homogeneous dispersion. This process was repeated five times to give a filtrate having an electric conductivity of 2 μS/cm.

Drying Step

The resulting solid was bedded in a stainless steel vat so as to have a thickness of 20 mm and was dried in a fan dryer set at 40° C. for 48 hours to give toner mother particles A.

### [Preparation of Tone A]

External Addition Step

The resulting toner mother particles A (250 g) were mixed with 1.55 g of H2000 silica manufactured by Clariant Inc., as an external additive, and 0.62 g of SMT150IB titania fine powder manufactured by Tayca Corp. with a sample mill (Kyoritsu Riko Co., Ltd.) at 6000 rpm for 1 minute and then filtered through a 150-mesh sieve to give toner A.

Analysis Step

The resulting toner A had a volume median diameter (Dv50) of 5.54 μm, which was measured with Multisizer, the “content (% by number: Dns) of the toner particles having a particle diameter of 2.00 μm or more and 3.56 μm or less” was 3.83%, the average sphericity was 0.943, and the number variation coefficient was 18.6%.

### Toner Production Examples 2

### [Preparation of Toner Mother Particles B]

Toner mother particles B were produced by the same process as that in the “preparation of toner mother particles A” of Toner Production Example 1 except that the “core material, agglomeration step”, “shell-coating step”, and “spheronization step”, in the agglomeration step (core material agglomeration step and shell-coating step), spheronization step, washing step, and drying step of the “preparation of toner mother particles A”, were modified as follows.

Core Material Agglomeration Step

A mixer (capacity: 12 L, internal diameter: 208 mm, height: 355 mm) equipped with an agitator (double helical blade), a heater/cooler, a concentrator, and a device for charging various raw materials and additives was charged with the polymer primary particle dispersion A1 and the aqueous 20% DBS solution, which were then mixed for 5 minutes into a homogeneous mixture as an internal temperature of 7° C. Subsequently, an aqueous 5 mass % ferrous sulfate solution (0.52 part as FeSO₄.7H₂O) was added to the mixture with agitation as 250 rpm over 5 minutes at an internal temperature of 7° C., and then the colorant dispersion A was added thereto over 5 minutes. The resulting mixture was continuously mixed at an internal temperature of 7° C. into a homogeneous mixture, and an aqueous 0.5 mass % aluminum sulfate solution (0.10 part of solid components on the basis of the resin solid components) was dropwise added thereto over 8 minutes under the same conditions. Then, at a rotation speed of 250 rpm, the internal temperature was increased to 55.0° C. While the volume median diameter (Dv50) was measured with Multisizer, the particles were allowed to grow up to a diameter of 5.86 μm.

Shell-coating Step

Then, the polymer primary particle dispersion A2 was added thereto over 3 minutes at an internal temperature of 55.0° C. at a rotation speed of 250 rpm. The resulting mixture was maintained under the same conditions for 60 minutes.

Spheronization Step

Subsequently, the rotation speed was decreased to 150 rpm (the peripheral velocity at the rotor end; 1.56 m/sec, a 40% decrease relative to the rotation speed in the agglomeration step), and after the reduction of the rotation speed, the aqueous 20% DBS solution (6 parts as solid components) was added thereto over 10 minutes. The resulting mixture was heated to 84° C. over 30 minutes, and the temperature and the agitation were maintained to give an average sphericity of 0.942. Then, the mixture was cooled to 30° C. over 20 minutes to give slurry.

### [Preparation of Toner B]

Then, toner B was prepared by the same process as that in the external addition step of the “preparation of toner A” except that the amount of H2000 silica as an external additive was 1.41 g and the amount of SMT150IB titania fine powder as another external additive was 0.56 g.

Analysis Step

The resulting toner B had a volume median diameter (Dv50) of 5.97 μm, which was measured with Multisizer, the “content (% by number: Dns) of the toner particles having a particle diameter of 2.00 μm or more and 3.56 μm or less” was 2.53%, the average sphericity was 0.943, and the number variation coefficient was 18.4%.

### Toner Production Example 3

### [Preparation of Toner Mother Particles C]

Toner mother particles C were produced by the same process as that in the “preparation of toner mother particles A” of the Toner Production Example 1 except that the “core material agglomeration step”, “shell-coating step”, and “spheronization step”, in the agglomeration step (core material agglomeration step and shell-coating step), spheronization step, washing step, and drying step of the “preparation of toner mother particles A”, were modified as follows.

Core Material Agglomeration Step

A mixer (capacity: 12 L, internal diameter: 208 mm, height: 355 mm) equipped with an agitator (double helical blade), a heater/cooler, a concentrator, and a device for charging various raw materials and additives was charged with the polymer primary particle dispersion A1 and the aqueous 20% DBS solution which were then mixed for 5 minutes into a homogeneous mixture at an internal temperature of 7° C. Subsequently, an aqueous 5 mass % ferrous sulfate solution (0.52 part as FeSO₄.7H₂O) was added to the mixture with agitation at 250 rpm over 5 minutes at an internal temperature of 7° C., and then the colorant dispersion A was added thereto over 5 minutes. The resulting mixture was continuously mixed at an internal temperature of 7° C. into a homogeneous mixture, and an aqueous 0.5 mass % aluminum sulfate solution (0.10 part of solid components on the basis of the resin solid components) was dropwise added thereto over 8 minutes under the same conditions. Then, at a rotation speed of 250 rpm, the internal temperature was increased to 57.0° C. While the volume median diameter (Dv50) was measured with Multisizer, the particles were allowed to grow up to a diameter of 6.72 μm.

Shell-coating Step

Then, the polymer primary particle dispersion A2 was added thereto over 3 minutes at a rotation speed of 250 rpm at an internal temperature of 57.0° C. The resulting mixture was maintained under the same conditions for 60 minutes.

Spheronization Step

Subsequently, the rotation speed was decreased to 150 rpm (the peripheral velocity at the rotor end: 1.56 m/sec, a 40% decrease relative to the rotation speed in the agglomeration step), and after the reduction of the rotation speed, the aqueous 20% DBS solution (6 parts as solid components) was added thereto over 10 minutes. The resulting mixture was heated to 87° C. over 30 minutes and was continuously heated and agitated under the state conditions to give an average sphericity of 0.941, and then was cooled to 30° C. over 20 minutes to give slurry.

### [Preparation of Toner C]

Then, toner C was prepared by the same process as that in the external addition step of the “preparation of toner A” except that the amount of H2000 silica as an external additive was 1.25 g and the amount of SMT150IB titania fine powder as another external additive was 0.50 g.

Analysis Step

The resulting toner C had a volume median diameter (Dv50) of 6.75 μm, which was measured with Multisizer, the “content (% by number: Dns) of the toner particles having a particle diameter of 2.00 μm or more and 3.56 μm or less” was 1.83%, the average sphericity was 0.942, and the number variation coefficient was 18.7%.

### Toner Production Example 4

### [Preparation of Toner Mother Particles D]

Toner mother particles D were produced by the same process as that in the “preparation of toner mother particles A” of Example 1 except that the “core material agglomeration step”, “shell-coating step”, and “spheronization step”, in the agglomeration step (core material agglomeration step and shell-coating step), spheronization step, washing step, and drying step of the “preparation of toner mother particles A”, were modified as follows.

Core Material Agglomeration Step

A mixer (capacity: 12 L, internal diameter: 208 mm, height: 355 mm) equipped with an agitator (double helical blade), a heater/cooler, a concentrator, and a device for charging various raw materials and additives was charged with the polymer primary particle dispersion A1 and the aqueous 20% DBS solution, which were then mixed for 5 minutes into a homogeneous torture at an internal temperature of 7° C. Subsequently, an aqueous 5 mass % ferrous sulfate solution (0.52 part as FeSO₄.7H₂O) was added to the mixture with agitation at 250 rpm over 5 minutes at an internal temperature of 21° C., and then the colorant dispersion A was added thereto over 5 minutes. The resulting mixture was continuously mixed at an internal temperature of 7° C. into a homogeneous mixture, and an aqueous 0.5 mass % aluminum sulfate solution (0.10 part of solid components on the basis of the resin solid components) was dropwise added thereto over 8 minutes under the same conditions. Then, at a rotation speed of 250 rpm, the internal temperature was increased to 54.0° C. While the volume median diameter (Dv50) was measured with Multisizer, the particles were allowed to grow up to a diameter of 5.34 μm.

Shell-coating Step

Then, the polymer primary particle dispersion A2 was added thereto over 3 minutes at an internal temperature at 54.0° C. at a rotation speed of 250 rpm. The resulting mixture was maintained under the same conditions for 60 minutes.

Spheronization Step

Subsequently, the rotation speed was decreased to 220 rpm (the peripheral velocity at the rotor end: 2.28 m/sec, a 12% decrease relative to the rotation speed in the agglomeration step), and after the reduction of the rotation speed, the aqueous 20% DBS solution (6 parts as solid components) was added thereto over 10 minutes. The resulting mixture was heated to 81° C. over 30 minutes and was continuously heated and agitated under the same conditions to give an average sphericity of 0.942, and then was cooled to 30° C. over 20 minutes to give slurry.

### [Preparation of Toner D]

Then, toner D was prepared by the same process as that in the external addition step of the “preparation of toner A” in Example 1.

Analysis Step

The resetting toner D had a volume median diameter (Dv50) of 5.48 μm, which was measured with Multisizer, the “content (% by number: Dns) of the toner particles having a particle diameter of 2.00 μm or more and 3.56 μm or less” was 4.51%, the average sphericity was 0.943, and the number variation coefficient was 20.4%.

### Toner Production Example 5

### [Preparation of Toner Mother Particles E]

Toner mother particles E were produced by the same process as that in the “preparation of toner mother particles A” of Example 1 except that the “core material agglomeration step”, “shell-coating step”, and “spheronization step”, in the agglomeration step (core material agglomeration step and shell-coating step), spheronization step, washing step, and drying step of the “preparation of toner mother particles A”, were modified as follows.

Core Material Agglomeration Step

A mixer (capacity: 12 L, internal diameter: 208 mm, height: 3.55 mm) equipped with an agitator (double helical blade), a heater/cooler, a concentrator, and a device for charging various raw materials and additives was charged with the polymer primary particle dispersion A1 and the aqueous 20% DBS solution, which were then mixed for 5 minutes into a homogeneous mixture at an internal temperature of 7° C. Subsequently, an aqueous 5 mass % ferrous sulfate solution (0.52 part as FeSO₄.7H₂O) was added to the mixture with agitation at 250 rpm over 5 minutes at an internal temperature of 21° C., and then the colorant dispersion A was added thereto over 5 minutes. The resulting mixture was continuously mixed at an internal temperature of 7° C. into a homogeneous mixture, and an aqueous 0.5 mass % aluminum sulfate solution (0.10 part of solid components on the basis of the resin solid components) was dropwise added thereto over 8 minutes under the same conditions. Then, at a rotation speed of 250 rpm, the internal temperature was increased to 55.0° C. While the volume median diameter (Dv50) was measured with Multisizer, the particles were allowed to grow up to a diameter of 5.86 μm.

Shell-coating Step

Then, the polymer primary particle dispersion A2 was added thereto over 3 minutes at an internal temperature of 55.0° C. at a rotation speed of 250 rpm. The resulting mixture was maintained under the same conditions for 60 minutes.

Spheronization Step

Subsequently, the rotation speed was decreased to 220 rpm (the peripheral velocity at the rotor end: 2.28 m/sec, a 12% decrease relative to the rotation speed in the agglomeration step), and after the reduction of the rotation speed, the aqueous 20% DBS solution (6 parts as solid components) was added thereto over 10 minutes. The resulting mixture was heated to 84° C. over 30 minutes and was continuously heated and agitated under the same conditions to give an average sphericity of 0.941, and then was cooled to 30° C. over 20 minutes to give slurry.

### [Preparation of Toner E]

Then, toner E was prepared by the same process as that in the external addition step of the “preparation of toner A” except that the amount of H2000 silica as an external additions was 1.41 g and the amount of SMT150IB titania fine powder as another external additive was a 0.56 g.

Analysis Step

The resulting toner E had a volume median diameter (Dv50) of 5.93 μm, which was measured Multisizer, the “content (% by number: Dns) of the toner particles having a particle diameter of 2.00 μm or more and 3.56 μm or less” was 3.62%, the average sphericity was 0.942, and the number variation coefficient was 20.1%.

### Toner Production Example 6

### [Preparation of Toner Mother Particles F]

Toner mother particles F were produced by the same process as that in the “preparation of toner mother particles A” of Example 1 except that the “core material agglomeration step”, “shell-coating step”, and “spheronization step”, in the agglomeration step (core material agglomeration step and shell-coating step), spheronization step, washing step, and drying step of the “preparation of toner mother particles A”, were modified as follows.

Core Material Agglomeration Step

A mixer (capacity: 12 L, internal diameter: 208 mm, height: 350 mm) equipped with an agitator (double helical blade), a heater/cooler, a concentrator, and a device for charging various raw materials and additives was charged with the polymer primary particle dispersion A1 and the aqueous 20% DBS solution, which were then mixed for 5 minutes into a homogeneous mixture at an internal temperature of 7° C. Subsequently, an aqueous 5 mass % ferrous sulfate solution (0.52 part as FeSO₄.7H₂O) was added to the mixture with agitation at 250 rpm over 5 minutes at an internal temperature of 21° C., and then the colorant dispersion A was added thereto over 5 minutes. The resulting mixture was continuously mixed at an internal temperature of 7° C. into a homogeneous mixture, and an aqueous 0.5 mass % aluminum sulfate solution (0.10 part of solid components on the basis of the resin solid components) were dropwise added thereto over 8 minutes under the same conditions. Then, at a rotation speed of 250 rpm, the internal temperature was increased to 57.0° C. While the volume median diameter (Dv50) was measured with Multisizer, the particles were allowed to grow up to a diameter of 6.76 μm.

Shell-coating Step

Then, the polymer primary particle dispersion A2 was added thereto over 3 minutes at an internal temperature of 57.0° C. at a rotation speed of 250 rpm. The resulting mixture was maintained under the same conditions for 60 minutes.

Spheronization Step

Subsequently, the rotation speed was decreased to 220 rpm (the peripheral velocity at the rotor end: 2.28 m/sec, a 12% decrease relative to the rotation speed in the agglomeration step), and after the reduction of the rotation speed, the aqueous 20% DBS solution (6 parts as solid components) was added thereto over 10 minutes. The resulting mixture was heated to 87° C. over 30 minutes and was continuously heated and agitated under the same conditions to give an average sphericity of 0.941, and then was cooled to 30° C. over 20 minutes to give slurry.

### [Preparation of Toner F]

Then, toner F was prepared by the same process as that in the external addition step of the “preparation of tone A” except that the amount of H2000 silica as an external additive was 1.25 g and the amount of SMT150IB titania fine powder as another external additive was 0.50 g.

Analysis Step

The resulting toner F had a volume median diameter (Dv50) of 6.77 μm, which was measured with Multisizer, the “content (% by number: Dns) of the toner particles having a particle diameter of 2.00 μm or more and 3.56 μm or less” was 2.48%, the average sphericity was 0.942, and the number variation coefficient was 21.1%.

### Toner Production Comparative Example 1

### [Preparation of Toner Mother Particles G]

Toner mother particles G were produced by the same process as that in the “preparation of toner mother particles A” of Example 1 except that the “core material agglomeration step”, “shell-coating step”, and “spheronization step”, in the agglomeration step (core material agglomeration step and shell-coating step), spheronization step, washing step, and drying step of the “preparation of toner mother particles A”, were modified as follows.

Core Material Agglomeration Step

A mixer (capacity: 12 L, internal diameter: 208 mm, height: 355 mm) equipped with an agitator (double helical blade), a heater/cooler, a concentrator, and a device for charging various raw materials and additives was charged with the polymer primary particle dispersion A1 and the aqueous 20% PBS solution, which were then mixed for 5 minutes into a homogeneous mixture at an internal temperature of 7° C. Subsequently, an aqueous 5 mass % ferrous sulfate solution (0.52 part as FeSO₄.7H₂O) was entirely added to the mixture with agitation at 250 rpm in 5 minutes at an internal temperature of 21° C., and then the colorant dispersion A was entirely added thereto in 5 minutes. The resulting mixture was continuously mixed at an internal temperature of 7° C. into a homogeneous mixture, and an aqueous 0.5 mass % aluminum sulfate solution (0.10 part of solid components on the basis of the resin solid components) was entirely added thereto in 8 seconds (sic) under the same conditions. Then, at a rotation speed of 250 rpm, the internal temperature was increased to 57.0° C. While the volume median diameter (Dv50) was measured with Multisizer, the particles were allowed to grow up to a diameter of 6.85 μm.

Shell-coating Step

Then, the polymer primary particle dispersion A2 was entirely added thereto in 3 minutes at an internal temperature of 57.0° C. at a rotation speed of 250 rpm. The resulting mixture was maintained under the same conditions for 60 minutes.

Spheronization Step

Subsequently, the rotation speed was kept at 250 rpm (the peripheral velocity at the rotor end: 2.59 m/sec, the same rotation speed as that in the agglomeration step), and the aqueous 20% DBS solution (6 parts as solid components) was added thereto over 10 minutes. The resulting mixture was heated to 87° C. over 30 minutes and was continuously heated and agitated under the same conditions to give an average sphericity of 0.942, and then was cooled to 30° C. over 20 minutes to give slurry.

### [Preparation of Toner G]

Then, toner G was prepared by the same process as that in the external addition seat of the “preparation of toner A” except that the amount of H2000 silica as an external additive was 1.25 g and the amount of SMT150IB titania fine powder as another external additive was 0.50 g.

Analysis Step

The resulting toner G had a volume median diameter (Dv50) of 6.79 μm, which was measured with Multisizer, the “content (% by number: Dns) of the toner particles having a particle diameter of 2.00 μm or more and 3.56 μm or less” was 4.52%, the average sphericity was 0.943, and the number variation coefficient was 24.5%.

### Examples 1 to 6 and Comparative Example 1

“Smears” were evaluated by the method of “actual printing evaluation 1” using each toner A to G and the photoreceptor 2 described below as the photoreceptor. Table 2 shows the results.

TABLE 2

| | | Rotation speed | | | | | Number | Charge density | |
|---|---|---|---|---|---|---|---|---|---|
| | | (peripheral velocity | Volume median | | | | variation | distribution | |
| | | at the rotor end) in | diameter (Dv50) | Average | 0.233EXP | Dns | coefficient | (standard deviation | |
| No. | Toner | spheronization step | (μm) | sphericity | (17.3/Dv) | (%) | (%) | of charge density) | Smear |
| Example 1 | A | 150 rpm | 5.54 | 0.943 | 5.29 | 3.83 | 18.6 | 1.64 | — |
| Example 2 | B | (1.56 m/sec) | 5.97 | 0.943 | 4.23 | 2.53 | 18.4 | 1.66 | — |
| Example 3 | C | | 6.75 | 0.942 | 3.02 | 1.83 | 18.7 | 1.68 | Excellent |
| Example 4 | D | 220 rpm | 5.48 | 0.943 | 5.48 | 4.51 | 20.4 | 1.94 | — |
| Example 5 | E | (2.28 m/sec) | 5.93 | 0.942 | 4.31 | 3.62 | 20.1 | 1.91 | — |
| Example 6 | F | | 6.77 | 0.942 | 3.00 | 2.48 | 21.1 | 1.92 | Good |
| Comparative | G | 250 rpm | 6.79 | 0.943 | 2.98 | 4.52 | 24.5 | 2.60 | Poor |
| Example 1 | | (2.59 m/sec) | | | | | | | |

As obvious from the results shown in Table 2, the methods described in Toner Production Examples 1 to 6 can actually produce toners A to F that satisfy the requirement (3) according to the present invention. All the toners A to F that satisfy all the requirements (1) to (3) of the present invention show sufficiently small standard deviations of charge density and significantly narrow charge density distributions. In the actual printing evaluation 1 using a combination of any of the toners and the photoreceptor 2 described below, smears are not observed at all or are an acceptable level (Examples 3 and 6).

In contrast, the toner G that does not satisfy the requirement (3) shows a large standard deviation of charge density and a broad charge density distribution. In the actual printing evaluation 1 using a combination of the toner and the photoreceptor 2 described below, distinct smears are observed over the entire print (Comparative Example 1).

### Toner Production Example 7

### [Preparation of Wax/Long-chain Polymerizable Monomer Dispersion H1]

Twenty seven parts (540 g) of paraffin wax (HNP-9, manufactured by Nippon Seiro Co., Ltd., surface tension: 23.5 mN/m, thermal characteristics: a melting point peak temperature of 82° C., a half width of fusion curve of 8.2° C., a crystallization temperature of 66° C., a half width of crystallization curve of 13.0° C.), 2.8 parts of stearyl acrylate (manufactured by TOKYO CHEMICAL INDUSTRY CO., LTD.), 1.9 parts of an aqueous 20% DBS solution, and 68.3 parts of desalted water were heated to 90° C. and were agitated with a homomixer (model: Mark II f, manufactured by Tokusyo Kika Kogyo Co., Ltd.) for 10 minutes.

Then, the resulting dispersion was heated to 90° C., and was circulation-emulsified in a homogenizer (model: 15-M-8PA, manufactured by Gaulin) under a pressure of 25 MPa. While the particle diameter was measured with Nanotrac, the dispersion was continued to give a volume-average particle diameter (Mv) of 250 nm to prepare a wax/long-chain polymerizable monomer dispersion H1 (solid content of the emulsion=30.2 mass %).

### [Preparation of Polymer Primary Particle Dispersion H1]

A reactor (internal capacity: 21 L, internal diameter: 250 mm, height: 420 mm) equipped with an agitator (three blades), a heater/cooler, and a device for charging various raw materials and additives was charged with 35.6 parts (712.12 g) of the wax/long-chain polymerizable monomer dispersion H1 and 259 parts of desalted water, which were then heated to 90° C. under a nitrogen stream with agitation.

Thereafter, a mixture of the following “polymerizable monomers” and “an aqueous emulsifier solution” was added to the dispersion with agitation over a period of 5 hours. The “initiation of the polymerization” was defined as the starting time of the dropwise addition of the mixture. Thirty minutes after the initiation of the polymerization, the following “aqueous initiator solution” was added over a period of 4.5 hours. Furthermore, 5 hours after the initiation of the polymerization, the following “aqueous additional initiator solution” was added over a period of 2 hours, and the polymerization was continued at an internal temperature of 90° C. for further 1 hour with agitation.

### [Polymerizable Monomers]

Styrene: 76.8 parts (1535.0 G)

Butyl acrylate: 23.2 parts

Acrylic acid: 1.5 parts

Hexanediol diacrylate: 0.7 part

Trichlorobromomethane: 1.0 part

### [Aqueous Emulsifier Solution]

Aqueous 20% DBS solution: 1.0 part

Desalted water: 67.1 parts

### [Aqueous Initiator Solution]

Aqueous 8 mass % hydrogen peroxide solution: 15.5 parts

Aqueous 8 mass % L(+)-ascorbic acid solution: 15.5 parts

### [Aqueous Additional Initiator Solution]

Aqueous 8 mass % L(+)-ascorbic acid solution: 14.2 parts

After completion of the polymerization reaction, the reaction system was cooled to give a milky white polymer primary particle dispersion H1. The volume-average particle diameter (Mv) measured with Nanotrac was 265 nm, and the solid content was 22.3 mass %.

### [Preparation of Silicone Wax Dispersion H2]

Twenty seven parts (540 g) of an alkyl-modified silicone wax (thermal characteristics: a melting point peak temperature of 77° C., a heat of fusion of 97J/g, a half width of fusion curve: 10.9° C., a crystallization temperature: 61° C., half width of crystallization curve: 17.0° C.), 1.9 parts of an aqueous 20% DBS solution, and 71.1 parts of desalted water were put in a 3-L stainless steel container and were heated to 90° C. and agitated with a homomixer (model: Mark II f, manufactured by Tokusyu Kika Kogyo Co., Ltd.) for 10 minutes. Then, the resulting dispersion was heated to 99° C., and was circulation-emulsified in a homogenizer (model: 15-M-8PA, manufactured by Gaulin) under a pressure of 45 MPa. While the volume-average particle diameter (Mv) was measured with Nanotrac, dispersion was continued to give a volume-average particle diameter (Mv) of 240 nm to prepare a silicone wax dispersion H2 (solid content of tee emulsion=27.3%).

### [Preparation of Polymer Primary Particle Dispersion H2]

A reactor (internal capacity: 21 L, internal diameter: 250 mm, height: 420 mm) equipped with an agitator (three blades), a heater/cooler, and a device for charging various raw materials and additives was charged with 23.3 parts by weight (466 g) of the silicone wax dispersion H2, 1.0 part of an aqueous 20% DBS solution, and 324 parts of desalted water, which were then heated to 90° C. under a nitrogen stream. Then, 3.2 parts of an aqueous 8% hydrogen peroxide solution and 1.2 parts of an aqueous 8% L(+)-ascorbic acid solution were simultaneously added thereto with agitation. The “initiation of the polymerization” was defined as the time 5 minutes after the simultaneous addition.

A mixture of the following “polymerizable monomers” and “aqueous emulsifier solution” was added over a period of 5 hours from the initiation of the polymerization. Furthermore, the following “aqueous initiator solution” was added over a period of 6 hours from the initiation of the polymerization, and the polymerization was continued at an internal temperature of 90° C. for further 1 hour with agitation.

### [Polymerizable Monomers]

Styrene: 92.5 parts (1850.0 G)

Butyl acrylate: 7.5 parts

Acrylic acid: 1.5 parts

Trichlorobromomethane: 0.6 part

### [Aqueous Emulsifier Solution ]

Aqueous 20% DBS solution: 1.0 part

Desalted water: 67.0 parts

### [Aqueous Initiator Solution]

Aqueous 8 mass % hydrogen peroxide solution: 18.9 parts

Aqueous 8 mass % L(+)-ascorbic acid solution: 18.0 parts

After completion of the polymerization reaction, the reaction system was cooled to give a milky white polymer primary particle dispersion H2. The volume-average particle diameter (Mv) measured with Nanotrac was 290 nm, and the solid content was 19.0 mass %.

### [Preparation of Colorant Dispersion H]

A container having an internal capacity of 300 L and equipped with an agitator (propeller blade) was charged with 20 parts (40 kg) of carbon black (Mitsubishi Carbon Black MA100S, manufactured by Mitsubishi Chemical Corp.) that was prepared by a furnace process and had an ultraviolet absorption of 0.02 in a toluene extract and a true density of 1.8 g/cm³, 1 part of an aqueous 20% DBS solution, 4 parts of a nonionic surfactant (Emargen 120, manufactured by Kao Corp.), and 75 parts of deionized water having an electric conductivity of 2 μS/cm for predispersion to give a pigment premix solution. The volume-average particle diameter (Mv) of the carbon black in the dispersion after the pigment premix measured with Nanotrac was about 90 μm.

The pigment premix solution was supplied to a wet bead mill as raw material slurry for one-path dispersion. The stator had an internal diameter of 75 mm, the separator had a diameter of 60 mm, and the distance between the separator and the disk was 15 mm. The medium for dispersion was zirconia beads (true density: 6.0 g/cm²) with a diameter of 100 μm. Since the stator having an effective internal capacity of 0.5 L was filled with 0.35 L of the medium, the filling rate of the medium was 70 mass %. The rotation speed of the rotor was maintained constant (the peripheral velocity at the rotor end: 11 m/sec), and the pigment premix solution was continuously supplied to the mill at a supply rate of 50 L/hr from a supply port with a non-pulsing metering pump and was continuously discharged from a discharging port to give a black colorant dispersion H. The volume-average particle diameter (Mv) of the colorant dispersion H measured with Nanotrac was 150 nm, and the solid content was 24.2 mass %.

### [Preparation of Toner Mother Particles H]

Toner mother particles H were produced by the following agglomeration step (core material agglomeration step and shell-coating step), spheronization step, washing step, and drying step using the following components:

Polymer primary particle dispersion H1: 90 parts as solid components (958.9 g as solid components),

Polymer primary particle dispersion H2: 10 parts as solid components,

Colorant dispersion H: 4.4 parts as colorant solid components,

Aqueous 20% DBS solution: 0.15 part as solid components in the core material agglomeration step, and

Aqueous 20% DBS solution: 6 parts as solid components in the spheronization step.

Core Material Agglomeration Step

A mixer (capacity: 12 L, internal diameter: 208 mm, height: 355 mm) equipped with an agitator (double helical blade), a heater/cooler, and a device for charging various raw materials and additives was charged with the polymer primary particle dispersion H1 and the aqueous 20% DBS solution, which were then mixed for 10 minutes into a homogeneous mixture at an internal temperature of 10° C. Subsequently, an aqueous 5 mass % potassium sulfate solution (0.12 part as K₂SO₄) was sequentially added to the mixture with agitation at 280 rpm over 1 minute at an internal temperature of 10° C., and then the colorant dispersion H was sequentially added thereto over 5 minutes. The resulting mixture was mixed at an internal temperature of 10° C. into a homogeneous mixture.

Then, 100 parts of desalted water was sequentially added to the mixture over 30 minutes, and at a rotation speed of 280 rpm, the internal temperature was increased to 48.0° C. over 67 minutes (0.5° C./min) and then raising temperature by 1° C. every 30 minutes (0.03° C./min), and the temperature was kept at 54.0° C. While the volume median diameter (Dv50) was measured with Multisizer, the particles were allowed to grow up to a diameter of 5.15 μm.

The agitation on this occasion was carried out under the following conditions:
(iii) the diameter of agitation container (as a common cylindrical type): 208 mm,
(ii) the height of agitation container: 355 mm,

(iii) the peripheral velocity at the rotor end: 280 rpm, i.e., 2.78 m/sec,

(iv) the shape of agitation blade: double helical blade (diameter: 190 mm, height: 20 mm, width: 20 mm), and

(v) the position of blade in agitation container: disposed 5 mm upper from the bottom of the container.

Shell-coating Step

Then, the polymer primary particle dispersion H2 was sequentially added thereto over 6 minutes at an internal temperature of 54.0° C. at a rotation speed of 280 rpm. The resulting mixture was maintained under the same conditions for 60 minutes. On this occasion, the Dv50 of the particles was 5.34 μm.

Spheronization Step

Subsequently, while an aqueous mixture of the aqueous 20% DBS solution (6 parts as solid components) and 0.04 part of water was added thereto over 30 minutes, the mixture was heated to 83° C. The resulting mixture was further heated by 1° C. every 30 minutes up to 88° C., and was continuously heated and agitated under the sate conditions over 3.5 hours to give an average sphericity of 0.939, and then was cooled to 20° C. over 10 minutes to give slurry. On this occasion, the Dv50 of the particles was 5.33 μm, and the average sphericity was 0.937.

Washing Step

The resulting slurry wee extracted and was filtered by suction with an aspirator through a filter paper No. 5C (manufactured by Toyo Roshi Co., Ltd.). The cake remaining on the filter paper was transferred to a stainless steel container having an internal capacity of 10 L and equipped with an agitator (propeller blade), and 8 kg of deionized water with an electric conductivity of 1 μS/cm was added thereto. The resulting mixture was agitated at 50 rpm into a homogeneous dispersion and was continuously agitated for further 30 minutes.

Then, the mixture was filtered by suction with an aspirator through a filter paper No. 5C (manufactured by Toyo Roshi Co., Ltd.) again. The solid remaining on the filter paper was transferred to a container having an internal capacity of 10 L, equipped with an agitator (propeller blade), and containing 8 kg of deionized water having an electric conductivity of 1 μS/cm, and the resulting mixture was agitated at 50 rpm for 30 minutes into a homogeneous dispersion. This process was repeated five times to give a filtrate having an electric conductivity of 2 μS/cm.

Drying Step

The resulting solid was bedded in a stainless steel vat so as to have a thickness of 20 mm and was dried in a fan dryer set at 40° C. for 48 hours to give toner mother particles H.

### [Preparation of Toner H]

External Addition Step

The resulting toner mother particles H (500 g) was mixed with 8.75 g of H30TD silica manufactured by Clariant Inc., as an external additive with a 9-L Henshcel mixer (Mitsui Mining Co., Ltd.) at 3000 rpm for 30 minutes. Furthermore, 1.4 g of calcium phosphate HAP-05NP manufactured by Maruo Calcium Co., Ltd. Was added thereto, followed by mixing at 3000 rpm for 10 minutes. The mixture was filtered through a 200-mesh sieve to give toner H.

Analysis Step

The resulting toner H had a “volume median diameter (Dv50)” of 5.26 μm, which was measured with Multisizer, the “content (% by number: Dns) of the toner particles having a particle diameter of 2.00 μm or more and 3.56 μm or less” was 5.87%, the average sphericity was 0.948, and the number variation coefficient was 18.0%.

### Toner Production Example 3

### [Preparation of Toner Mother Particles I]

Toner mother particles I were produced by the same process as that in the “preparation at toner mother particles H” of Example 7 except that the “core material agglomeration step”, “shell-coating step”, and “spheronization step”, in the agglomeration step (core material agglomeration step and shell-coating step), spheronization step, washing step, and drying step of the “preparation of toner mother particles H”, were modified as follows.

Core Material Agglomeration Step

A mixer (capacity: 12 L, internal diameter: 208 mm, height: 355 mm) equipped with an agitator (double helical blade), a heater/cooler, a concentrator, and a device for charging various raw materials and additives was charged with the polymer primary particle dispersion H1 and the aqueous 20% DBS solution, which were then mixed for 5 minutes into a homogeneous mixture at an internal temperature of 10° C. Subsequently, 0.12 part of an aqueous 5 mass % potassium sulfate solution was sequentially added to the mixture with agitation at 280 rpm over 1 minute at an internal temperature of 10° C., and then the colorant dispersion H was sequentially added thereto over 5 minutes. The resulting mixture was mixed at an internal temperature of 10° C. into a homogeneous mixture. Then, 100 parts of desalted water was sequentially added to the mixture over 26 minutes, and at a rotation speed of 280 rpm, the internal temperature was increased to 52.0° C. over 64 minutes (0.5° C./min) and then by 1° C. over 30 minutes (0.03° C./min), and the resulting temperature was kept for 110 minutes. While the volume median diameter (Dv50) was measured with Multisizer, the particles were allowed to grow up to a diameter of 5.93 μm. The agitation was carried out under the same conditions as those in Example 7.

Shell-coating Step

Then, the polymer primary particle dispersion H2 was sequentially added to the resulting mixture over 6 minutes at an internal temperature of 53.0° C. at a rotation speed of 280 rpm. The resulting mixture was maintained under the same conditions for 90 minutes. On this occasion, the Dv50 of the particles was 6.23 μm.

Spheronization Step

Subsequently, while an aqueous mixture of the aqueous 20% DBS solution (6 parts as solid components) and 0.04 part of water was added thereto over 30 minutes, the mixture was heated to 85° C. The resulting mixture was heated to 92° C. over 130 minutes and was continuously heated and agitated under the same conditions to give an average sphericity of 0.943, and then was cooled to 20° C. over 10 minutes to give slurry. On this occasion, the Dv50 of the particles was 6.17 μm, and the average sphericity was 0.945. The washing, drying, and external addition steps were carried out in the same manner as those in Example 7.

External Addition Step

The resulting toner mother particles 1 (500 g) was mixed with 7.5 g or H30TD silica manufactured by Clariant Inc., as an external additive with a 9-L Henshcel mixer (Mitsui Mining Co., Ltd.) at 3000 rpm for 30 minutes. Furthermore, 1.2 g of calcium phosphate HAP-05NP manufactured by Maruo Calcium Co., Ltd. Was added thereto, followed by mixing at 3000 rpm for 10 minutes. The mixture was filtered through a 200-mesh sieve to give toner I.

Analysis Step

The resulting toner I had a “volume median diameter (Dv50)” of 5.16 μm, which was measured with Multisizer, the “content (% by number: Dns) of the toner particles having a particle diameter of 2.00 μm or more and 3.56 μm or less” was 2.79%, the average sphericity was 0.946, and the number variation coefficient was 19.2%.

### Toner Production Example 9

### [Preparation of Toner Mother Particles J]

Toner mother particles J were produced by the same process as that in the “preparation of toner mother particles H” of Example 7 except that the “core material agglomeration step”. “shell-coating step”, and “spheronization step”, in the agglomeration step (core material agglomeration step and shell-coating step), spheronization step, washing step, and drying step of the “preparation of toner mother particles H”, were modified as follows.

Core Material Agglomeration Step

A mixer (capacity: 12 L, internal diameter: 208 mm, height: 355 mm) equipped with an agitator (double helical blade), a heater/cooler, a concentrator, and a device for charging various raw materials and additives was charged with the polymer primary particle dispersion H1 and the aqueous 20% DBS solution, which were then mixed for 10 minutes into a homogeneous mixture at an internal temperature of 10° C. Subsequently, 0.12 part of an aqueous 5 mass % potassium sulfate solution was sequentially added to the mixture with agitation at 280 rpm over 1 minute at an internal temperature of 10° C., and then the colorant dispersion H was sequentially added thereto over 5 minutes. The resulting mixture was mixed at an internal temperature of 10° C. into a homogeneous mixture. Then, 0.5 part of desalted water was sequentially added to the mixture over 26 minutes, and, at a rotation speed of 280 rpm, the internal temperature was increased to 52.0° C. over 64 minutes (0.5° C./min) and then by 1° C. over 30 minutes (0.03° C./min), and the resulting temperature was kept for 130 minutes. While the volume median diameter (Dv50) was measured with Multisizer, the particles were allowed to grow up to a diameter of 6.60 μm. The agitation was carried out under the same conditions as those in Example 7.

Shell-coating Step

Then, the polymer primary particle dispersion H2 was sequentially added to the resulting mixture over 6 minutes at an internal temperature of 53.0° C. at a rotation speed of 280 rpm. The resulting mixture was maintained under the same conditions for 60 minutes. On this occasion, the Dv50 of the particles was 6.93 μm.

Spheronization Step

Subsequently, while an aqueous mixture of the aqueous 20% DBS solution (6 parts as solid components) and 0.04 part of water was added thereto over 30 minutes, the mixture was heated to 90° C. The resulting mixture was heated to 97° C. over 60 minutes and was continuously heated and agitated under the same conditions to give an average sphericity of 0.945, and then was cooled to 20° C. over 10 minutes to give slurry. On this occasion, the Dv50 of the particles was 6,93 μm, and the average sphericity was 0.945. The washing and drying steps were carried out in the same manner as those in Example 7.

External Addition Step

The resulting toner mother particles J (500 g) was mixed with 6.25 g of H30TD silica manufactured by Clariant Inc., as an external additive with a 9-L Henshcel mixer (Mitsui Mining Co.; Ltd.) at 3000 rpm for 30 minutes. Furthermore, 1.0 g of calcium phosphate HAP-05NP manufactured by Maruo Calcium Co., Ltd. Was added thereto, followed by mixing at 3000 rpm for 10 minutes. The mixture was filtered through a 200-mesh sieve to give toner J.

Analysis Step

The resulting toner J had a “volume median diameter (Dv50)” of 6.97 μm, which was measured with Multisizer, the “content (% by number: Dns) of the toner particles having a particle diameter of 2.00 μm or more and 3.56 μm or less” was 1.82%, the average sphericity was 0.946, and the number variation coefficient was 19.5%.

### Toner Production Comparative Example 2

### [Preparation of Toner Mother Particles O]

Toner mother particles O were produced by the same process as that in the “preparation of toner mother particles H” of Example 7 except that the “core material agglomeration step”, “shell-coating step”, and “spheronization step”, in the agglomeration step (core material agglomeration step and shell-coating step), spheronization step, washing step, and drying step of the “preparation of toner mother particles H”, were modified as follows.

Core Material Agglomeration Step

A mixer (capacity: 12 L, internal diameter: 208 mm, height: 355 mm) equipped with an agitator (double helical blade), a heater/cooler, a concentrator, and a device for charging various raw materials and additives was charged with the polymer primary particle dispersion H1 and the aqueous 20% DBS solution, which were then mixed for 10 minutes into a homogeneous mixture as an internal temperature of 10° C. Subsequently, 0.12 part of an aqueous 5 mass % potassium sulfate solution was sequentially added to the mixture with agitation at 280 rpm over 1 minute at an internal temperature of 10° C., and then the colorant dispersion H was sequentially added thereto over 5 minutes. The resulting mixture was mixed as an internal temperature of 10° C. into a homogeneous mixture. Then, 200 parts of desalted water was sequentially added to the mixture over 30 minutes, and at a location speed of 280 rpm, the internal temperature was increased to 34.0° C. over 40 minutes (0.6° C./min), and the resulting temperature was kept for 20 minutes. While the volume median diameter (Dv50) was measured with Multisizer, the particles were allowed to grow up to a diameter of 3.81 μm.

Shell-coating Step

Then, the polymer primary particle dispersion H2was added thereto over 6 minutes at an internal temperature of 34.0° C. at a rotation speed of 280 rpm. The resulting mixture was maintained under the same conditions for 90 minutes.

Spheronization Step

Subsequently, the rotation speed was kept at 280 rpm (the same rotation speed as that in the agglomeration step), and the aqueous 20% DBS solution (6 parts as solid components) was added thereto over 10 minutes. The resulting mixture was heated to 76° C. over 30 minutes and was continuously heated and agitated under the same conditions to give an average sphericity of 0.962, and then was cooled to 20° C. over 10 minutes to give slurry.

### [Preparation of Toner K]

Then, 100 parts of toner mother particles H prepared in Example 7 was mixed with 1 part of the toner mother particles O, and 500 g of the resulting toner mother particle mixture K was mixed with 8.75 g of H30TD silica manufactured by Clariant Inc., as an external additive with a 9-L Henshcel mixer (Mitsui Mining Co., Ltd.) at 3000 rpm for 30 minutes. Furthermore, 1.4 g of calcium phosphate HAP-05NP manufactured by Maruo Calcium Co., Ltd. Was added thereto, followed by mixing at 3000 rpm for 10 minutes. The mixture was filtered through a 200-mesh sieve to give toner K.

Analysis Step

The resulting toner K had a “volume median diameter (Dv50)” of 5.31 μm, which was measured with Multisizer, the “content (% by number: Dns) of the toner particles having a particle diameter of 2.00 μm or more and 3.56 μm or less” was 7.22%, the average sphericity was 0.949, and the number variation coefficient was 19.2%.

### Toner Production Comparative Example 3

### [Preparation of Toner Mother Particles L]

Toner mother particles L were produced by the same process as that in the “preparation of toner mother particles H” of Example 7 except that the “core material agglomeration step”, “shell-coating step”, and “spheronization step”, in the agglomeration step (core material agglomeration step and shell-coating step), spheronization step, washing step, and drying step of the “preparation of toner mother particles H”, were modified as follows.

Core Material Agglomeration Step

A mixer (capacity: 12 L, internal diameter: 208 mm, height: 355 mm) equipped with an agitator (double helical blade), a heater/cooler, a concentrator, and a device for charging various raw materials and additives was charged with the polymer primary particle dispersion H1 and the aqueous 20% DBS solution, which were then mixed tor 10 minutes into a homogeneous mixture at an internal temperature of 10° C. Subsequently, an aqueous 5 mass % potassium sulfate solution (0.12 part as K₂SO₄) was sequentially added to the mixture with agitation at 310 rpm over 1 minute at an internal temperature of 10° C., and then the colorant dispersion H was sequentially added thereto over 5 minutes. The resulting mixture was mixed at an internal temperature of 10° C. into a homogeneous mixture.

Then, 100 parts of desalted water was sequentially added to the mixture over 30 minutes, and at a rotation speed of 310 rpm, the internal temperature was increased to 48.0° C. over 67 minutes (0.5° C./min) then by 1° C. every 30 minutes (0.03° C./min) to 53.0° C. The temperature was kept at this temperature, and while the volume median diameter (Dv50) was measured with Multisizer, the particles were allowed to grow or up to a diameter of 5.08 μm.

The agitation on this occasion was carried out under the same conditions as those in Example 7 except that the condition (iii) was as follows:

(iii) the peripheral velocity at the rotor end: 310 rpm, i.e., 3.08 m/sec.

Shell-coating Step

Then, the polymer primary particle dispersion H2 was added thereto over 6 minutes at an internal temperature of 54.0° C. at a rotation speed of 310 rpm. The resulting mixture was maintained under the same conditions for 60 minutes. On this occasion, the Dv50 of the particles was 5.19 μm.

Spheronization Step

Subsequently, while an aqueous mixture of the aqueous 20% DBS solution (6 parts as solid components) and 0.04 part of water was added thereto over 30 minutes, the mixture was heated to 83° C. The resulting mixture was heated by 1° C. every 30 minutes to 90° C. and was continuously heated and agitated under the same conditions for 2.5 hours to give an average sphericity of 0.939, and then was cooled to 20° C. over 10 minutes to give slurry. On this occasion, the Dv50 of the particles was 5.18 μm, and the average sphericity was 0.940. The washing and drying steps were carried out in the same manner as those in Example 7.

External Addition Step

The resulting toner mother particles L (500 g) were mixed with 8.75 g of H30TD silica manufactured by Clariant Inc., as an external additive with a 9-L Henshcel mixer (Mitsui Mining Co., Ltd.) at 3000 rpm for 30 minutes. Furthermore, 1.4 g of calcium phosphate HAP-05NP manufactured by Maruo Calcium Co., Ltd. Was added thereto, followed by mixing at 3000 rpm for 10 minutes. The mixture was filtered through a 200-mesh sieve to give toner L.

Analysis Step

The resulting toner L had a “volume median diameter (Dv50)” of 5.18 μm, which was measured with Multisizer, the “content (% by number: Dns) of the toner particles having a particle diameter of 2.00 μm or more and 3.56 μm or less” was 9.94%, the average sphericity was 0.940, and the number variation coefficient was 20.4%.

### Toner Production Comparative Example 4

### [Preparation of Toner Mother Particles M]

Toner mother particles M were produced by the same process as that in the “preparation of toner mother particles H” of Example 7 except that the “core material agglomeration Step”, “shell-coating step”, and “spheronization Step”, in the agglomeration step (core material agglomeration step and shell-coating step), spheronization step, washing step, and drying step of the “preparation of toner mother particles H”, were modified as follows.

Core Material Agglomeration Step

A mixer (capacity: 12 L, internal diameter: 208 mm, height: 355 mm) equipped with an agitator (double helical blade), a heater/cooler, a concentrator, and a device tor charging various raw materials and additives was charged with the polymer primary particle dispersion H1 and the aqueous 20% DBS solution, which were then mixed for 10 minutes into a homogeneous mixture at an internal temperature of 10° C. Subsequently, an aqueous 5 mass % potassium sulfate solution (0.12 part as K₂SO₄) was sequentially added to the mixture with agitation at 310 rpm over 1 minute at an internal temperature of 10° C., and then the colorant dispersion H was sequentially added thereto over 5 minutes. The resulting mixture was mixed at an internal temperature of 10° C. into a homogeneous mixture.

Then, 100 parts of desalted water was sequentially added to the mixture over 30 minutes. The agitation at a rotation speed of 310 rpm was continued, and the internal temperature of the resulting mixture was increased to 52.0° C. over 56 minutes (0.8° C./min) then by 1° C. every 30 minutes (0.03° C./min) to 54.0° C. The temperature was kept at 54.0° C., and while the volume median diameter (Dv50) was measured with Multisizer, the particles were allowed to grow up to a diameter of 5.96 μm.

The agitation on this occasion was carried out under the same conditions as those in Example 7 except that the condition (iii) was as follows:

(iii) the peripheral velocity at the rotor end: 310 rpm, i.e., 3.08 m/sec.

Shell-coating Step

Then, the polymer primary particle dispersion H2 was added thereto over 6 minutes at an internal temperature of 54.0° C. at a rotation speed of 310 rpm. The resulting mixture was maintained under the same conditions for 60 minutes. On this occasion, the Dv50 of the particles was 5.94 μM.

Spheronization Step

Subsequently, while an aqueous mixture of the aqueous 20% DBS solution (6 parts as solid components) and 0.04 part of water was added thereto over 30 minutes, the mixture was heated to 88° C. The resulting mixture was heated by 1° C. every 30 minutes to 90° C. and was continuously heated and agitated under the same conditions for 2 hours to give an average sphericity of 0.940, and then was cooled to 20° C. over 10 minutes to give slurry. On this occasion, the Dv50 of the particles was 5.88 μm, and the average sphericity was 0.943. The washing and drying steps were carried out in the same manner as those in Example 7.

External Addition Step

The resulting toner mother particles M (500 g) were mixed with 7.5 g of H30TD silica manufactured by Clariant Inc., as an external additive with a 9-L Henshcel mixer (Mitsui Mining Co., Ltd.) at 3000 rpm for 30 minutes. Furthermore, 1.2 g of calcium phosphate HAP-05NP manufactured by Maruo Calcium Co., Ltd. Was added thereto, followed by mixing at 3000 rpm for 10 minutes. The mixture was filtered through a 200-mesh sieve to give toner M.

Analysis Step

The resulting toner M had a “volume median diameter (Dv50)” of 5.92 μm, which was measured with Multisizer, the “content (% by number: Dns) of the toner particles having a particle diameter of 2.00 μm or more and 3.56 μm or less” was 5.22%, the average sphericity was 0.945, and the number variation coefficient was 21.2%.

Toner Production Comparative Example 5

The toner mother particles J (100 parts) prepared in Example 9 was mixed with 3 parts of the toner mother particles O, and 500 g of the resulting toner mother particle mixture was mixed with 6.25 g of H30TD silica manufactured by Clariant Inc., as an external additive with a 9-L Henshcel mixer (Mitsui Mining Co., (Ltd.) at 3000 rpm for 30 minutes. Furthermore, 1.0 g of calcium phosphate HAP-05NP manufactured by Maruo Calcium Co., Ltd. Was added thereto, followed by mixing at 3000 rpm for 30 minutes. The mixture was filtered through a 200-mesh sieve to give toner N.

Analysis Step

The resulting toner N had a “volume median diameter (Dv50 )” of 6.88 μm, which was measured with Multisizer, the “content (% by number: Dns) of the toner particles having a particle diameter of 2.00 μm or more and 3.56 μm or less” was 0.08%, the average sphericity was 0.952, and the number variation coefficient was 25.6%.

### Examples 7 to 0 and Comparative Examples 2 to 5

Toners H to N were subjected to actual printing evaluation according to the actual printing evaluation 2 using the photoreceptor 2 described below. Table 3 shows the results.

TABLE 3

| | | | | | | Number | | Thin spot | |
|---|---|---|---|---|---|---|---|---|---|
| | | Volume median | | | | variation | Residual image | (imperfect solid | Cleaning |
| | | diameter (Dv50) | Average | 0.233EXP | Dns | coefficient | (ghost) | image) | properties |
| No. | Toner | (μm) | sphericity | (17.3/Dv) | (%) | (%) | (8 kp) | (8 kp) | (8 kp) |
| Example 7 | H | 5.26 | 0.948 | 6.25 | 5.87 | 18.0 | Excellent | Excellent | Good |
| Example 8 | I | 6.16 | 0.946 | 3.86 | 2.79 | 19.2 | Good | Excellent | Good |
| Example 9 | J | 6.97 | 0.946 | 2.79 | 1.85 | 19.5 | Good | Good | Good |
| Comparative | K | 5.31 | 0.949 | 6.06 | 7.22 | 19.2 | Poor | Poor | Poor |
| Example 2 | | | | | | | | | |
| Comparative | L | 5.18 | 0.940 | 6.57 | 9.94 | 20.4 | Bleeding of toner from developer tank | | |
| Example 3 | | | | | | | (image not obtained) | | |
| Comparative | M | 5.92 | 0.945 | 4.33 | 5.22 | 21.2 | Poor | Good | Poor |
| Example 4 | | | | | | | | | |

| | | | | | | | |
|---|---|---|---|---|---|---|---|
| Comparative | N | 6.88 | 0.952 | 2.88 | 9.08 | 25.6 | Bleeding of toner from developer tank |
| Example 5 | | | | | | | (image not obtained) |

All toners in Examples 7 to 9 are satisfactory in all the residual image (ghost), thin spot (imperfect solid image), and cleaning properties, and no “selective development” is observed. In contrast, in Comparative Examples 2 to 5, all the toners are unsatisfactory in the residual image (ghost), thin spot (imperfect solid image), and cleaning properties. Toners H, I, and J exhibit excellent actual printing properties when used in combination with the photoreceptor 2 described below, but toners K, L, M, and N exhibit poor actual printing properties even in combination with the photoreceptor 2 described below.

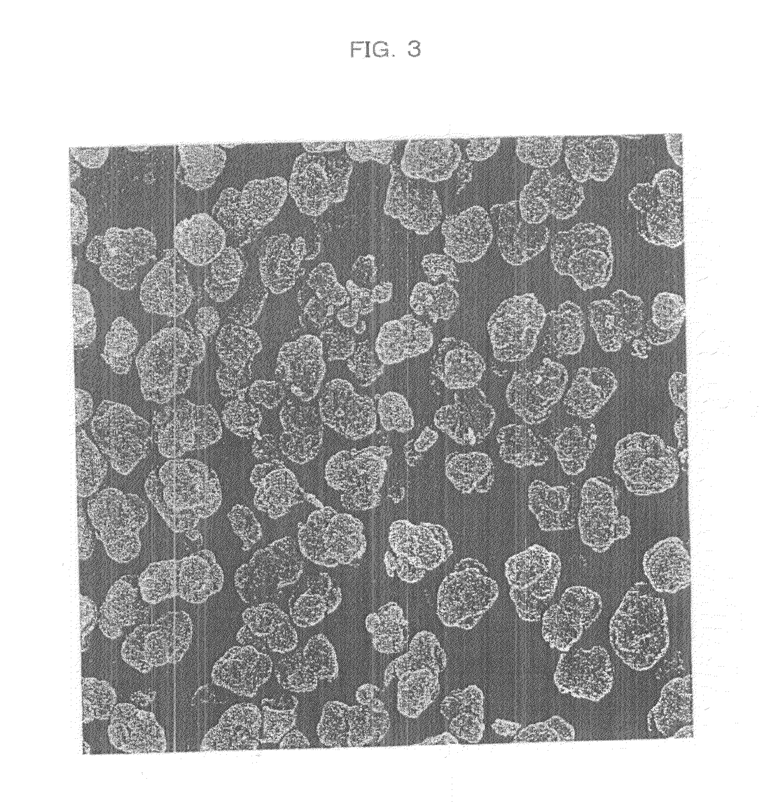

FIG. 3 is a scanning electron microscopic (SEM) photograph of the toner (toner K) prepared in Toner Production Comparative Example 2, and FIG. 4 is an SEM photograph of the toner (toner H) prepared in Toner Production Example 7. It is obvious from comparison of these toners that the toner shown in FIG. 3 (Toner Production Comparative Example 2) contains fine powder of 3.56 μm or less in a larger amount than that in the toner shown in FIG. 4 (Toner Production Example 7).

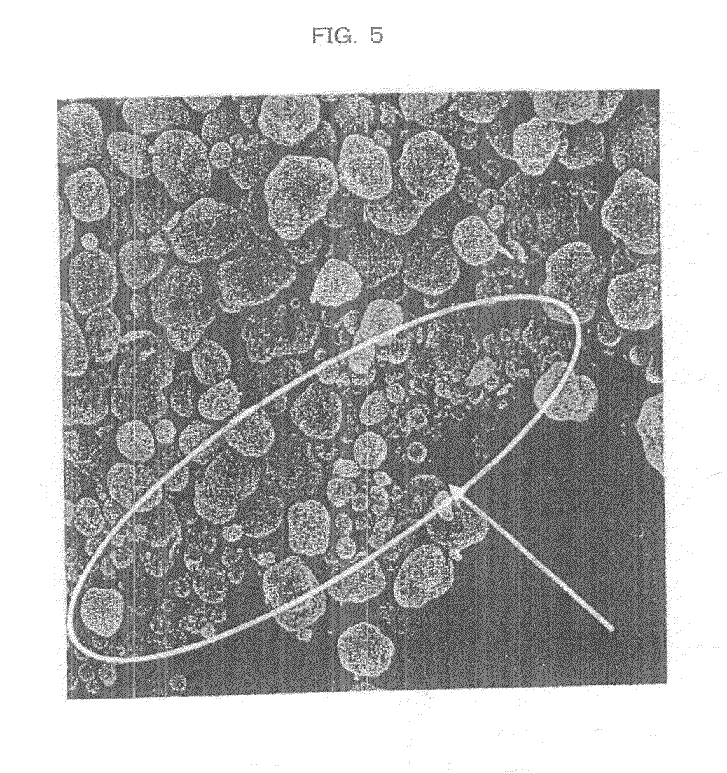

FIG. 5 is an SEM photograph of the toner (toner K) that was prepared in Toner Production Comparative Example 2 and that adhered to the cleaning blade after actual printing evaluation. It is evident that, in printing for a long period of time using such toner containing a large amount of fine powder as shown in FIG. 5, the fine powder of 3.56 μm or less with high adherence significantly accumulates on the cleaning blade in the image-forming apparatus to form a bank having a high bulk density, resulting in prevention of the toner from being transferred. The area surrounded by an ellipse in FIG. 5 is the bank formed by the accumulation of fine powder of 3.56 μm or less.

### [Photoreceptor]

[Measurement Process of CuKα Characteristic X-rays (wavelength: 1.541 angstroms) of charge-generating layer]

The “diffraction peak (Bragg angle) by CuKα characteristic X-rays” of oxytitanium phthalocyanine contained in the photosensitive layer in the present invention is determined with oxytitanium phthalocyanine actually contained in the photosensitive layer.

The diffraction pattern of the photosensitive layer by CuKα characteristic X-rays may be measured by any method that can give the X-ray diffraction pattern of photosensitive layer itself. For example, a photosensitive layer formed on a glass plate is used for measurement. A process for measuring the diffraction pattern of a photosensitive layer of the present invention by CuKα characteristic X-rays, that is, a diffraction pattern of oxytitanium phthalocyanine by CuKα characteristic X-rays, will be described below. In the samples prepared in the following preparation processes (1) and (2), the diffraction patterns of oxytitanium phthalocyanine by CuKα characteristic X-rays are generally identical, and these processes do not include a step that may change a crystal structure. Consequently, the diffraction peak is the same as that of oxytitanium phthalocyanine in the actual state of the oxytitanium phthalocyanine contained in a photosensitive layer.

### 1. Sample Preparation Process (1)

A coating liquid for forming a photosensitive layer was applied on an invisible cover glass into a dried thickness of 10 μm or more.

### 1. Sample Preparation Process (2)

As described below in photoreceptor-producing examples 1 and 4 and comparative photoreceptor-producing examples 1 and 2, a photoreceptor from which charge-transporting layer was delaminated was immersed in methanol to delaminate the charge-generating layer. The charge-generating layer delaminated from the photoreceptor was laminated on an invisible cover glass such that the thickness of the laminated charge-generating layers is sufficient for measurement, and then dried.

### 2 Apparatus and Conditions for Measurement

A diffractometer (RINT2000, Rigaku) for thin film samples using CuKα radiation that was monochromated and collimated with an artificial multilayer film mirror was used as the measurement apparatus. Diffraction pattern was measured under the following conditions: X-ray output: 50 kV, 250 mA, fixed incident angle (θ): 1.0°, scanning range (2θ): 3 to 40°, scanning step width: 0.05°, incident solar slit: 5.0°, incident slit: 0.1 mm, and receiving solar slit: 0.1°.

### [Measurement of Viscosity-average Molecular Weight]

The viscosity-average molecular weighs (Mv) of the binder resin (polycarbonate resin or polyarylate resin) contained in the charge-transporting layer described below in photoreceptor-producing example and comparative photoreceptor-producing example was measured by the following procedure.

The flow time (t) of a binder resin solution in dichloromethane (concentration: 6.00 g/L) at 20.0° C. was measured with an Ubbelohde capillary viscometer (a flow time t₀ of dichloromethane: 136.16 seconds). The viscosity-average molecular weight (Mv) of the binder resin was calculated by the following expressions:

ηsp=(t/t₀)−1

a=0.438×ηsp+1

b=100×(ηsp/C)

C=6.00 [g/L]

η=b/a

Mv=3207×η1.205 (sic)

### [Photoreceptor-producing Example]

### Charge-generating Material-producing Example 1

### (Preparation of CG1)

Sixty grams of α-type oxytitanium phthalocyanine was slowly added to 1.5 kg of concentrated sulfuric acid at 5° C. or less to prepare an oxytitanium phthalocyanine solution in concentrated sulfuric acid. The resulting oxytitanium phthalocyanine solution in concentrated sulfuric acid was placed into 15 kg of iced-water at 5° C. or less to precipitate oxytitanium phthalocyanine. The precipitated oxytitanium phthalocyanine was collected by filtration and thoroughly washed with water until the water used for the washing had a pH of neutral to give aqueous paste of oxytitanium phthalocyanine. The solid content of this aqueous paste was 12 mass %. One kilogram of n-octane was added to the aqueous paste, and the resulting texture was subjected to milling with glass beads having a diameter of 1 mm for 10 hours for crystal-form transformation to give oxytitanium phthalocyanine crystals for being used as the charge-generating material.

Photoreceptor-producing Example 1

Surface-treated titanium oxide was prepared by mixing rutile titanium oxide having an average primary particle diameter of 40 nm (“TTO55N” manufactured by Ishihara Sangyo Co., Ltd.) and methyldimethoxysilane (“TSL8117”, manufactured by Toshiba Silicone Co., Ltd.) in an amount of 3 mass % on the basis of the amount of the titanium oxide with a Henschel mixer. One kilogram of raw material slurry composed of a mixture of 50 parts of the surface-treated titanium oxide and 120 parts of methanol was subjected to dispersion treatment for 1 hour using zirconia beads with a diameter of about 100 μm (YTZ, manufactured by Nikkato Corp.) as a dispersion medium and an Ultra Apex Mill (model UAM-015, manufactured by Kotobuki Industries Co., Ltd.) having a mill capacity of about 0.15 L under liquid circulation conditions of a rotor peripheral velocity of 10 m/sec and a liquid flow rate of 10 kg/h to give a titanium oxide dispersion T1.

The titanium oxide dispersion, a solvent mixture of methanol/1-propanol/toluene, and a pelletized polyamide copolymer composed of ε-caprolactam [compound represented by the following Formula (A)]/bis(4-amino-3-methylcyclohexyl)methane [compound represented by the following Formula (B)]/hexamethylene diamine [compound represented by the following Formula (C)]/decamethylenedicarboxylic acid [compound represented by the following Formula (D)]/octadecamethylenedicarboxylic acid [compound represented by the following Formula (E)] at a molar ratio of 60%/15%/5%/15%/5% were mixed with agitation under heat to dissolve the pelletized polyamide. The resulting solution was subjected to ultrasonic dispersion treatment for 1 hour with an ultrasonic oscillator at an output of 1200 W and then filtered through a PTFE membrane filter with a pore size of 5 μm (Mitex LC, manufactured by Advantech Co., Ltd.) to give dispersion A1 for forming an undercoat layer wherein the weight ratio of the surface-treated titanium oxide/copolymerized polyamide was 3/1, the weight ratio of methanol/1-propanol/toluene in the solvent mixture was 7/1/2, and the solid content was 18.0 mass %.

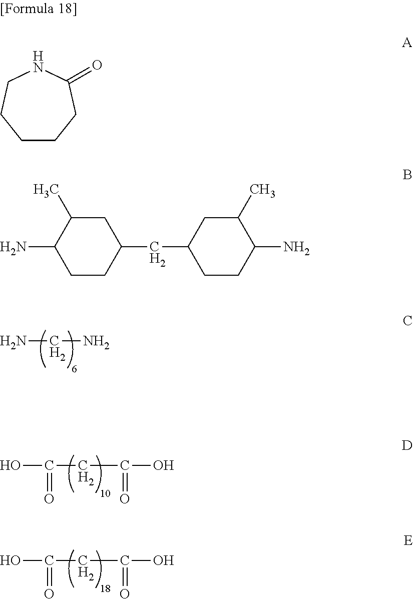

This dispersion A1 for forming an undercoat layer was applied to a non-anodized aluminum cylinder (external diameter: 30 mm, thickness: 1.0 mm, surface roughness Ra: 0.02 μm) by dipping, and the resulting coating was dried by heat to form an undercoat layer with a dried thickness of 1.5 μm.

Then, as a charge-generating material, 20 parts by weight of the oxytitanium phthalocyanine (CG1) obtained in charge-generating material-producing example 1 and 230 parts by weight of 1,2-dimethoxyethane were mixed with 800 parts by weight of glass beads having a diameter of 1 mm in a cylindrical stainless steel container with a radius of 10 cm and a height of 15 cm. The mixture was subjected to dispersion treatment for 1 hour with an agitation blade having three stainless steel disk agitation blades with a radius of 8.5 cm at a rotation speed of 1000 rpm to prepare oxytitanium phthalocyanine dispersion.

Then, the dispersion was mixed with 10 parts by weight of polyvinyl butyral (trade name “Denka Butyral” #6000C, manufactured by Denki Kagaku Kogyo K.K.), 437 parts by weight of 1,2-dimethoxyethane, and 85 parts by weight of 4-methoxy-4-methyl-2-pentanone to prepare a coating liquid for a charge-generating layer.

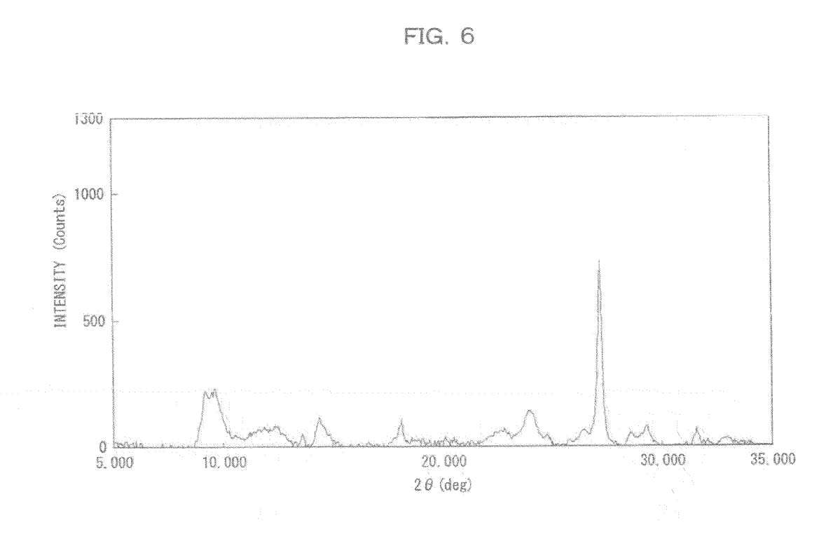

The resulting coating liquid for charge-generating layer was subjected to the measurement described in the “measurement process of CuKα characteristic X-rays (wavelength: 1.541 angstroms) of charge-generating layer” (sample preparation process (1)). As shown in FIG. 6, oxytitanium phthalocyanine contained in the coating liquid for charge-generating layer has main diffraction peaks at Bragg angles (2θ±0.2°) of 9.0° and 27.2° and at least one main diffraction peak in the range of 9.3° to 9.8° to CuKα character X-rays (wavelength: 1.541 angstroms). Therefore, the oxytitanium phthalocyanine actually contained in photoreceptor 1 will also have these diffraction peaks at the same Bragg angles.

Then, the coating liquid for charge-generating layer was applied to the “aluminum cylinder provided with an undercoat layer” by dipping to form a charge-generating layer having a dried thickness of about 0.3 μm (0.3 g/m²).

A coating liquid for forming a charge-transporting layer was prepared by mixing 50 parts by weight of a charge-transporting material represented by the following Formula (6), 100 parts by weight of a polycarbonate resin represented by the following Formula (7), 8 parts by weight of 3,5-di-t-butyl-4-hydroxytoluene, and 0.05 part by weight of silicone oil as a leveling agent in 640 parts by weight of a solvent mixture of tetrahydrofuran and toluene (80 mass % of tetrahydrofuran and 20 mass % of toluene).

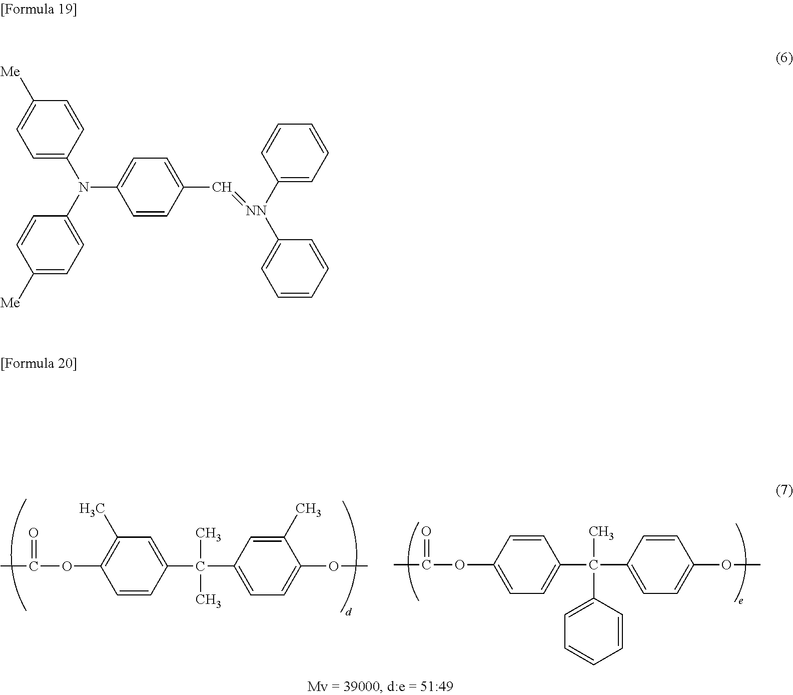

The coating liquid for forming a charge-transporting layer was applied to the cylinder provided with the charge-generating layer by dipping to form a charge-transporting layer having a dried thickness of 18 μm. The resulting photoreceptor drum was used as “photoreceptor 1”.

The photoreceptor 1 was cut into pieces with a size of 3 cm by 3 cm. A cut piece of the photoreceptor 1 was immersed in 4-methoxy-4-methyl-2-pentanone for 5 minutes. Then, the photoreceptor 1 was pulled out from the 4-methoxy-4-methyl-2-pentanone to delaminate the charge-transporting layer. Subsequently, the photoreceptor 1 from which the charge-transporting layer was delaminated was immersed in methanol and was pulled out from the methanol to delaminate the charge-generating layer. This process was repeated six times. The charge-generating layer delaminated from the photoreceptor 1 was uniformly disposed on an invisible cover glass and completely dried. Thereby, only the charge-generating layer wee separated from the photoreceptor 1.

The charge-generating layer delaminated from the photoreceptor 1 was subjected to the measurement described in the “measurement process of CuKα characteristic X-rays (wavelength: 1.541 angstroms) of charge-generating layer”. Oxytitanium phthalocyanine contained in the charge-generating layer had main diffraction peaks at Bragg angles (2θ±0.2°) of 9.0° and 27.2° and at lease one main diffraction peak in the range of 9.3° to 9.8° to CuKα characteristic X-rays (wavelength: 1.541 angstroms), as in the prepared coating liquid for charge-generating layer. Therefore, it was demonstrated that the crystal form of oxytitanium phthalocyanine contained in the coating liquid for charge-generating layer was identical to the crystal form of oxytitanium phthalocyanine contained in the charge-generating layer of the photoreceptor 1.

### Photoreceptor-producing Example 2

Fifty parts of titanium oxide powder containing 10 mass % antimonium oxide and coated with tin oxide, 25 parts of resol-type phenolic resin, 20 parts of methyl cellosolve, 5 parts of methanol, and 0.002 part of silicone oil (copolymer of polydimethylsiloxane and polyoxyalkylene, average molecular weight: 3000) were dispersed with a sand mill containing glass heads having a diameter of 1 mm for 2 hours to prepare a coating liquid for electroconductive layer. The coating liquid for electroconductive layer was applied to an aluminum cylinder (diameter: 30 mm) by dipping, and the coating was dried at 150° C. for 30 minutes to form an electroconductive layer having a thickness of 12.5 μm.

A solution prepared by dissolving 40.0 parts of polyamide used in photoreceptor-producing example 1 in a solvent mixture of 412 parts of methyl alcohol and 206 parts of n-butyl alcohol was applied to the cylinder by dipping, and the coating was dried at 100° C. for 10 minutes to form an interlayer having a thickness of 0.65 μm on the electroconductive layer.

Furthermore, the coating liquid for charge-generating layer used in photoreceptor-producing example 1 was applied to the aluminum cylinder provided with the interlayer by dipping to form a charge-generating layer having a dried thickness of about 0.3 μm (0.3 g/m²).

A coating liquid for forming a charge-transporting layer was prepared as in photoreceptor-producing example 1 except that 80 parts of a charge-transporting material represented by the following Formula (8) and 10 parts of a charge-transporting material represented by the following Formula (9) were used instead of the charge-transporting material used in the preparation of the coating liquid for charge-transporting layer in photoreceptor-producing example 1 and a polyacrylate resin represented by the following Formula (10) was used instead of the binder resin used in the preparation of the coating liquid for charge-transporting layer in photoreceptor-producing example 1.

The coating liquid for forming a charge-transporting layer was applied to the cylinder provided with the charge-generating layer by dipping to form a charge-transporting layer having a dried thickness of 18 μm. The resulting photoreceptor drum was used as “photoreceptor 2”.

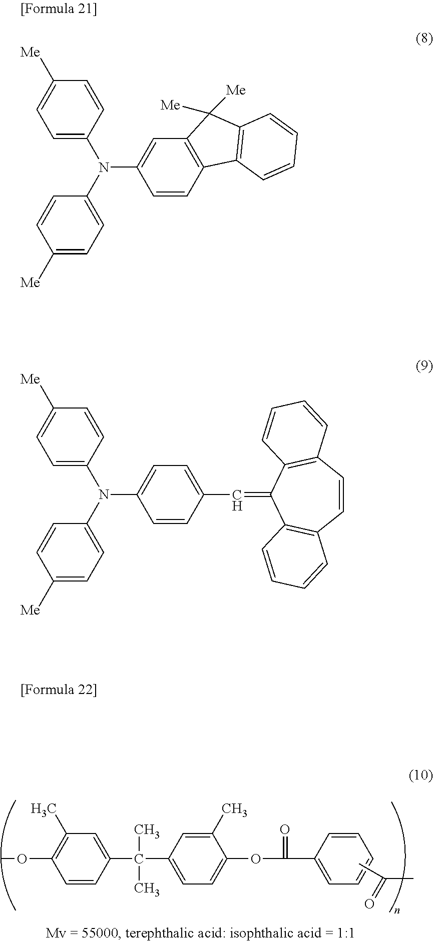

### Photoreceptor-producing Example 3

“Photoreceptor 3” was produced as in photoreceptor-producing example 2 except that a coating liquid for charge-transporting layer was prepared using 60 parts of a charge-transporting material represented by Formula (8) and 30 parts of a charge-transporting material represented by Formula (9) instead of the charge-transporting material used in the preparation of the coating liquid for charge-transporting layer in photoreceptor-producing example 2 and using a polycarbonate resin represented by the following Formula (11) instead of the binder resin.

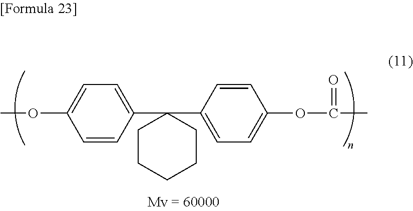

### Photoreceptor-producing Example 4

A polyethylene jar with a capacity of 500 mL (manufactured by As One Corp.) was charged with 5 parts by weight of oxytitanium phthalocyanine prepared in charge-generating material-producing example 1, 200 parts by weight of glass beads with a diameter of 1 mm, 192 parts by weight of 1,2-dimethoxyethane, 21 parts by weight of 4-methoxy-4-methyl-2-pentanone, and 2.5 parts by weight of polyvinyl butyral (trade name “Denka butyral” #6000C, manufactured by Denki Kagaku Kogyo K.K.). The polyethylene jar was shaken with a paint shaker (Toyo Seiki Co., Ltd.) for one hour for dispersion to prepare a coating liquid for charge-generating layer.

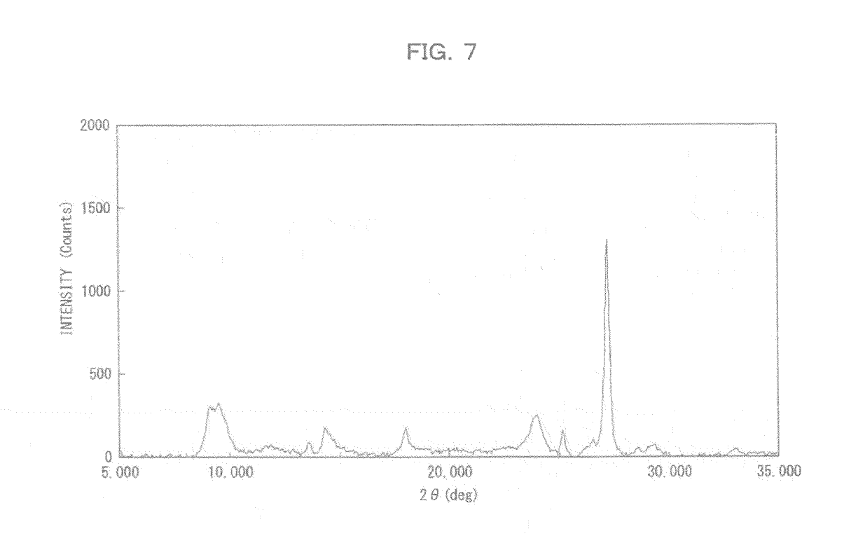

The resulting coating liquid for charge-generating layer was subjected to the measurement described in the “measurement process of CuKα characteristic X-rays (wavelength: 1.541 angstroms) of charge-generating layer” (Sample preparation process (1)). As a result, as shown in FIG. 7, it was confirmed that oxytitanium phthalocyanine contained in the coating liquid for charge-generating layer showed main diffraction peaks at Bragg angles (2θ±0.2°) of 9.0° and 27.2° and at least one main diffraction peak in the range of 9.3° to 9.8° to CuKα characteristic X-rays (wavelength: 1.541 angstroms). Therefore, the oxytitanium phthalocyanine actually contained in photoreceptor 4 should show diffraction peaks at the same Bragg angles as above.

“Photoreceptor 4” was produced as in photoreceptor-producing example 2 using the resulting coating liquid for charge-generating layer, the aluminum cylinder, and the coating liquid for charge-transporting layer used in the photoreceptor-producing example 2.

The photoreceptor 4 was cut into pieces with a size of 3 cm by 3 cm. A cut piece of the photoreceptor 4 was immersed in 4-methoxy-4-methyl-2-pentanone for 5 minutes. Then, the photoreceptor 5 (sic) was pulled out from the 4-methoxy-4-methyl-2-pentanone to delaminate the charge-transporting layer. Subsequently, the photoreceptor 1 (sic) from which the charge-transporting layer was delaminated was immersed in methanol and was pulled out from the methanol to delaminate the charge-generating layer. This process was repeated six times. The charge-generating layer delaminated from the photoreceptor 4 was uniformly disposed on an invisible cover glass and completely dried. Thereby, only the charge-generating layer was separated from the photoreceptor 4.

The separated charge-generating layer was subjected to the measurement described in the “measurement process of CuKα characteristic X-rays (wavelength: 1.541 angstroms) of charge-generating layer”. Oxytitanium phthalocyanine contained in the charge-generating layer had main diffraction peaks at Bragg angles (2θ±0.2°) of 9.0° and 27.2° and at least one main diffraction peak in the range of 9.3° to 9.8° to CuKα characteristic X-rays (wavelength: 1.541 angstroms), as in the coating liquid for charge-generating layer. Therefore, it was demonstrated that the crystal form of oxytitanium phthalocyanine contained in the coating liquid for charge-generating layer is identical to the crystal form of oxytitanium phthalocyanine contained in the charge-generating layer of the photoreceptor 4.

### Comparative Photoreceptor-producing Example 1

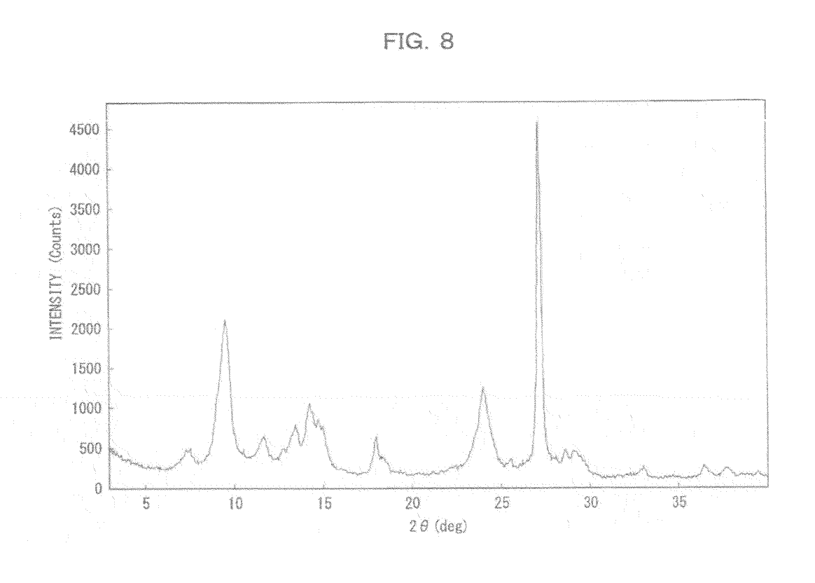

Comparative photoreceptor 1 was produced as in photoreceptor-producing example 1 except that, in the preparation of the coating liquid for charge-generating layer, oxytitanium phthalocyanine showing main diffraction peaks at Bragg angles of 9.6°, 24.1°, and 27.2° CuKα characteristic X-rays (wavelength: 1.541 angstroms) shown in FIG. 8 was used instead of the oxytitanium phthalocyanine used in the preparation of the coating liquid for charge-generating layer for photoreceptor 1.

The resulting coating liquid for charge-generating layer was subjected to the measurement described in the “measurement process of CuKα characteristic X-rays (wavelength: 1.541 angstroms) of charge-generating layer” (sample preparation process (1)). As a result, a diffraction pattern that is substantially the same as that shown in FIG. 8 was obtained. That is, it was confirmed that oxytitanium phthalocyanine contained in the coating liquid for charge-generating layer showed main diffraction peaks at Bragg angles (2θ±0.2°) of 9.6° and 27.2° to CuKα characteristic X-rays (wavelength: 1.541 angstroms), as in that before the dispersion treatment. Therefore, the oxytitanium phthalocyanine actually contained in comparative photoreceptor 1 will also have these diffraction peaks at the same Bragg angles.

The comparative photoreceptor 1 was cut into pieces with a size of 3 cm by 3 cm. A cut piece of the comparative photoreceptor 1 was immersed in 4-methoxy-4-methyl-2-pentanone for 5 minutes. Then, the comparative photoreceptor 1 was pulled out from the 4-methoxy-4-methyl-2-pentanone to delaminate the charge-transporting layer. Subsequently, the comparative photoreceptor 1 from which the charge-transporting layer was delaminated was immersed in methanol and was pulled out from the methanol to delaminate the charge-generating layer. This process was repeated six times. The charge-generating layer delaminated from the comparative photoreceptor 1 was uniformly disposed on an invisible cover glass and completely dried. Thereby, only the charge-generating layer was separated from the comparative photoreceptor 1.

The separated charge-generating layer was subjected to the measurement described in the “measurement process of CuKα characteristic X-rays (wavelength: 1.541 angstroms) of charge-generating layer”. Oxytitanium phthalocyanine contained in the charge-generating layer had main diffraction peaks at Bragg angles (2θ±0.2°) of 9.6° and 27.2° to CuKα characteristic X-rays (wavelength: 1.541 angstroms), as in the prepared coating liquid for charge-generating layer. Therefore, it was demonstrated that the crystal form of oxytitanium phthalocyanine contained in the coating liquid for charge-generating layer is identical to the crystal form of oxytitanium phthalocyanine contained in the charge-generating layer of the comparative photoreceptor 1.

### Comparative Photoreceptor-producing Example 2

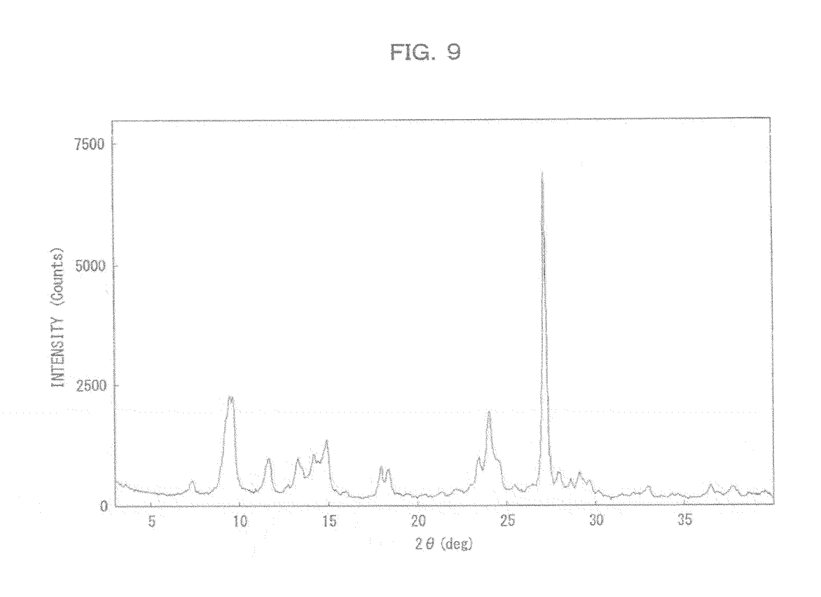

Comparative photoreceptor 2 was produced by the same procedure as in photoreceptor-producing example 2 except that, in the preparation of the coating liquid for charge-generating layer, oxytitanium phthalocyanine showing main diffraction peaks at Bragg angles of 9.5°, 9.7°, 24.1°, and 27.2° to CuKα characteristic X-rays (wavelength: 1.541 angstroms) demonstrated in FIG. 9 was used instead of the oxytitanium phthalocyanine used in the preparation of the coating liquid for charge-generating layer for photoreceptor 2.

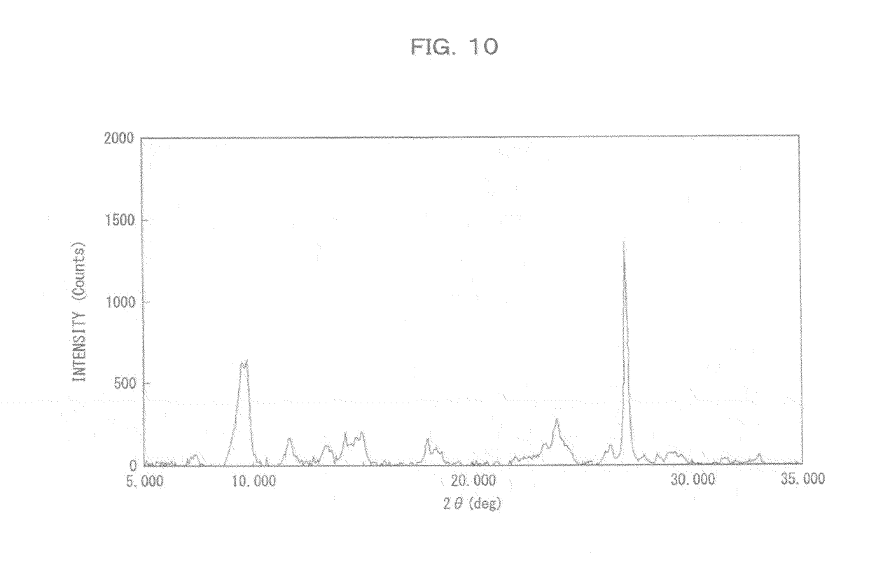

The resulting coating liquid for charge-generating layer was subjected to the measurement described an the “measurement process of CuKα characteristic X-rays (wavelength: 1.541 angstroms) of charge-generating layer” (sample preparation process (1)). As a result, as shown in FIG. 10, it was confirmed that oxytitanium phthalocyanine contained in the coating liquid tor charge-generating layer showed main diffraction peaks at Bragg angles (2θ±0.2°) of 9.5°, 9.7°, and 27.2° to CuKα characteristic X-rays (wavelength: 1.541 angstroms), as in that before the dispersion treatment. Therefore, the oxytitanium phthalocyanine actually contained in comparative photoreceptor 2 will have diffraction peaks at the same Bragg angles.

The comparative photoreceptor 2 was cut into pieces of 3 cm by 3 cm. A cut piece of the comparative photoreceptor 2 was immersed in 4-methoxy-4-methyl-2-pentanone for 5 minutes. Then, the comparative photoreceptor 2 was pulled out from the 4-methoxy-4-methyl-2-pentanone to delaminate the charge-transporting layer. Subsequently, the comparative photoreceptor 2 from which the charge-transporting layer was delaminated was immersed in methanol and was pulled out from the methanol to delaminate the charge-generating layer. This process was repeated six times. The charge-generating layer delaminated from the comparative photoreceptor 2 was uniformly disposed on an invisible cover glass and completely dried. Thereby, only the charge-generating layer was separated from the comparative photoreceptor 2.

The separated charge-generating layer was subjected to the measurement described in the “measurement process or CuKα characteristic X-rays (wavelength: 1.541 angstroms) of charge-generating layer”. Oxytitanium phthalocyanine contained in the charge-generating layer had main diffraction peaks at Bragg angles (2θ±0.2°) of 9.5°, 9.7°, and 27.2° to CuKα characteristic X-rays (wavelength: 1.541 angstroms), as in the prepared coating liquid for charge-generating layer. Therefore, it was demonstrated that the crystal form of oxytitanium phthalocyanine contained in the coating liquid for charge-generating layer is identical to the crystal form of oxytitanium phthalocyanine contained in the charge-generating layer of the comparative photoreceptor 2.

### Comparative Photoreceptor-producing Example 3

“Comparative photoreceptor 3” was produced as in photoreceptor-producing example 2 except that the coating liquid for charge-generating layer used in comparative photoreceptor-producing example 1 and the coating liquid for charge-transporting layer used in photoreceptor-producing example 3 were used.

### Examples 10 to 24 and Comparative Examples 5 to 14

### [Actual Printing Evaluation 3]

One of photoreceptors 1 to 4 and comparative photoreceptors 1 to 3 was mounted on a black drum cartridge, a black toner cartridge was loaded with a toner, and these cartridges being mounted to a commercially available tandem LED color printer, Microline Pro 9800PS-E (manufactured by Oki Data Corp.) compatible with size A3 printing, where the photoreceptor has an entire length of the aluminum cylinder that was modified so as to be adjusted to the printer. These cartridges were loaded in the printer. Since photoreceptors used were the same as the photoreceptors 1 to 4 and the comparative photoreceptors 1 to 3 except for the entire length of the aluminum cylinder, the photoreceptors are equally represented by photoreceptors 1 to 4 and comparative photoreceptors 1 to 3.

Specification of Microline Pro 9800PS-E:

Four-stage tandem, color: 36 ppm, monochrome: 40 ppm

600 to 1200 dpi

Contact-type roller charging (DC voltage applied)

Erase light provided

With this image-forming apparatus, a white image and a gradation image (test charts of The Imaging Society of Japan) were printed out after 1000 copies of a gradation image (test charts of The Imaging Society of Japan), and fog value of the white image and dot omission of the gradation image were evaluated. The results are shown in Table 4.

The “fog value” was determined by measuring the degree of whiteness of paper before the printing with a whiteness meter adjusted such that the degree of whiteness of a standard sample was 94.4, printing full-page white on the paper according to a signal input to the above-mentioned laser printer, and then measuring the degree of whiteness of this paper again to determine the difference in the degree of whitenesses between before and after the printing. A larger difference value represents that the paper after the printing has a large number of small black spots and is blackened, i.e., low image quality.

The gradation image was evaluated by determining which concentration standard is printed without dot omission. The lowest concentration standard printed without dot omission was defined as “responding concentration”. A smaller responding concentration represents better printing that allows lighter portions to be printed.

Thin-line reproducibility was evaluated after the evaluation of fogs and scattering at the completion of 1000 copies. A fixed image formed by exposure of a latent image with a line width of 0.20 mm was used as a sample to be measured. Since the thin-line image of the toner has unevenness in the width direction, the average line width was used as the line width. The thin-line reproducibility was evaluated by calculating the ratio (line width ratio) of a measured line width to a latent-image line width (0.20 mm).

The evaluation criteria of thin-line reproducibility are shown below.

The ratio (line width ratio) of a measured line width value to a latent-image line width is rated as follows:
A: less than 1.1,
B: 1.1 or more and less than 1.2,
C: 1.2 or more and less than 1.3, and
D: 1.3 or more.

TABLE 4

| | | | | | Thin-line |
|---|---|---|---|---|---|
| | | | Fog | Responding | repro- |
| No. | Toner | Photoreceptor | value | concentration | ducibility |
| Example 10 | A | photoreceptor 1 | 1.3 | 0.09 | B |
| Example 11 | A | photoreceptor 2 | 1.2 | 0.08 | A |
| Example 12 | A | photoreceptor 3 | 1.2 | 0.08 | A |
| Example 13 | A | photoreceptor 4 | 1.3 | 0.08 | A |
| Comparative | A | comparative | 1.7 | 0.14 | D |
| Example 6 | | photoreceptor 1 | | | |
| Comparative | A | comparative | 1.8 | 0.13 | D |
| Example 7 | | photoreceptor 2 | | | |
| Comparative | A | comparative | 1.8 | 0.14 | D |
| Example 8 | | photoreceptor 3 | | | |
| Example 14 | B | photoreceptor 1 | 1.1 | 0.11 | B |
| Example 15 | B | photoreceptor 2 | 1.2 | 0.08 | B |
| Example 16 | B | photoreceptor 3 | 1.3 | 0.10 | A |
| Example 17 | B | photoreceptor 4 | 1.2 | 0.09 | B |
| Example 18 | C | photoreceptor 2 | 1.1 | 0.08 | B |
| Example 19 | D | photoreceptor 1 | 1.2 | 0.08 | C |
| Example 20 | D | photoreceptor 2 | 1.2 | 0.09 | B |
| Example 21 | D | photoreceptor 3 | 1.3 | 0.08 | B |
| Example 22 | D | photoreceptor 4 | 1.1 | 0.09 | B |
| Example 23 | E | photoreceptor 2 | 1.3 | 0.08 | A |
| Example 24 | F | photoreceptor 3 | 1.3 | 0.10 | A |
| Comparative | G | photoreceptor 1 | 1.9 | 0.16 | D |
| Example 9 | | | | | |
| Comparative | G | photoreceptor 1 | 2.0 | 0.15 | D |
| Example 10 | | | | | |
| Comparative | G | photoreceptor 2 | 1.8 | 0.16 | D |
| Example 11 | | | | | |
| Comparative | G | photoreceptor 3 | 1.9 | 0.15 | D |
| Example 12 | | | | | |
| Comparative | G | photoreceptor 4 | 1.8 | 0.16 | D |
| Example 13 | | | | | |
| Comparative | G | comparative | 2.1 | 0.17 | D |
| Example 14 | | photoreceptor 1 | | | |

### Example 25, Comparative Example 15

### [Actual Printing Evaluation 4]

Photoreceptor 1 was mounted on a black drum cartridge, and a black toner cartridge was loaded with toner A or G prepared in Toner Production Example or Toner Production Comparative Example. These cartridges were mounted to a commercially available tandem LED color printer, Microline Pro 9800PS-E (manufactured by Oki Data Corp.) compatible with size A3 printing. The cartridges were loaded in the printer. The cleaning blade of the printer was removed, and the image was evaluated as in actual printing evaluation 3. The results of toner A were similar to those in actual printing evaluation 3, but the use of toner G caused significant image defects.

TABLE 5

| | | | | Responding |
|---|---|---|---|---|
| No. | Toner | Photoreceptor | Fog value | concentration |
| Example 25 | A | photoreceptor 1 | 1.3 | 0.08 |
| Comparative | G | photoreceptor 1 | 1.9 | 0.16 |
| Example 15 | | | | |

### [Actual Printing Evaluation 5]

A cartridge of a machine of 600 dpi having a guaranteed service life of 30000 sheets at a printing ratio of 5% was loaded with toner A, and a chart of a printing ratio of 1% was printed continuously on 50 sheets with a nonmagnetic single component (using photoreceptor 1) and rubber roller-contacting development system at a process speed (development speed) of 164 mm/sec using a belt transfer system. No smear was observed by visual investigation.

As obvious from the above results, all toners A to F that satisfy all the requirements of the present invention exhibit sufficiently small standard deviations of charge density and significantly narrow charge density distributions. In addition, no smear or acceptable slight smears were observed in actual printing evaluation for an electrophotographic photoreceptor having an interlayer. The “selective development” was also suppressed.

In contrast, toner G, which does not satisfy the requirements of the present invention, exhibits a large standard deviation of charge density and a broad charge density distribution. In addition, the “selective development” was observed. Furthermore, the actual printing evaluation by applying the toner to the image-forming apparatus of the present invention confirmed (sic) synergistic effect.

### [Actual Printing Evaluation 6]

The exposure unit of Microline Pro 9800PS-E (manufactured by Oki Data Corp.) compatible with size A3 printing was modified so that the photoreceptor was able to be illuminated with light from a compact size spot-illumination blue LED (B3MP-8: 470 nm) manufactured by Nissin Electronic Co., Ltd. Photoreceptor 1 or photoreceptor 2 was mounted on this modified apparatus loaded with Toner C, and lines were printed. All line images were satisfactory. The compact site spot-illumination type blue LED was connected to a stroboscopic light power source LPS-203KS, and dots were printed. Dot images with a diameter of 8 mm were formed in all cases.

### [Actual Printing Evaluation 7]

Photoreceptor 2 was mounted in the modified machine of HP-4600 manufactured by Hewlett-Packard, and toner B was used as the developer. The printed image was satisfactory.

### [Actual Printing Evaluation 8]

A cartridge of a machine of 600 dpi having a guaranteed service life of 30000 sheets at a printing ratio of 5 % was loaded with a toner prepared by suspension polymerization having an average sphericity of 0.990, and a chart of a printing ratio of 1% was printed continuously on 60 sheets with a nonmagnetic single component (using photoreceptor 1) and rubber roller-contacting development system at a development speed of 164 mm/sec using a belt transfer system. A large number of image defects caused by, for example, fogs were visually observed.

In actual printing evaluations 1 to 8 using various machines under various actual printing conditions, every combination of a toner exhibiting a specific particle size distribution and a photoreceptor having a specific photosensitive layer of the present invention showed satisfactory actual printing properties due to the synergistic effect. On the other hand, in a combination wherein either of the toner or photoreceptor does not satisfy the requirements of the present invention, the actual printing properties were unsatisfactory.

### [Photoreceptor 5]

The mirror finished surface of an aluminum cylinder having an external diameter of 30 mm, a length of 375.8 mm, and a thickness of 0.75 was anodized, and pore sealing treatment was carried out with a sealer containing nickel acetate as a main component. Thus, an anodization coating (alumite coating) of about 6 μm was formed. This cylinder was used as an electroconductive support. The dispersion for forming a charge-generating layer used in photoreceptor-producing example 1 was applied so the cylinder by dipping to form a charge-generating layer with a dried thickness of about 0.4 μm.

Then, a coating liquid for forming a charge-transporting layer was prepared by mixing 60 parts by weight of charge-transporting material represented by the following Formula [1], 30 parts by weight of charge-transporting material represented by the following Formula [2], 100 parts by weight of polycarbonate resin represented by the following Formula [3], 8 parts by weight of 3,5-di-t-butyl-4-hydroxytoluene as an antioxidant, and 0.05 part by weight of silicone oil as a leveling agent with 640 parts by weight of a solvent mixture of tetrahydrofuran and toluene (80 wt % of tetrahydrofuran and 20 wt % of toluene).

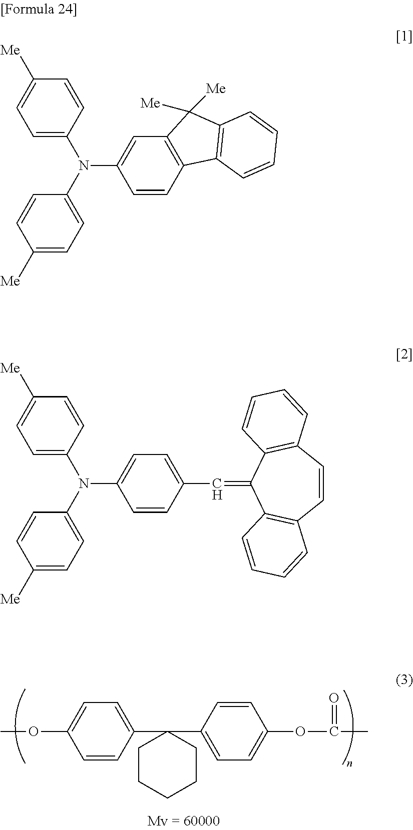

This coating liquid for forming a charge-transporting layer was applied to the cylinder provided with the charge-generating layer by dipping to form a charge-transporting layer with a dried thickness of 18 μm. The resulting photoreceptor drum was used as photoreceptor 5.

The charge-generating layer of the photoreceptor 5 was separated as in photoreceptor-producing example 1. The separated charge-generating layer was subjected to the measurement described in “2. apparatus and conditions for measurement” of “measurement process of diffraction pattern by CuKα characteristic X-rays”, and it was confirmed that oxytitanium phthalocyanine contained in the charge-generating layer showed diffraction peaks at Bragg angles (2θ±0.2°) of 9.0°, 27.2°, and at least in the range of 9.3° to 9.8° to CuKα characteristic X-rays (wavelength: 1.541 angstroms). These results are the same as those of diffraction pattern by CuKα characteristic X-rays of the coating liquid for charge-generating layer prepared above, and no difference was found between oxytitanium phthalocyanine in the charge-generating layer separated from photoreceptor 5 and oxytitanium phthalocyanine contained in the coating liquid for charge-generating layer.

### [Photoreceptor 6]

Photoreceptor 6 was produced as in photoreceptor 5 except that the coating liquid for charge-transporting layer was prepared using 80 parts of the charge-transporting material represented by Formula [1], 10 parts of the charge-transporting material represented by Formula [2], and a polyarylate resin represented by the following Formula [4] instead of the polycarbonate resin represented by Formula [3] as the binder resin.

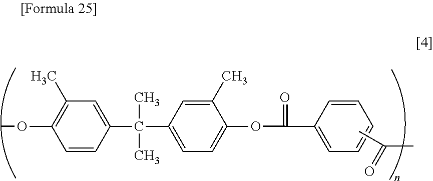

Mv=55000 terephthalic acid: isophthalic acid=1:1

### [Photoreceptor 7]

Photoreceptor 7 was produced as in photoreceptor 5 except that the coating liquid for charge-transporting layer was prepared using 80 parts of a charge-transporting material represented by Formula [5] instead of the charge-transporting materials used for photoreceptor 5 and a polycarbonate resin represented by the following Formula [6] instead of the polycarbonate resin represented by Formula [3] as the binder resin.

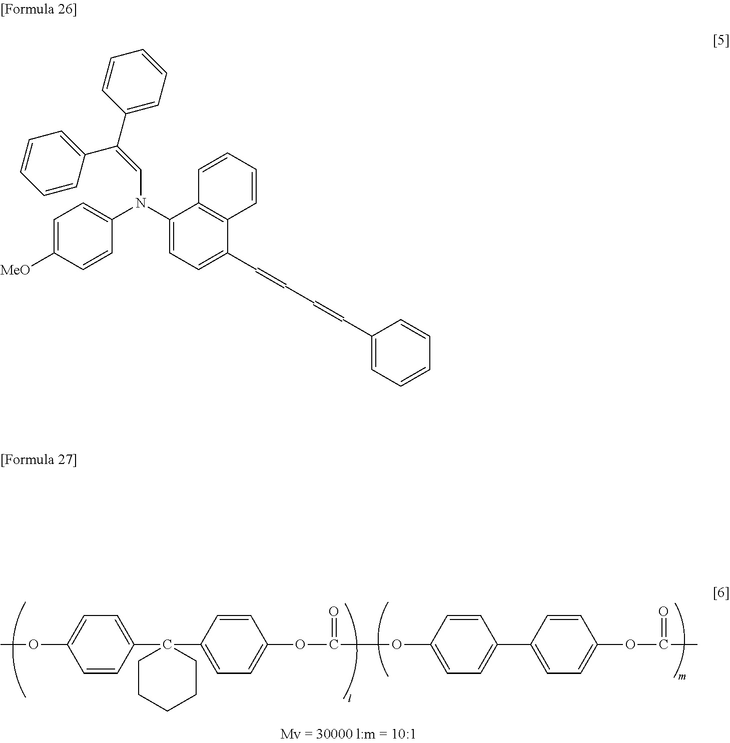

### [Photoreceptor 8]

Photoreceptor 8 was produced as in photoreceptor 5 except that the coating liquid for charge-transporting layer was prepared using 50 parts of a charge-transporting material represented by the following Formula [7] instead of the charge-transporting materials used for photoreceptor 5 and a polycarbonate resin represented by the following Formula [8] instead of the polycarbonate resin represented by Formula [3] as the binder resin.

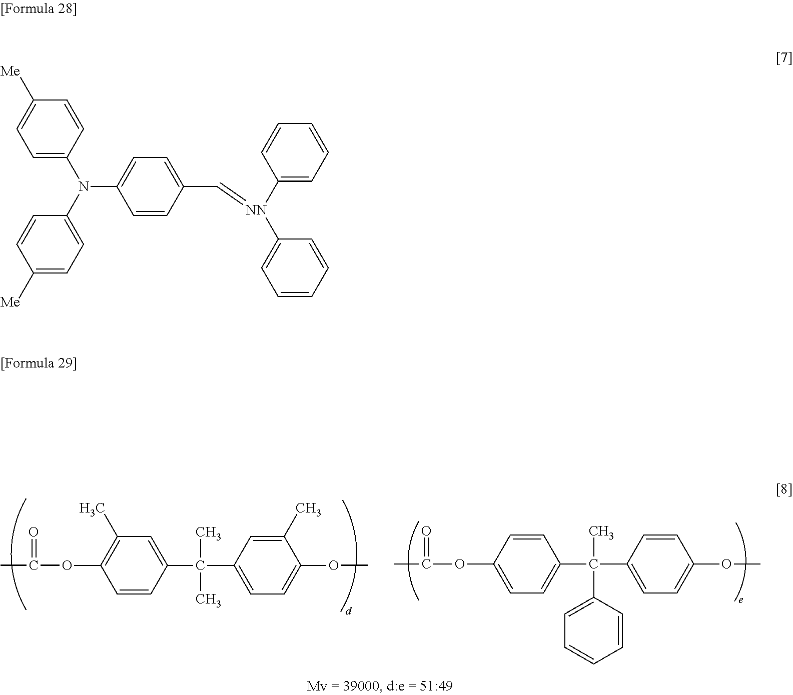

### [Photoreceptor 9]

Photoreceptor 9 was produced as in photoreceptor 5 except that the coating liquid for charge-generating layer used in photoreceptor-producing example 4 was used.

The charge-generating layer of the photoreceptor 9 was separated as in photoreceptor-producing example 4. The separated charge-generating layer was subjected to the measurement described in “2. apparatus and conditions for measurement” of “measurement process of diffraction pattern by CuKα characteristic X-rays”. Oxytitanium phthalocyanine contained in the charge-generating layer showed diffraction peaks at Bragg angles (2θ±0.2°) of 9.0°, 27.2°, and at least in the range of 9.3° to 9.8° to CuKα characteristic X-rays (wavelength: 1.541 angstroms). These results are the same as those of diffraction pattern by CuKα characteristic X-rays of the coating liquid for charge-generating layer prepared above, and no difference was found between oxytitanium phthalocyanine in the charge-generating layer separated from photoreceptor and oxytitanium phthalocyanine contained in the coating liquid for charge-generating layer.

### [Comparative Photoreceptor 4]

Comparative photoreceptor 4 was produced as in photoreceptor 5 except that the coating liquid for charge-generating layer used in comparative photoreceptor-producing example 1 was used.

The charge-generating layer of the comparative photoreceptor 4 was separated as in comparative photoreceptor-producing example 1. The separated charge-generating layer was subjected to the measurement described in “2. apparatus and conditions for measurement” of “measurement process of diffraction pattern by CuKα characteristic X-rays”. Oxytitanium phthalocyanine that was contained in the charge-generating layer showed main diffraction peaks at Bragg angles (2θ±0.2°) of 9.6° and 27.2° to CuKα characteristic X-rays (wavelength: 1.541 angstroms). These results are the same as those of diffraction pattern by CuKα characteristic X-rays of the coating liquid for charge-generating layer prepared above, and no difference was observed between oxytitanium phthalocyanine in the charge-generating layer separated from photoreceptor and oxytitanium phthalocyanine contained in the coating liquid for charge-generating layer.

### [Comparative Photoreceptor 5]

Comparative photoreceptor 5 was produced as in photoreceptor 5 except that the coating liquid for charge-generating layer used in comparative photoreceptor-producing example 2 was used.

The charge-generating layer of the comparative photoreceptor 5 was separated as in comparative photoreceptor-producing example 2. The separated charge-generating layer was subjected to the measurement described in “2. apparatus and conditions for measurement” of “measurement process of diffraction pattern by CuKα characteristic X-rays”, and oxytitanium phthalocyanine contained in the charge-generating layer showed main diffraction peaks at Bragg angles (2θ±0.2°) of 9.5°, 9.7°, 24.1° C., and 27.2° to CuKα characteristic X-rays (wavelength: 1,541 angstroms). These results are the same as those of diffraction pattern by CuKα characteristic X-rays of the coating liquid for charge-generating layer prepared above, and no difference was observed between oxytitanium phthalocyanine in the charge-generating layer separated from photoreceptor and oxytitanium phthalocyanine contained in the coating liquid for charge-generating layer.

### [Comparative Photoreceptor 6]

Comparative photoreceptor 6 was produced as in photoreceptor 5 except that the coating liquid used in comparative photoreceptor 4 was used as the coating liquid for charge-generating layer, and the coating liquid used in photoreceptor 6 was used as the coating liquid for charge-transporting layer.

### [Comparative Photoreceptor 7]

Comparative photoreceptor 7 was produced as in photoreceptor 5 except that the coating liquid used in comparative photoreceptor 4 was used as the coating liquid for charge-generating layer, and the coating liquid used in photoreceptor 7 was used as the coating liquid for charge-transporting layer.

### [Comparative Photoreceptor 8]

Comparative photoreceptor 8 was produced as in photoreceptor 5 except that the coating liquid used in comparative photoreceptor 4 was used as the coating liquid for charge-generating layer, and the coating liquid used in photoreceptor 8 was used as the coating liquid for charge-transporting layer.

### [Comparative Photoreceptor 9]

Comparative photoreceptor 9 was produced as in photoreceptor 5 except that the coating liquid used in comparative photoreceptor 5 was used as the coating liquid for charge-generating layer, and the coating liquid used in photoreceptor 6 was used as the coating liquid for charge-transporting layer.

### [Comparative Photoreceptor 10]

Comparative photoreceptor 10 was produced as in photoreceptor 5 except that the coating liquid used in comparative photoreceptor 5 was used as the coating liquid tor charge-generating layer, and the coating liquid used in photoreceptor 7 was used as the coating liquid for charge-transporting layer.

### [Comparative Photoreceptor 11]

Comparative photoreceptor 11 was produced as in photoreceptor 5 except that the coating liquid used in comparative photoreceptor 5 was used as the coating liquid for charge-generating layer, and the coating liquid used in photoreceptor 8 was used as the coating liquid for charge-transporting layer.

### [Comparative Photoreceptor 12]

A photoreceptor drum was produced as in photoreceptor 5 except that an aluminum cylinder having an external diameter of 30 mm, a length of 351 mm, and a thickness of 1.0 mm was used. The resulting photoreceptor drum was used as comparative photoreceptor 12.

### [Comparative Photoreceptor 13]

A comparative photoreceptor 13 was produced as in comparative photoreceptor 4 except that an aluminum cylinder having an external diameter of 30 mm, a length of 351 mm, and a thickness of 1.0 mm was used.

### [Preparation of Toner]

### [Development Toner-producing Example 10]

Preparation of Wax/long-chain Polymerizable Monomer Dispersion T1

Twenty seven parts (540 g) of paraffin wax (HNP-9, manufactured by Nippon Seiro Co., Ltd., surface tension: 23.5 mN/m, melting point: 82° C., heat of fusion: 220 J/g, half width of fusion curve: 8.2° C., half width of crystallization curve: 13.0° C.), 2.8 parts of stearyl acrylate (manufactured by TOKYO CHEMICAL INDUSTRY CO., LTD.), 1.9 parts of an aqueous 20 wt % sodium dodecylbenzenesulfonate solution (Neogen S20A, manufactured by DAI-ICHI KOGYO SEIYAKU CO., LTD., hereinafter, abbreviated to “aqueous 20% DBS solution”), and 68.3 parts of desalted water were heated to 90° C. and were agitated with a homomixer (model: Mark II f, manufactured by Tokusyu Kida Kogyo Co., Ltd.) at a rotation speed of 8000 rpm for 10 minutes.

Then, the resulting dispersion was heated to 90° C., and was circulation-emulsified in a homogenizer (model: 15-M-8PA, manufactured by Gaulin) under a pressure of about 25 MPa. While the volume-average particle diameter was measured with UPA-EX, the dispersion was continued to give a volume-average particle diameter of 250 nm to prepare a wax/long-chain polymerizable monomer dispersion T1 (solid content of the emulsion=30.2 wt %).

Preparation of Silicone Wax Dispersion T2

Twenty seven parts (540 g) of an alkyl-modified silicone wax (melting point: 72° C.), 1.9 parts of an aqueous 20% DBS solution, and 71.1 parts of desalted water were placed in a 3-L stainless steel container and were heated to 90° C. and agitated with a homomixer (model: Mark II f, manufactured by Tokusyu Kika Kogyo Co., Ltd.) at a rotation speed of 8000 rpm for 10 minutes.

Then, the resulting dispersion was heated to 99° C., and as circulation-emulsified in a homogenizer (model: 15-M-8PA, manufactured by Gaulin) under a pressure of about 45 MPa. While the volume-average particle diameter was measured with UPA-EX, dispersion was continued to give a volume-average particle diameter of 240 nm to prepare a silicone wax dispersion T2 (solid content of the emulsion=27.4 wt %).

Preparation of Polymer Primary Particle Dispersion T1

A reactor (internal capacity: 21 L, external diameter: 250 mm, height: 420 mm) equipped with an agitator (three blades), a heater/cooler, a concentrator, and a device for charging various raw materials and additives was charged with 35.6 parts by weight (712.12 g) of wax/long-chain polymerizable monomer dispersion T1 and 259 parts of desalted water, which were then heated to 90° C. under a nitrogen stream at a rotation speed of 103 rpm.

Then, a mixture of the following polymerizable monomers and aqueous emulsifier solution was added over a period of 5 hours from the initiation of the polymerization. The starting time of the dropwise addition of the mixture of the monomers and the aqueous emulsifier solution was defined as the initiation of the polymerization. The following aqueous initiator solution was added over a period of 4.5 hours from the time 30 minutes after the initiation of the polymerization, and then the following aqueous additional initiator solution was added over 2 hours from the time 5 hours after the initiation of the polymerization. The polymerization was continued at an internal temperature of 90° C. for further 1 hour with agitation at a rotation speed of 103 rpm.

### [Monomers]

Styrene: 76.8 parts (1535.0 g)

Butyl acrylate: 23.2 parts

Acrylic acid: 1.5 parts

Trichlorobromomethane: 1.0 part

Hexanediol diacrylate: 0.7 part

### [Aqueous Emulsifier Solution ]

Aqueous 20% DBS solution: 1.0 part

Desalted water: 67.1 parts

### [Aqueous Initiator Solution]

Aqueous 8% hydrogen peroxide solution: 15.5 parts

Aqueous 8% L(+)-ascorbic acid solution: 15.5 parts

### [Aqueous Additional Initiator Solution]

Aqueous 8% L(+)-ascorbic acid solution: 14.2 parts

After the polymerization reaction, the reaction system was cooled to give a milky white polymer primary particle dispersion T1. The volume-average particle diameter measured with UPA-EX was 280 nm, and the solid content was 21.1 wt %.

Preparation of Polymer Primary Particle Dispersion T2

A reactor (internal capacity: 21 L, internal diameter: 250 mm, height: 420 mm) equipped with an agitator (three blades), a heater/cooler, a concentrator, and a device for charging various raw materials and additives was charged with 23.6 parts by weight (472.3 g) of silicone wax dispersion T2, 1.5 parts by weight of an aqueous 20% DBS solution, and 324 parts of desalted water, which were then heated to 90° C. under a nitrogen stream, and 3.2 parts of an aqueous 8% hydrogen peroxide solution and 3.2 parts of an aqueous 8% L(+)-ascorbic acid solution were simultaneously added with agitation at 103 rpm.

Five minutes after the simultaneous addition, a mixture of the following monomers and an aqueous emulsifier solution was added over a period of 5 hours from the initiation of the polymerization (the time 5 minutes after the simultaneous addition of 3.2 parts of the aqueous 8% hydrogen peroxide solution and 3.2 parts of the aqueous 8% L(+)-ascorbic acid solution). Furthermore, the following aqueous initiator solution was added over a period of 6 hours from the initiation of the polymerization, and the polymerization was continued at an internal temperature of 90° C. for further 1 hour with agitation at a rotation speed of 103 rpm.

### [Monomers]

Styrene: 92.5 parts (1850.0 g)

Butyl acrylate: 7.5 parts

Acrylic acid: 1.5 parts

Trichlorobromomethane: 0.6 part

### [Aqueous Emulsifier Solution]

Aqueous 20% DBS solution: 1.5 parts

Desalted water: 66.2 parts

### [Aqueous Initiator Solution]

Aqueous 8% hydrogen peroxide solution: 18.9 parts

Aqueous 8% L(+)-ascorbic acid solution: 18.9 parts

After completion of the polymerization reaction, the reaction system was cooled to give a milky white polymer primary particle dispersion T2. The volume-average particle diameter measured with UPS-EX was 290 nm, and the solid content was 19.0 wt %.

Preparation of Colorant Dispersion T

A container having an internal capacity of 300 L and equipped with an agitator (propeller blade) was charged with 20 parts (40 kg) of carbon black (Mitsubishi Carbon Black MA100S, manufactured by Mitsubishi Chemical Corp.) that was prepared by a furnace process and had an ultraviolet absorption of 0.02 in a toluene extract and a true density of 1.8 g/cm³, 1 part of an aqueous 20% DBS solution, 4 parts of a nonionic surfactant (Emargen 120, manufactured by Kao Corp.), and 75 parts of deionized water having an electric conductivity of 2 μS/cm for predispersion to give a pigment premix solution. The electric conductivity was measured with a conductometer (Personal SC meter model SC72 with a detector SC72SN-11, manufactured by Yokogawa Corp.).

The 50% volume cumulative diameter Dv50 of the carbon black in the dispersion after the premix treatment was about 90 μm. The premix solution was supplied to a wet bead mill as raw material slurry for one-path dispersion. The stator had an internal diameter of 75 mm, the separator had a diameter of 60 mm, and the distance between the separator and the disk was 15 mm. The medium for dispersion was zirconia beads (true density: 6.0 g/cm³) with a diameter of 50 μm. Since the stator having an effective internal capacity of 0.5 L was filled with 0.35 L of the medium, the filling rate of the medium was 70%. The rotation speed of the rotor was maintained constant (the peripheral velocity at the rotor end: about 11 m/sec), and the premix slurry was continuously supplied to one mill at a supply rate of about 50 L/hr from a supply port with a non-pulsing metering pump and was continuously discharged from a discharging port to give a black colorant dispersion T. The volume-average particle diameter measured with UPA-EX was 150 nm, and the solid content was 24.2 wt %.

Preparation of Mother Particles T for Development

Polymer primary particle dispersion T1: 95 parts as solid components (998.2 g as solid components),

Polymer primary particle dispersion T2: 5 parts as solid components,

Colorant microparticle dispersion T: 6 parts as colorant solid components, and

Aqueous 20% DBS solution: 0.1 part as solid components.

Toner was produced using the above components by the following steps:

A mixer (capacity: 12 L, internal diameter: 208 mm, height: 355 mm) equipped with an agitator (double helical blade), a heater/cooler, a concentrator, and a device for charging various raw materials and additives was charged with the polymer primary particle dispersion T1 and the aqueous 20% DBS solution which were then mixed at 40 rpm for 5 minutes into a homogeneous mixture at an internal temperature of 12° C. Subsequently, the rotation speed was increased to 250 rpm, and an aqueous 5% ferrous sulfate solution (0.52 part as FeSo₄.7H₂O) was added to the mixture over 5 minutes at an internal temperature of 12° C., and then the colorant microparticle dispersion T was added thereto over 5 minutes. The resulting mixture was continuously mixed at an internal temperature of 12° C. at 250 rpm into a homogeneous mixture, and an aqueous 0.5% aluminum sulfate solution (0.10 part of solid components on the basis of the resin solid components) was dropwise added thereto under the same conditions. Then, the internal temperature was increased to 53° C. over 75 minutes at 250 rpm and then to 56° C. over 170 minutes.

The particle diameter was measured with a precise particle size distribution measuring device (Multisizer III, manufactured by Beckman Coulter Inc.; hereinafter, optionally, abbreviated to “Multisizer”) with a 100 μm aperture diameter. The 50% volume diameter was 6.7 μm.

Then, at 250 rpm, the polymer primary particle dispersion T2 was added thereto over 3 minutes. The resulting mixture was continuously agitated under the same conditions for 60 minutes. The rotation speed was decreased to 168 rpm, and immediately after reduction of the rotation speed, the aqueous 20% DBS solution (6 parts as solid components) was added thereto over 10 minutes. The resulting mixture was heated to 90° C. at 168 rpm over 30 minutes and was maintained at this temperature for 60 minutes.

Then, the mixture was cooled to 30° C. over 20 minutes, and the resulting slurry was extracted and was filtered by suction with an aspirator through a filter paper No. 5C (manufactured by Toyo Roshi Co., Ltd.). The cake remaining on the filter paper was transferred to a stainless steel container having an internal capacity of 10 L (liter) and equipped with an agitator (propeller blade), and 8 kg of deionized water with an electric conductivity of 1 μS/cm was added thereto. The resulting mixture was agitated at 50 rpm into a homogeneous dispersion and was continuously agitated for further 30 minutes.

Then, the mixture was filtered by suction with an aspirator through a filter paper No. 5C (manufactured by Toyo Roshi Co., Ltd.) again. The solid remaining on the filter paper was transferred to a container having an internal capacity of 10 L, equipped with an agitator (propeller blade), and containing 8 kg of deionized water having an electric conductivity of 1 μS/cm, and the resulting mixture was agitated at 50 rpm for 30 minutes into a homogeneous dispersion. This process was repeated five times to give a filtrate having an electric conductivity of 2 μS/cm. The electric conductivity was measured with a conductometer (Personal SC meter model SC72 with a detector SC72SN-11, manufactured by Yokogawa. Corp.).

The resulting cake was bedded in a stainless steel vat so as to have a thickness of about 20 mm and was dried in a fan dryer set at 40° C. for 48 hours to give mother particles T for development.

Preparation of Toner TA for Development

One hundred parts (1000 g) of the mother particles T for development were charged in a Henschel mixer having an internal capacity of 10 L (diameter: 230 mm, height: 240 mm) and equipped with an agitator (Z/A0 blade) and a deflector arranged at the upper portion so as to be perpendicular to the wall, and then 0.5 part of silica microparticles hydrophobed with a silicone oil and having a volume average primary particle diameter of 0.04 μm, 2.0 parts of silica microparticles hydrophobed with a silicone oil and having a volume average primary particle diameter of 0.012 μm were added thereto. The resulting mixture was agitated at 3000 rpm for 10 minutes and was then passed through a 150-mesh sieve to give toner TA for development. The toner TA had a volume-average particle diameter of 7.05 μm measured with Multisizer II, a Dv/Dn of 1.14, and an average sphericity of 0.963 measured with FPIA-2000.

### [Development Toner-producing Example 11]

Toner TB for development was produced as in “Development toner-producing example 10” except that the conditions after the addition of the aqueous DBS solution for preparing mother particles TA for development were “maintaining the mixture at 90° C. for 180 minutes” instead of “maintaining the mixture at 90° C. for 60 minutes”. The average sphericity measured with FPIA-2000 was 0.981.

### Example 26

The photoreceptor 5 produced in above was mounted on a black drum cartridge of Microline Pro 9800PS-E (modified) manufactured by Oki Data Corp., and the cartridge was loaded in the printer. The specifications of the Microline Pro 9800PS-E (modified) were as follows. The “ppm” in the following specifications means the number of sheets printed per minute.

Printing system: four-stage tandem

Number of printing sheets: 36 ppm (color), 40 ppm (monochrome)

Number of pixels: 1200 dpi

Charging system: contact-type roller charging

Exposure System: LED exposure

Erase light: none

The toner produced in “Development toner-producing example 10” having an average sphericity of 0.963, a volume-average particle diameter of 7.05 μm, and a Dv/Dn of 1.14 or the toner produced in “Development toner-producing example 11” having an average sphericity of 0.981 was used.

A pattern having a boldface character in white on the upper area and a halftone portion from the central area to the lower area of an A3 region was sent as an input of printing data from a personal computer to the printer. The resulting output image was visually evaluated.

Since the charge elimination step is null in the printer used for the evaluation, the character in the upper area of the pattern may be memorized on the photoreceptor and adversely affect the usage formation in the next rotation, depending on the performance of a photoreceptor. That is, the character may appear in the halftone portion as an image memory (memory phenomenon). The degree of appearance of the memory image in an area that should be essentially even was classified into five ranks. Here, rank 1 denotes the most satisfactory result (i.e., a low degree of memory phenomenon), and a higher number of the rank to rank 5 denotes a higher degree of memory phenomenon.

This evaluation was conducted in usual environment (25° C./50% RH) and in low-temperature/low-humidity environment (5° C./10% RH).

In addition, fog values were measured with the modified machine. The fog values were determined by measuring the degree of whiteness of paper (A4) before the printing with a colorimetric color-difference meter (ND-1001DP model), Nippon Denshoku Co., Ltd.) adjusted such that the degree of whiteness of a standard white plate was 94.4. After the measurement of the degree of whiteness of paper before the printing, full-page white was printed on the paper according to signal input to the laser printer under the usual environment (25° C./50% RH), and then the degree of whiteness of this paper was measured. The difference in the degree of whitenesses between before and after the printing was calculated based on the following equation (1):

Fog value=(degree of whiteness before printing)−(degree of whiteness after printing) (1)

Table 6 shows the results.

### Examples 27 to 32 and Comparative Examples 13 to 31

The same evaluation as that in Example 26 was conducted using each of the photoreceptors and toners shown in Table 6. Table 6 shows the results.

### Comparative Example 32

Comparative photoreceptor 12 produced above was mounted on a black drum cartridge of Microline 3050c manufactured by OKI Data Corp., and the cartridge was loaded in the printer. The specifications of the Microline 3050c were as follows:

Printing system: four-stage tandem

Number of printing sheets: 21 ppm (color), 26 ppm (monochrome)

Number of pixels: 1200 dpi

Charging system: DC contact charging roller

Exposure system: LED exposure

Erase light: none

A commercially available toner for the printer was used. The toner was produced by a melting/kneading/pulverizing process and had an average sphericity of 0.935.

Memory image and fog value were evaluated in the same manner as in Example 26. Table 6 shows the results.

### [Additional Comparative Example 33]

Evaluation was conducted as in Comparative Example 32 using the comparative photoreceptor 13. Table 6 shows the results.

### [Table 6]

TABLE 6

| | | | | | Memory evaluation | | |
|---|---|---|---|---|---|---|---|
| | | Toner | | | | Low temp./ | |
| | | | Production | Average | Usual | low humidity | Fog |
| | Photoreceptor | Process | Example | sphericity | environment | environment | value |
| Example 26 | photoreceptor 5 | emulsion | Production | 0.963 | 1 | 2 | 0.5 |
| | | agglomeration | Example 10 | | | | |
| | | polymerization | | | | | |
| Example 27 | photoreceptor 6 | emulsion | Production | 0.963 | 1 | 2 | 0.5 |
| | | agglomeration | Example 10 | | | | |
| | | polymerization | | | | | |
| Example 28 | photoreceptor 7 | emulsion | Production | 0.963 | 1 | 2 | 0.6 |
| | | agglomeration | Example 10 | | | | |
| | | polymerization | | | | | |
| Example 29 | photoreceptor 8 | emulsion | Production | 0.963 | 1 | 1 | 0.5 |
| | | agglomeration | Example 10 | | | | |
| | | polymerization | | | | | |
| Example 30 | photoreceptor 9 | emulsion | Production | 0.963 | 2 | 3 | 0.6 |
| | | agglomeration | Example 10 | | | | |
| | | polymerization | | | | | |
| Example 31 | photoreceptor 5 | emulsion | Production | 0.946 | 1 | 2 | 0.3 |
| | | agglomeration | Example 8 | | | | |
| | | polymerization | | | | | |
| Example 32 | photoreceptor 6 | emulsion | Production | 0.946 | 1 | 1 | 0.4 |
| | | agglomeration | Example 8 | | | | |
| | | polymerization | | | | | |
| Example 33 | photoreceptor 7 | emulsion | Production | 0.946 | 1 | 2 | 0.4 |
| | | agglomeration | Example 8 | | | | |
| | | polymerization | | | | | |
| Example 34 | photoreceptor 8 | emulsion | Production | 0.946 | 1 | 1 | 0.3 |
| | | agglomeration | Example 8 | | | | |
| | | polymerization | | | | | |
| Example 35 | photoreceptor 9 | emulsion | Production | 0.946 | 2 | 2 | 0.3 |
| | | agglomeration | Example 8 | | | | |
| | | polymerization | | | | | |
| Comparative | photoreceptor 5 | emulsion | Production | 0.981 | 1 | 2 | 1.3 |
| Example 16 | | agglomeration | Example 11 | | | | |
| | | polymerization | | | | | |
| Comparative | photoreceptor 6 | emulsion | Production | 0.981 | 1 | 2 | 1.5 |
| Example 17 | | agglomeration | Example 11 | | | | |
| | | polymerization | | | | | |
| Comparative | photoreceptor 7 | emulsion | Production | 0.981 | 1 | 2 | 1.4 |
| Example 18 | | agglomeration | Example 11 | | | | |
| | | polymerization | | | | | |
| Comparative | comparative | emulsion | Production | 0.963 | 3 | 4 | 0.6 |
| Example 19 | photoreceptor 4 | agglomeration | Example 10 | | | | |
| | | polymerization | | | | | |
| Comparative | comparative | emulsion | Production | 0.963 | 3 | 4 | 0.7 |
| Example 20 | photoreceptor 5 | agglomeration | Example 10 | | | | |
| | | polymerization | | | | | |
| Comparative | comparative | emulsion | Production | 0.963 | 4 | 5 | 0.6 |
| Example 21 | photoreceptor 6 | agglomeration | Example 10 | | | | |
| | | polymerization | | | | | |
| Comparative | comparative | emulsion | Production | 0.963 | 3 | 4 | 0.6 |
| Example 22 | photoreceptor 7 | agglomeration | Example 10 | | | | |
| | | polymerization | | | | | |
| Comparative | comparative | emulsion | Production | 0.963 | 4 | 5 | 0.7 |
| Example 23 | photoreceptor 8 | agglomeration | Example 10 | | | | |
| | | polymerization | | | | | |
| Comparative | comparative | emulsion | Production | 0.963 | 4 | 5 | 0.7 |
| Example 24 | photoreceptor 9 | agglomeration | Example 10 | | | | |
| | | polymerization | | | | | |
| Comparative | comparative | emulsion | Production | 0.963 | 4 | 5 | 0.6 |
| Example 25 | photoreceptor 10 | agglomeration | Example 10 | | | | |
| | | polymerization | | | | | |
| Comparative | comparative | emulsion | Production | 0.963 | 4 | 5 | 0.7 |
| Example 26 | photoreceptor 11 | agglomeration | Example 10 | | | | |
| | | polymerization | | | | | |
| Comparative | comparative | emulsion | Production | 0.981 | 4 | 4 | 1.5 |
| Example 27 | photoreceptor 4 | agglomeration | Example 11 | | | | |
| | | polymerization | | | | | |
| Comparative | comparative | emulsion | Production | 0.981 | 3 | 4 | 1.6 |
| Example 28 | photoreceptor 5 | agglomeration | Example 11 | | | | |
| | | polymerization | | | | | |
| Comparative | comparative | emulsion | Production | 0.981 | 4 | 4 | 1.5 |
| Example 29 | photoreceptor 6 | agglomeration | Example 11 | | | | |
| | | polymerization | | | | | |
| Comparative | comparative | emulsion | Production | 0.946 | 4 | 4 | 0.4 |
| Example 30 | photoreceptor 4 | agglomeration | Example 8 | | | | |
| | | polymerization | | | | | |
| Comparative | comparative | emulsion | Production | 0.946 | 3 | 4 | 0.5 |
| Example 31 | photoreceptor 5 | agglomeration | Example 8 | | | | |
| | | polymerization | | | | | |
| Comparative | comparative | melting | | 0.935 | 4 | 4 | 0.5 |
| Example 32 | photoreceptor 12 | kneading | | | | | |
| | | pulverizing | | | | | |
| Comparative | comparative | melting | | 0.935 | 4 | 4 | 0.6 |
| Example 33 | photoreceptor 13 | kneading | | | | | |
| | | pulverizing | | | | | |

### INDUSTRIAL APPLICABILITY

The image-forming apparatus of the present invention exhibits excellent image stability during long-time operation or for changes in use environment and therefore can be applied to not only, for example, common printers and copiers but also, for example, image-forming systems performing with high resolution, long service life, and high speed printing, which have been recently developed.

Although the present invention has been described in detail with reference to certain preferred embodiments, those skilled in the art will recognize that various modifications will be made without departing from the purpose and scope of the present invention.

The present application is based on Japanese Patent Application (Patent Application No. 2007-155670) filed on Jun. 12, 2007 and Japanese Patent Application (Patent Application No. 2007-259703) filed on Oct. 3, 2007, the entire contents of which are hereby incorporated by reference.

1. (canceled)

2. A method of forming an image using an image-forming apparatus, the apparatus comprising an electrophotographic photoreceptor comprising a photosensitive layer on an electroconductive support, and a development device comprising a development tank, wherein the development tank comprises an electrostatic charge image-developing toner, wherein the photosensitive layer of the electrophotographic photoreceptor comprises oxytitanium phthalocyanine showing at least main diffraction peaks at Bragg angles (2θ±0.2°) of 9.0° and 27.2° and at least one main diffraction peak in the range of 9.3° to 9.8° to CuKα characteristic X-rays (wavelength: 1.541 angstroms), and the electrostatic charge image-developing toner satisfies following requirements (1) to (4):
(1) the volume median diameter (Dv50) is 4.0 μm or more and 7.0 μm or less,
(2) the average sphericity is 0.93 or more,
(3) the volume median diameter (Dv50) of the toner and a content (% by number: Dns) of toner particles having a particle diameter of 2.00 μm or more and 3.56 μm or less satisfy Dns≦0.233EXP(17.3/Dv50), and
(4) the number variation coefficient is 24.0 % or less.

3. The method according to claim 2, wherein the relation between the volume median diameter (Dv50) of the electrostatic charge image-developing toner and the content (% by number: Dns) of toner particles having a particle diameter of 2.00 μm or more and 3.56 μm or less satisfies following expression (3-1):

4. The method according to claim 2, wherein the relation between the volume median diameter (Dv50) of the electrostatic charge image-developing toner and the content (% by number: Dns) of toner particles having a particle diameter of 2.00 μm or more and 3.56 μm or less satisfies following expression (3-2):
0.0517EXP(22.4/Dv50)≦Dns. (3-2)

5. The method according to claim 2, wherein the content (% by number: Dns) of toner particles having a particle diameter of 2.00 μm or more and 3.56 μm or less in the electrostatic charge image-developing toner is 6% by number or less.

6. The method according to claim 2, wherein the photosensitive layer of the electrophotographic photoreceptor comprises a charge-transporting organic material having a dipole moment Peal satisfying 0.2 (D)<Pcal<2.1 (D), where the dipole moment is obtained by geometry optimization of a semiempirical molecular orbital calculation by an AM1 parameter.

7. The method according to claim 2, wherein the electrostatic charge image-developing toner comprises a wax in an amount of 4 to 20 parts by weight on the basis of 100 parts by weight of the electrostatic charge image-developing toner.

8. The method according to claim 2, wherein the development to a latent image carrier is carried out at a speed of 100 mm/sec or more.

9. The method according to claim 2, wherein the resolution to a latent image carrier is 600 dpi or more.

10. The method according to claim 2, wherein the standard deviation of charge density in the electrostatic charge image-developing toner is from 1.0 to 2.0.

11. The method according to claim 2, wherein the exposure light to form an electrostatic latent image is monochromatic light having a wavelength of 380 to 500 nm.
